(19) United States
(12) Patent Application Publication
(10) Pub. No.: US 2006/0135668 A1
(43) Pub. Date: Jun. 22, 2006

(54) Polyesters containing natural mineral materials, processes for producing such polyesters, and shaped articles produced therefrom

(76) Inventor: Richard Allen Hayes, Brentwood, TN (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/018,791

(22) Filed: Dec. 21, 2004

(51) Int. Cl. C08K 3/22; C08G 63/60

(52) U.S. Cl. 524/430; 524/605

(57) ABSTRACT

This invention provides polyester compositions containing pumice fillers, and shaped articles formed from the polyester compositions. Also provided are polyester compositions containing perlite fillers, and shaped articles formed from the compositions. The polyester compositions can also contain one or more other fillers, and can also optionally contain a heavy metal-containing or heavy metal-free catalyst. The invention further provides processes for producing the polyester compositions, and shaped articles formed therefrom.

### FIELD OF THE INVENTION

The present invention relates to polyesters containing natural mineral materials, and shaped articles produced therefrom. The present invention further relates to processes for producing a polyester containing natural mineral materials.

### BACKGROUND

A significant number of polyesters, including, for example, poly(ethylene terephthalate), are produced by using heavy metal-containing polymerization catalysts, such as, for example, antimony. Polyesters have a wide variety of end uses, including end uses that are in direct contact with food, such as, for example, bottles and containers for soda and water, and food trays, especially dual ovenable frozen food trays.

In a continuing effort to reduce the environmental footprints of polyesters produced by using heavy metal-containing polymerization catalysts, extensive research has been conducted to replace such catalysts. For example, complex titanate catalyst systems have been introduced to replace the antimony-based catalyst systems.

The present invention provides polyester catalyst systems comprising naturally derived volcanic materials, such as pumice and perlite, which material are believed to be more environmentally friendly than conventional metal-containing polymerization catalysts.

### SUMMARY OF THE INVENTION

One aspect of the present invention is a polyester composition containing pumice filler, processes for producing a polyester from such a polyester composition, and shaped articles formed from the polyester composition. Preferably, the polyester composition contains at least about 0.0001 weight percent pumice filler, based on total weight of the polyester composition, more preferably from about 0.0001 to about 30 weight percent, and most preferably from about 0.0001 to about 20 weight percent. In preferred embodiments, the pumice filler is added to the polyester composition while the polyester is being polymerized. The shaped articles that can be formed include, for example, films, sheets, filaments, molded products, and thermoformed products.

Another aspect of the present invention is a polyester composition containing a pumice filler as a catalyst, and other fillers, processes for producing the polyester composition, and shaped articles produced from the polyester composition. In some embodiments, the pumice functions as a catalyst and a filler. In other embodiments, the pumice functions solely as a catalyst. When pumice is used as a polymerization catalyst and not intended to function substantially as a filler, the amount of pumice is preferably from about 0.0001 to about 0.5 weight percent, and more preferably from about 0.0001 to about 0.1 weight percent, based on the total weight of the polyester composition. In addition to pumice as a catalyst and/or filler, other catalysts, which can be heavy metal-free catalysts or heavy metal-containing catalysts, can be used.

The processes include the addition of the pumice fillers within the polyester polymerization production process. The amount of other fillers is preferably at least about 0.01 weight percent based on the total weight of the polyester composition. More preferably, the amount of other fillers is from about 0.1 weight percent to about 20 weight percent, based on the total weight of the polyester composition. Most preferably, the amount of other fillers is from about 1 weight percent to about 15 weight percent, based on the total weight of the polyester compositions. Preferably, the other fillers include carbon black. Preferably, the carbon black fillers have a DBP value of at least about 150 cc/100 grams. More preferably, the carbon black fillers have a DBP value of at least about 220 cc/100 grams. Preferably, the polyester compositions that contain both a pumice filler and a carbon black filler have electrical properties as described herein below. Shaped articles that can be made from the polyester compositions include films, sheets, filaments, molded products, and thermoformed products.

A further aspect of the present invention is polyester compositions containing pumice fillers in combination with other, heavy metal-free catalysts, processes to produce the polyester compositions, and shaped articles produced therefrom. The other, heavy metal-free catalysts do not contain components derived from heavy metals, such antimony. The processes include the addition of the pumice fillers within the polyester polymerization production process. Preferably, the amount of the pumice fillers is at least about 0.0001 weight percent based on the total weight of the polyester composition. More preferably, the amount of the pumice fillers is from about 0.0001 weight percent to about 30 weight percent based on the total weight of the polyester composition. Most preferably, the amount of pumice fillers is from about 0.0001 weight percent to about 20 weight percent based on the total weight of the polyester composition. Shaped articles that can be made from the polyester compositions include films, sheets, filaments, molded products, and thermoformed products.

A further aspect of the present invention includes polyester compositions containing pumice fillers in combination with other, heavy metal-free catalysts and other fillers, processes to produce the polyester compositions, and shaped articles produced therefrom. The other, heavy metal-free catalysts do not contain components derived from heavy metals, such as antimony. The processes include the addition of the pumice fillers within the polyester polymerization production process. Preferably, the amount of the pumice fillers is at least about 0.0001 weight percent based on the total weight of the polyester composition. More preferably, the amount of the pumice fillers is from about 0.0001 weight percent to about 30 weight percent based on the total weight of the polyester composition. Most preferably, the amount of the pumice fillers is from about 0.0001 weight percent to about 20 weight percent based on the total weight of the polyester composition. Preferably, the amount of other fillers is at least about 0.01 weight percent based on the total weight of the polyester composition. More preferably, the amount of other fillers is from about 0.1 weight percent to about 20 weight percent, based on the total weight of the polyester composition. Most preferably, the amount of other fillers is from about 1 weight percent to about 15 weight percent, based on the total weight of the polyester composition. Preferably, the other fillers include carbon black. In some preferred embodiments, the other fillers consist essentially of carbon black, and in some preferred embodiments the other fillers consist of only carbon black. Preferably, the carbon black fillers have a DBP value of at least about 150 cc/100 grams. More preferably, the carbon black fillers have a DBP value of at least about 220 cc/100 grams. Preferably, the polyester compositions containing both a pumice filler and a carbon black filler have electrical properties as described herein below. Shaped articles that can be made from the polyester compositions include films, sheets, filaments, molded products, and thermoformed products.

A further aspect of the present invention includes processes for producing polyester compositions containing pumice fillers in combination with heavy metal-containing catalysts and shaped articles produced therefrom. Optionally, other heavy-metal free catalysts can also be included in the polyester compositions containing pumice fillers in combination with heavy metal-containing catalysts. The processes include the addition of the pumice fillers within the polyester polymerization production process. Preferably, the amount of the pumice fillers is at least about 0.0001 weight percent based on the total weight of the polyester composition. More preferably, the amount of the pumice fillers is from about 0.0001 weight percent to about 30 weight percent based on the total weight of the polyester composition. Most preferably, the amount of the pumice fillers is from about 0.0001 weight percent to about 20 weight percent based on the total weight of the polyester composition. Shaped articles that can be made from the polyester compositions include films, sheets, filaments, molded products, and thermoformed products.

A further aspect of the present invention includes processes for producing polyester compositions containing pumice fillers in combination with heavy metal-containing catalysts and other fillers, and shaped articles produced therefrom. Optionally, other heavy-metal free catalysts can also be used. The processes include the addition of the pumice fillers within the polyester polymerization production process. Preferably, the amount of the pumice fillers is at least about 0.0001 weight percent based on the total weight of the polyester composition. More preferably, the amount of the pumice fillers is from about 0.0001 weight percent to about 30 weight percent based on the total weight of the polyester composition. Most preferably, the amount of the pumice fillers is from about 0.0001 weight percent to about 20 weight percent based on the total weight of the polyester composition. Preferably, the amount of other fillers is at least about 0.01 weight percent based on the total weight of the polyester composition. More preferably, the amount of other fillers is from about 0.1 weight percent to about 20 weight percent, based on the weight of the total polyester composition. Most preferably, the amount of other fillers is from about 1 weight percent and about 15 weight percent, based on the total weight of the polyester composition. Preferably, the other fillers are carbon black. Preferably, the carbon black fillers have a DBP value of at least about 150 cc/100 grams. More preferably, the carbon black fillers have a DBP value of at least about 220 cc/100 grams. Preferably, the polyester compositions containing both a pumice filler and a carbon black filler have electrical properties as described herein below. Shaped articles that can be made from the polyester compositions include films, sheets, filaments, molded products, and thermoformed products.

A preferred embodiment of the present invention is monofilaments produced from polyester compositions containing pumice fillers. The monofilaments produced from the polyester compositions have enhanced abrasion resistance. Polyester compositions used in making the monofilaments can also optionally contain heavy metal-free catalysts, heavy metal-containing catalysts, and/or other fillers.

A further aspect of the present invention polyester compositions containing perlite fillers that function as the sole polymerization catalyst in polymerization to make the polyester, processes for producing the polyester compositions, and shaped articles formed therefrom. Preferably, the amount of perlite fillers in the polyester compositions containing perlite fillers is at least about 0.0001 weight percent based on the total weight of the polyester composition. More preferably, the amount of perlite fillers is from about 0.0001 weight percent to about 30 weight percent based on the total weight of the polyester composition. Most preferably, the amount of perlite fillers is from about 0.0001 weight percent to about 20 weight percent based on the total weight of the polyester composition. The processes include the addition of the perlite fillers within the polyester polymerization production process. Shaped articles that can be made from the polyester compositions containing perlite fillers include films, sheets, filaments, molded products, and thermoformed products.

A further aspect of the present invention includes polyester compositions containing perlite fillers as the sole catalyst, and one or more other fillers. Also provided are processes to produce the polyester compositions, and shaped articles produced therefrom. The processes include the addition of the perlite fillers within the polyester polymerization production process. Preferably, the amount of the perlite fillers is at least about 0.0001 weight percent based on the total weight of the polyester composition. More preferably, the amount of perlite fillers is from about 0.0001 weight percent to about 30 weight percent based on the total weight of the polyester composition. Most preferably, the amount of the perlite fillers is from about 0.0001 weight percent to about 20 weight percent based on the total weight of the polyester composition. Preferably, the amount of other fillers, if used, is at least about 0.01 weight percent based on the total weight of the polyester composition. More preferably, the amount of other fillers is from about 0.1 weight percent to about 20 weight percent, based on the weight of the total polyester composition. Most preferably, the amount of other fillers is from about 1 weight percent to about 15 weight percent, based on the total weight of the polyester composition. Preferably, the other fillers include carbon black. Preferably, the carbon black fillers have a DBP value of at least about 150 cc/100 grams. More preferably, the carbon black fillers have a DBP value of at least about 220 cc/100 grams. Preferably, the polyester compositions that contain both a perlite filler and a carbon black filler have electrical properties as disclosed herein below. Shaped articles that can be formed from the polyester compositions include films, sheets, filaments, molded products, and thermoformed products.

Another aspect of the present invention is a polyester composition containing a perlite filler as a catalyst, and other fillers, processes for producing the polyester composition, and shaped articles produced from the polyester composition. In some embodiments, the perlite functions as a catalyst and a filler. In other embodiments, the perlite functions solely as a catalyst. When perlite is used as a polymerization catalyst and not intended to function substantially as a filler, the amount of perlite is preferably from about 0.0001 to about 0.5 weight percent, and more preferably from about 0.0001 to about 0.1 weight percent, based on the total weight of the polyester composition. In addition to perlite as a catalyst and/or filler, other catalysts, which can be heavy metal-free catalysts or heavy metal-containing catalysts, can be used.

A further aspect of the present invention includes polyester compositions containing perlite fillers in combination with other, heavy metal-free catalysts, processes to produce the polyester compositions, and shaped articles produced therefrom. The other, heavy metal-free catalysts do not contain components derived from heavy metals, such antimony. The processes include the addition of the perlite fillers within the polyester polymerization production process. Preferably, the amount of perlite fillers is at least about 0.0001 weight percent based on the total weight of the polyester composition. More preferably, the amount of perlite fillers is from about 0.0001 weight percent to about 30 weight percent based on the total weight of the polyester composition. Most preferably, the amount of perlite fillers is from about 0.0001 weight percent to about 20 weight percent based on the total weight of the polyester composition. Shaped articles that can be made from the polyester compositions include films, sheets, filaments, molded products, and thermoformed products.

A further aspect of the present invention includes polyester compositions containing perlite fillers in combination with other, heavy metal-free catalysts and other fillers, processes to produce the polyester compositions, and shaped articles produced therefrom. The other, heavy metal-free catalysts do not contain components derived from heavy metals, such as antimony. The processes include the addition of the perlite fillers within the polyester polymerization production process. Preferably, the amount of perlite fillers is at least about 0.0001 weight percent based on the total weight of the polyester composition. More preferably, the amount of perlite fillers is from about 0.0001 weight percent to about 30 weight percent based on the total weight of the polyester composition. Most preferably, the amount of perlite fillers is from about 0.0001 weight percent to about 20 weight percent based on the total weight of the polyester composition. Preferably, the amount of other fillers is at least about 0.01 weight percent based on the total weight of the polyester composition. More preferably, the amount of other fillers is from about 0.1 weight percent to about 20 weight percent, based on the weight of the total polyester composition. Most preferably, the amount of other fillers is from about 1 weight percent and about 15 weight percent, based on the total weight of the polyester composition. Preferably, the other fillers include carbon black. Preferably, the carbon black fillers have a DBP value of at least about 150 cc/100 grams. More preferably, the carbon black fillers have a DBP value of at least about 220 cc/100 grams. Preferably, the polyester compositions containing both a perlite filler and a carbon black filler have electrical properties as disclosed herein below. Shaped articles that can be made from the polyester compositions include films, sheets, filaments, molded products, and thermoformed products.

A further aspect of the present invention includes processes for producing polyester compositions containing perlite fillers in combination with heavy metal-containing catalysts, and shaped articles produced therefrom. Optionally, other heavy-metal free catalysts can also be included. The processes include the addition of the perlite fillers within the polyester polymerization production process. Preferably, the amount of the perlite fillers is at least about 0.0001 weight percent based on the total weight of the polyester composition. More preferably, the amount of the perlite fillers is from about 0.0001 weight percent to about 30 weight percent based on the total weight of the polyester composition. Most preferably, the amount of perlite fillers is from about 0.0001 weight percent to about 20 weight percent based on the total weight of the polyester composition. Shaped articles that can be made from the polyester compositions include films, sheets, filaments, molded products, and thermoformed products.

A further aspect of the present invention includes processes to produce polyester compositions containing perlite fillers in combination with heavy metal-containing catalysts and other fillers and shaped articles produced therefrom. Optionally, other heavy-metal free catalysts can also be included. The processes include the addition of the perlite fillers within the polyester polymerization production process. Preferably, the amount of perlite fillers is at least about 0.0001 weight percent based on the total weight of the polyester composition. More preferably, the amount of perlite fillers is from about 0.0001 weight percent to about 30 weight percent based on the total weight of the polyester composition. Most preferably, the amount of perlite fillers is from about 0.0001 weight percent to about 20 weight percent based on the total weight of the polyester composition. Preferably, the amount of other fillers at least about 0.01 weight percent based on the total weight of the polyester composition. More preferably, the amount of other fillers from about 0.1 weight percent and about 20 weight percent, based on the weight of the total polyester composition. Most preferably, the amount of other fillers from about 1 weight percent and about 15 weight percent, based on the weight of the total polyester compositions. Preferably, the other fillers include carbon black. Preferably, the carbon black fillers have a DBP value of at least about 150 cc/100 grams. More preferably, the carbon black fillers have a DBP value of at least about 220 cc/100 grams. Preferably, the polyester compositions containing both a perlite filler and a carbon black filler have electrical properties as disclosed herein below. Shaped articles that can be made from the polyesters include films, sheets, filaments, molded products, and thermoformed products.

A further preferred embodiment of the present invention includes monofilaments produced from polyester compositions containing perlite fillers. The monofilaments produced from the polyester compositions containing perlite fillers have enhanced abrasion resistance.

### DETAILED DESCRIPTION

The present invention provides polyesters containing pumice fillers. The pumice fillers are naturally occurring. In preferred embodiments, the pumice fillers are used during polymerization to form the polyesters. The pumice fillers act as catalysts during polymerization to form the polyesters; accordingly, additional catalysts are not required. The use of pumice fillers as catalysts permits the elimination of heavy metal catalysts. Heavy metal catalysts may be undesirable in many applications, for example, for environmental reasons.

Also provided according the invention are shaped articles made from the polyesters containing pumice fillers, and processes for making the shaped articles.

As used herein, the term “polyester composition” refers to the total of the polyester, the pumice filler, and any other materials added to the polyester, such as any other catalysts, any other fillers, and any additives. Quantities presented in descriptions of polyester compositions, unless otherwise stated, refer to quantities utilized in making the compositions, and not necessarily to quantities in the polyester composition after production.

Unless stated otherwise, all percentages, parts, ratios, etc., are by weight. Further, when an amount, concentration, or other value or parameter is given as either a range, preferred range or a list of upper preferable values and lower preferable values, the recited amount, concentration, or other value or parameter is intended to include all ranges formed from any pair of any upper range limit or preferred value and any lower range limit or preferred value, regardless of whether such ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Polyesters made and used according to the processes disclosed herein contain a dicarboxylic acid component, a glycol component, and, optionally, a polyfunctional branching agent component. A preferred process for making the polyester composition includes providing a dicarboxylic acid component, a glycol component, and, optionally, a polyfunctional branching agent component to form a reaction mixture contacting the reaction mixture with a pumice filler, and allowing the dicarboxylic acid component, the glycol component, and the optional polyfunctional branching agent to polymerize in the presence of the pumice filler to form a polyester. Alternatively, the pumice filler can be combined with one of the components, e.g., the glycol component, and then used in forming the reaction mixture. The dicarboxylic acid component is selected from unsubstituted, substituted, linear, and branched dicarboxylic acids, lower alkyl esters of dicarboxylic acids having from 2 carbons to 36 carbons, and bisglycolate esters of dicarboxylic acids. Specific examples of desirable dicarboxylic acid component include terephthalic acid, dimethyl terephthalate, isophthalic acid, dimethyl isophthalate, 2,6-naphthalene dicarboxylic acid, dimethyl-2,6-naphthalate, 2,7-naphthalene dicarboxylic acid, dimethyl-2,7-naphthalate, metal salts of 5-sulfoisophthalic acid, sodium dimethyl-5-sulfoisophthalate, lithium dimethyl-5-sulfoisophthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid), dimethyl-4,4′-methylenebis(benzoate), bis(2-hydroxyethyl)terephthalate, bis(2-hydroxyethyl)isophthalate, bis(3-hydroxypropyl)terephthalate, bis(3-hydroxypropyl)isophthalate, bis(4-hydroxybutyl)terephthalate, bis(4-hydroxybutyl)isophthalate, oxalic acid, dimethyl oxalate, malonic acid, dimethyl malonate, succinic acid, dimethyl succinate, methylsuccinc acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, bis(2-hydroxyethyl)glutarate, bis(3-hydroxypropyl)glutarate, bis(4-hydroxybutyl)glutarate), and mixtures derived therefrom.

Aliphatic dicarboxylic acids, if used, are preferably saturated, for enhanced thermal stability. Preferably, the dicarboxylic acid component is an aromatic dicarboxylic acid component, which can provide enhanced thermal stability and enhanced thermal properties, such as glass transition temperature, crystalline melting point, and heat deflection temperature. Preferred aromatic dicarboxylic acid components are selected from terephthalic acid, dimethyl terephthalate, bis(2-hydroxyethyl)terephthalate, bis(3-hydroxypropyl)terephthalate, bis(4-hydroxybutyl)terephthalate, isophthalic acid, dimethyl isophthalate, bis(2-hydroxyethyl)isophthalate, bis(3-hydroxypropyl)isophthalate, bis(4-hydroxybutyl)isophthalate, 2,6-naphthalene dicarboxylic acid, dimethyl-2,6-naphthalate, and mixtures derived therefrom. More preferably, the aromatic dicarboxylic acid component is selected from terephthalic acid and isophthalic acid and lower alkyl esters, such as dimethyl terephthalate and dimethyl isophthalate, and glycolate esters, such as bis(2-hydroxyethyl)terephthalate, bis(2-hydroxyethyl)isophthalate, bis(3-hydroxypropyl)terephthalate, bis(3-hydroxypropyl)isophthalate, bis(4-hydroxybutyl)terephthalate, bis(4-hydroxybutyl)isophthalate, and mixtures thereof. Essentially any dicarboxylic acid known can be used.

The dicarboxylic acid component is incorporated into the polyester composition at from about 90 to about 110 mole percent based on 200 total mole percent of the dicarboxylic acid component and the glycol component. Preferably, the dicarboxylic acid component is incorporated into the polyester composition at from about 95 to about 105 mole percent, based on 200 total mole percent. More preferably, the dicarboxylic acid component is incorporated into the polyester composition at from about 97.5 to about 102.5 mole percent based on 200 mole percent of the total of the dicarboxylic acid component and the glycol component. Most preferably, the dicarboxylic acid component is incorporated into the polyester composition at about 100 mole percent based on 200 mole percent of the total of the dicarboxylic acid component and the glycol component.

Examples of glycols that can be used include unsubstituted, substituted, straight chain, branched, cyclic aliphatic, aliphatic-aromatic and aromatic diols having from 2 carbon atoms to 36 carbon atoms; and poly(alkylene ether)glycols that preferably have a molecular weight of from about 500 to about 4000. More specific examples of acceptable glycols include ethylene glycol; 1,3-propanediol; 1,4-butanediol; 1,6-hexanediol; 1,8-octanediol; 1,10-decanediol; 1,12-dodecanediol; 1,14-tetradecanediol; 1,16-hexadecanediol; dimer diol; 4,8-bis(hydroxymethyl)-tricyclo[5.2.1.0/2.6]decane; 1,4-cyclohexanedimethanol; isosorbide; di(ethylene glycol); tri(ethylene glycol); poly(ethylene glycol); poly(1,3-propylene glycol); poly(1,4-butylene glycol)(polytetrahydrofuran); poly(pentamethylene glycol); poly(hexamethylene glycol); poly(hepthamethylene glycol); poly(ethylene glycol)-block-poly(propylene glycol)-block-poly(ethylene glycol); 4,4′-isopropylidenediphenol ethoxylate (Bisphenol A ethoxylate); 4,4′-(1-phenylethylidene)bisphenol ethoxylate (Bisphenol AP ethoxylate); 4,4′-ethylidenebisphenol ethoxylate (Bisphenol E ethoxylate); bis(4-hydroxyphenyl)methane ethoxylate (Bisphenol F ethoxylate); 4,4′-(1,3-phenylenediisopropylidene)bisphenol ethoxylate (Bisphenol M ethoxylate); 4,4′-(1,4-phenylenediisopropylidene)bisphenol ethoxylate (Bisphenol P ethoxylate); 4,4′sulfonyldiphenol ethoxylate (Bisphenol S ethoxylate); 4,4′-cyclohexylidenebisphenol ethoxylate (Bisphenol Z ethoxylate); and mixtures derived therefrom. Essentially any glycol known can be used. Preferably, the glycol is selected from ethylene glycol; 1,3-propanediol; 1,4-butanediol; 1,4-cyclohexanedimethanol; and mixtures thereof. The polyester composition contains from about 90 to about 110 mole percent glycol, based on 200 mole percent of the total of the dicarboxylic acid and the glycol. Preferably, the glycol component is incorporated into the polyester composition at from about 95 to about 105 mole percent based on 200 mole percent of the total of the dicarboxylic acid component and the glycol component. More preferably, the glycol component is incorporated into the polyester composition at from about 97.5 to about 102.5 mole percent based on 200 mole percent of the total of the dicarboxylic acid component and the glycol component. Most preferably, the glycol component is incorporated into the polyester composition at about 100 mole percent based on 200 mole percent of the total of the dicarboxylic acid component and the glycol component.

The optional polyfunctional branching agent component can be any material having three or more carboxylic acid functions, hydroxy functions or a mixture thereof. Specific examples of desirable polyfunctional branching agents include 1,2,4-benzenetricarboxylic acid (trimellitic acid), trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid (pyromellitic acid), 1,2,4,5-benzenetetracarboxylic dianhydride(pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, glycerol, 2-(hydroxymethyl)-1,3-propanediol, 2,2-bis(hydroxymethyl)propionic acid, and mixture therefrom. Essentially any polyfunctional compound having three or more carboxylic acid or hydroxyl functions can be used. The polyfunctional branching agent can be included, for example, when higher resin melt viscosity is desired for specific end uses. Examples of such end uses include melt extrusion coatings, melt blown films and containers, and foams. Preferably, the polyetherester composition includes 0 to 1.0 mole percent of the polyfunctional branching agent based on 100 mole percent of the dicarboxylic acid component.

Pumice, as used herein, includes light porous stones of volcanic origin, containing silicates of aluminum, potassium, and/or sodium. All types of magma, such as basalt, andesite, dacite, and rhyolite, can form pumice. Preferably, the polyester compositions contain at least about 0.0001 weight percent of one or more pumice fillers, based on the total weight of the polyester composition. More preferably, the amount of pumice filler is from about 0.0001 weight percent to about 30 weight percent based on the total weight of the polyester composition. Most preferably, the amount of pumice filler is from about 0.0001 weight percent to about 20 weight percent based on the total weight of the polyester composition. Preferably, the nominal particle size of the pumice is about 100 microns or less, more preferably about 50 microns or less, and most preferably about 10 microns or less.

A preferred process for making the polyesters containing the pumice fillers includes adding the pumice filler to the components of the polyester, e.g., monomers, during the initial stages of the polyester polymerization process. The pumice filler can be added at any stage of the polyester polymerization prior to the polyester achieving an inherent viscosity above about 0.20 dL/g. The pumice filler is preferably added at the monomer stage, such as with the dicarboxylic acid component or with the glycol component, or to the initial (trans)esterification product, precondensates), ranging from the bis(glycolate) to polyester oligomers with degrees of polymerization (DP) of about 10 or less. More preferably, the pumice filler is added with the glycol component or to the initial (trans)esterification product.

The polyester compositions can be prepared by conventional polycondensation techniques. The compositions can vary, depending in part on the method of preparation used, particularly the amount of glycol in the polyester. Preferably, the polyester compositions are produced by a melt polymerization method. In the melt polymerization method, the dicarboxylic acid component, (either as acids, esters, bisglycolates or mixtures thereof, the glycol component, the pumice component, and optionally the polyfunctional branching agent, are combined to a high enough temperature that the monomers combine to form esters and diesters, then oligomers, and ly polymers. The polymeric product at the end of the polymerization process is a molten product. Generally, the glycol component is volatile and distills from the reactor as the polymerization proceeds. Such procedures are known to those skilled in the art.

The melt process conditions, particularly the amounts of monomers used, depend on the polymer composition desired. The amount of glycol component, dicarboxylic acid component, pumice component, and optional branching agent are desirably chosen so that the polymeric product contains the desired amounts of the various monomer units, desirably with equimolar amounts of monomer units derived from the respective sum of the glycol components with the dicarboxylic acid components. Because of the volatility of some of the monomers, especially some of the glycol components, and depending on such variables as whether the reactor is sealed, (i.e. is under pressure), the polymerization temperature ramp rate, and the efficiency of the distillation columns used in synthesizing the polymer, some of the monomers may need to be included in excess at the beginning of the polymerization reaction and removed by distillation as the reaction proceeds. This is particularly true of the glycol component.

The amount of monomers to be charged to a particular reactor can be determined by a skilled practitioner, but often will be in the ranges below. Excesses of the dicarboxylic acid and the glycol are often desirably charged, and the excess dicarboxylic acid and glycol is desirably removed by distillation or other means of evaporation as the polymerization reaction proceeds. Preferred glycol components, such as ethylene glycol, 1,3-propanediol, and 1,4-butanediol, are desirably charged at 10 to 100 percent greater than the desired incorporation amount in the polymer. Preferably, the amount of ethylene charged is 40 to 100 percent greater than the content desired in the polyester. Preferably, the 1,3-propanediol and 1,4-butanediol are charged at 20 to 70 percent greater than the content desired in the polyester. Other glycol components are desirably charged at 0 to 100 percent greater than the desired incorporation amount in the product, depending on the volatility of the other glycol component.

The ranges recited herein for the amounts of each of monomers used in making the polyesters are very wide because of the wide variation in the monomer loss during polymerization, depending on the efficiency of distillation columns or other recovery and recycle system used, and are only an approximation. The amounts of monomers to be charged to a specific reactor to achieve a specific composition can be determined by a skilled practitioner.

In a preferred polymerization process, the monomers are combined, and heated gradually with mixing with a catalyst or catalyst mixture, to a temperature in the range of 200° C. to about 330° C., desirably 220° C. to 295° C. The preferred temperature and other conditions depend on whether the dicarboxylic acid component is polymerized as acid, as dimethyl esters, or as bisglycolates. The heating and stirring are continued for a sufficient time and to a sufficient temperature, generally with removal by distillation of excess reactants, to yield a molten polymer having a high enough molecular weight to be suitable for making fabricated products.

The monomer composition of the polymer can be chosen for specific uses and for specific sets of properties. As one skilled in the art will appreciate, the thermal properties observed will be a complex function of the chemical composition of a polyester and the amount of each component used in the polyetherester composition.

Polymers having an adequate molecular weight for many applications can be made by the melt condensation process above. The molecular weight is normally not measured directly. Instead, the inherent viscosity of the polymer in solution or the melt viscosity is used as an indicator of molecular weight. The inherent viscosities are an indicator of molecular weight for comparisons of samples within a polymer family, such as poly(ethylene terephthalate), poly(butylene terephthalate), etc., and are used as an indicator of molecular weight herein.

To give the desired physical properties for some applications, the polyester compositions preferably have an IV of at least 0.25, as measured on a 0.5 percent (weight/volume) solution of the polyester in a 50:50 (weight) solution of trifluoroacetic acid:dichloromethane solvent system at room temperature. More preferably, the IV is at least 0.35 dL/g. Higher inherent viscosities are desirable for many other applications, such as films, bottles, sheet, and molding resin. The polymerization conditions can be adjusted to obtain the desired inherent viscosities of at least about 0.50 and preferably higher than 0.65 dL/g. Further processing of the polyester can be used to achieve inherent viscosities of 0.7, 0.8, 0.9, 1.0, 1.5, 2.0 dL/g and even higher.

Solid state polymerization can be used to achieve even higher inherent viscosities (molecular weights). The polymer made by melt polymerization, after extruding, cooling and pelletizing, can be essentially noncrystalline. Noncrystalline materials can be made semicrystalline by heating it to a temperature above the glass transition temperature for an extended period of time. This induces crystallization so that the polymer can then be heated to a higher temperature to raise the molecular weight.

The polymer can also be crystallized to a semicrystalline state prior to solid state polymerization by treatment with a relatively poor solvent for polyesters which induces crystallization. Such solvents reduce the glass transition temperature (Tg) allowing for crystallization. Solvent induced crystallization is known for polyesters and is described in U.S. Pat. No. 5,164,478 and U.S. Pat. No. 3,684,766. The semicrystalline polymer is subjected to solid state polymerization by placing the pelletized or pulverized polymer into a stream of an inert gas, usually nitrogen, or under a vacuum of 1 Torr, at an elevated temperature, but below the melting temperature of the polymer for an extended period of time.

Also provided according to the present invention are polyester compositions containing combinations of pumice fillers wherein the pumice fillers are used as the sole catalyst in making the polyesters, processes for producing the polyesters, and shaped articles produced therefrom. When pumice is used essentially or solely as a polymerization catalyst and not intended to function substantially as a filler, the amount of pumice is preferably from about 0.0001 to about 0.5 weight percent, and more preferably from about 0.0001 to about 0.1 weight percent, based on the total weight of the polyester composition. The polyester compositions produced by the process, as described above, can be filled with other fillers, including inorganic, organic and clay fillers, such as, for example, carbon black, wood flour, gypsum, talc, mica, carbon black, wollastonite, montmorillonite minerals, chalk, diatomaceous earth, sand, gravel, crushed rock, bauxite, limestone, sandstone, aerogels, xerogels, microspheres, porous ceramic spheres, gypsum dihydrate, calcium aluminate, magnesium carbonate, ceramic materials, pozzolamic materials, zirconium compounds, xonotlite, (a crystalline calcium silicate gel), perlite, vermiculite, hydrated or unhydrated hydraulic cement particles, pumice, perlite, zeolites, kaolin, natural and synthetic clays and treated and untreated clays, such as organoclays and clays which have been surface treated with silanes and stearic acid to enhance adhesion with the polyester matrix, smectite clays, magnesium aluminum silicate, bentonite clays, hectorite clays, silicon oxide, calcium terephthalate, aluminum oxide, titanium dioxide, iron oxides, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, polymer particles, powdered metals, pulp powder, cellulose, starch, chemically modified starch, thermoplastic starch, lignin powder, wheat, chitin, chitosan, keratin, gluten, nut shell flour, wood flour, corn cob flour, calcium carbonate, calcium hydroxide, glass beads, hollow glass beads, seagel, cork, seeds, gelatins, wood flour, saw dust, agar-based materials, reinforcing agents, such as glass fiber, natural fibers, such as sisal, hemp, cotton, wool, wood, flax, abaca, sisal, ramie, bagasse, and cellulose fibers, carbon fibers, graphite fibers, silica fibers, ceramic fibers, metal fibers, stainless steel fibers, recycled paper fibers, for example, from repulping operations. Fillers may increase the Young's modulus, improve the dead-fold properties, improve the rigidity of the film, coating, laminate, or molded article, decrease the cost, and/or reduce the tendency of the films, coatings, or laminates containing the polyesters to block or self-adhere during processing or use. The use of fillers has also been found to produce plastic articles which have many of the qualities of paper, such as texture and feel, as disclosed by, for example, Miyazaki, et. al., in U.S. Pat. No. 4,578,296.

The clay filler materials can be added before the polymerization process, at any stage during the polymerization process or as a post polymerization process. Essentially any filler material known for use in polyesters can be used in the polyester compositions produced by the processes disclosed herein.

Clay fillers include both natural and synthetic clays and untreated and treated clays, such as organoclays and clays which have been surface treated with silanes or stearic acid to enhance the adhesion with the polyester matrix. Specific examples of usable clay materials include kaolin, smectite clays, magnesium aluminum silicate, bentonite clays, montmorillonite clays, hectorite clays, and mixtures thereof. The clays can be treated with organic materials, such as surfactants, to make them organophilic. Examples of commercially available suitable clay fillers include Gelwhite® MAS 100 clay, a commercial product of the Southern Clay Company, which is defined as a white smectite clay, (magnesium aluminum silicate); Claytone® 2000 clay, a commercial product of the Southern Clay Company, which is defined as a an organophilic smectite clay; Gelwhite® L clay, a commercial product of the Southern Clay Company, which is defined as a montmorillonite clay from a white bentonite clay; Cloisite® 30 B clay, a commercial product of the Southern Clay Company, which is defined as an organophilic natural montmorillonite clay with bis(2-hydroxyethyl)methyl tallow quarternary ammonium chloride salt; Cloisite® Na clay, a commercial product of the Southern Clay Company, which is defined as a natural montmorillonite clay; Garamite® 1958 clay, a commercial product of the Southern Clay Company, which is defined as a mixture of minerals; Laponite® RDS clay, a commercial product of the Southern Clay Company, which is defined as a synthetic layered silicate with an inorganic polyphosphate peptiser; Laponite® RD clay, a commercial product of the Southern Clay Company, which is defined as a synthetic colloidal clay; Nanomer® clay, which are commercial products of the Nanocor Company, which are defined as montmorillonite minerals which have been treated with compatibilizing agents; Nanomer® 1.24TL clay, a commercial product of the Nanocor Company, which is defined as a montmorillonite mineral surface treated with amino acids; “P Series” Nanomer® clay, which are commercial products of the Nanocor Company, which are defined as surface modified montmorillonite minerals; Polymer Grade (PG) Montmorillonite PGW clay, a commercial product of the Nanocor Company, which is defined as a high purity aluminosilicate mineral, sometimes referred to as a phyllosilicate; Polymer Grade (PG) Montmorillonite PGA clay, a commercial product of the Nanocor Company, which is defined as a high purity aluminosilicate mineral, sometimes referred to as a phyllosilicate; Polymer Grade (PG) Montmorillonite PGV clay, a commercial product of the Nanocor Company, which is defined as a high purity aluminosilicate mineral, sometimes referred to as a phyllosilicate; Polymer Grade (PG) Montmorillonite PGN clay, a commercial product of the Nanocor Company, which is defined as a high purity aluminosilicate mineral, sometimes referred to as a phyllosilicate; and mixtures thereof. Essentially any clay filler known can be used. Some of the clay fillers may exfoliate to provide nanocomposites. This is especially true for layered silicate clays, such as smectite clays, magnesium aluminum silicate, bentonite clays, montmorillonite clays, and hectorite clays. As discussed above, such clays can be natural or synthetic, treated or not.

The particle size of the clay filler can be within a wide range when used in the polyester compositions. As one skilled within the art would appreciate, the filler particle size can be tailored based on the desired use of the filled polyester composition. It is generally preferable that the average diameter of the filler be less than about 40 microns. It is more preferable that the average diameter of the filler be less than about 20 microns. The filler can include particle sizes ranging up to 40 mesh, (US Standard), or larger. Mixtures of filler particle sizes can also be advantageously used. For example, mixtures of calcium carbonate fillers with average particle sizes of about 5 microns and of about 0.7 microns may provide better space filling of the filler within the polyester matrix than such fillers havine a single average particle size. Use of two or more filler particle sizes allows for improved particle packing, which can be accomplished by selecting two or more ranges of filler particle sizes such that the spaces between a group of larger particles are substantially occupied by a selected group of smaller filler particles. In general, the particle packing is increased whenever any given set of particles is mixed with another set of particles having a particle size that is at least about 2 times larger or smaller than the first group of particles. The particle packing density for a two-particle system is generally maximized whenever the size ratio of a given set of particles is from about 3 to 10 times the size of another set of particles. Similarly, three or more different sets of particles can be used to further increase the particle packing density. The optimal degree of packing density depends on a number of factors, such as, for example, the types and concentrations of the various components within both the thermoplastic phase and the solid filler phase, the film, coating or lamination process used, and the desired mechanical, thermal and other performance properties of the products to be manufactured. Andersen, et. al., in U.S. Pat. No. 5,527,387, disclose particle packing techniques. Filler concentrates containing a mixture of filler particle sizes based on the above particle packing techniques are commercially available by the Shulman Company under the tradename Papermatch®.

Filler, other than pumice, can be added to the polyester at any stage during the polymerization of the polymer or after the polymerization is completed. For example, the fillers can be added with the polyester monomers at the start of the polymerization process. This is preferable for, for example, silica and titanium dioxide fillers, to provide adequate dispersion of the fillers within the polyester matrix. Alternatively, the filler can be added at an intermediate stage of the polymerization, for example, as the precondensate passes into the polymerization vessel. As yet a further alternative, the filler can be added after the polyester exits the polymerizer. For example, the polyester compositions can be melt fed to any intensive mixing operation, such as a static mixer or a single- or twin-screw extruder, and compounded with the filler.

As yet a further alternative, the polyester composition can be combined with the filler in a subsequent post polymerization process. Typically, such a process includes intensive mixing of the molten polyester with the filler. The intensive mixing can be provided by, for example, static mixers, Brabender mixers, single screw extruders, or twin screw extruders. Typically, the polyester is dried and the dried polyester is then mixed with the filler, or the polyester and the filler can be cofed into the extruder through two different feeders. In an extrusion process, the polyester and the filler are typically fed into the back, feed section of the extruder. However, the polyester and the filler can be advantageously fed into two different locations of the extruder. For example, the polyester can be added in the back, feed section of the extruder while the filler is fed (“side-stuffed”) in the front of the extruder near the die plate. The extruder temperature profile is set up to allow the polyester to melt under the processing conditions. The screw design will also provide stress and, in turn, heat, to the resin as it mixes the molten polyester with the filler. Such processes to melt mix in fillers are disclosed, for example, by Dohrer, et. al., in U.S. Pat. No. 6,359,050. Alternatively, the filler can be blended with the polyester during the formation of films and coatings as described below.

A particularly preferred filler for use in the polyester compositions containing pumice is carbon black. The addition of carbon black can provide enhanced UV stability and, advantageously, electrical properties, such as antistatic and conductivity properties. Carbon black filled polymers can be classified based on their electrical characteristics into three categories: antistatic, static dissipating or moderately conductive, and conductive. The terms “static” and “antistatic” refer to a material's ability to resist triboelectric charge generation. Antistatic materials are generally defined as not generating a charge, not allowing a charge to remain localized on a part's surface. Static dissipating or moderately conductive materials are generally defined as having surface resistivities in the range 100,000 to 1,000,000,000 Ohms/square. Polymeric materials can also be categorized based on the additional ability to be able to safely bleed an electric charge to ground. Conductive materials are generally defined as having surface resistivities below 100,000 Ohms/square. In addition, conductive materials will not generate a charge, will not allow a charge to remain localized on a part's surface, can ground a charge quickly, and will shield parts from electromagnetic fields. Electrical properties are described in, for example; Kubotera, et. al., in U.S. Pat. No. 6,540,945, and Nishihata, et. al., in U.S. Pat. No. 6,545,081.

The incorporation of carbon black component into parts made from polymers allows the parts to dissipate electrical charges formed on the part as it is being electrostatically painted, providing an even coating of paint over the entire part. Electrostatic painting of substrates is desirable because it can reduce paint waste and emissions as compared to non-electrostatic painting processes. This allows for relatively large parts to be consistently painted without color differences over the surface of the part. Parts made from polyester compositions according to the invention containing carbon black are electrostatically paintable while maintaining the majority of their desirable physical properties due to the low carbon loadings incorporated therein.

Herein, the conductive carbon black fillers are differentiated by their structure, as defined by dibutyl phthlate (DBP) absorption. Dibutyl phthalate absorption is measured according to ASTM Method Number D2414-93. The DBP has been related to the structure of carbon blacks; high structure carbon blacks typically also have high surface areas. The surface areas of carbon blacks can be measured by ASTM Method Number D3037-81, which measures the nitrogen adsorption (BET) of the carbon black. Preferably, the carbon black has a DBP absorption greater than about 150 cc/100 grams. More preferably, the carbon black fillers have a DBP value of at least about 220 cc/100 grams. The amount of the carbon black in the polyester can be optimized for the electrical properties desired, depending upon whether it is desired that the polyester be antistatic, static dissipating or moderately conductive, or conductive. Examples of commercially available carbon blacks preferred for use in the polyesters include: Ketjenblack® EC 600 JD carbon black available from the Akzo Company, Ketjenblack® EC 300 J carbon black available from the Akzo Company, Black Pearls® 2000 carbon black available from the Cabot Corporation, Printex® XE-2 carbon black available from the Cabot Corporation, Conductex® 975 carbon black available from the Columbian Company, and Vulcan® XC-72 carbon black available from the Cabot Company. The Ketjenblack® EC 600 JD carbon black is reported to have a DBP absorption of between 480 and 520 cc/100 grams and a nitrogen adsorption between 1250 and 1270 m2/g. The Ketjenblack® EC 300 J carbon black is reported to have a DBP absorption of between 350 and 385 cc/100 grams and a nitrogen adsorption of 800 m2/g. The Black Pearls® 2000 carbon black is reported to have a DBP absorption of 330 cc/100 grams and a nitrogen adsorption of between 1475 and 1635 m2/g. The Printex® XE-2 carbon black is reported to have a DBP absorption of between 380 and 400 cc/100 grams and a nitrogen adsorption of 1300 m2/g. The Conductex® 975 carbon black is reported to have a DBP absorption of 170 cc/100 grams and a nitrogen adsorption of 250 m2/g. The Vulcan® XC-72 carbon black is reported to have a DBP absorption of between 178 and 192 cc/100 grams and a nitrogen adsorption of 245 m2/g.

The amount of carbon black in the polyester composition is preferably about 15 weight percent or less. More preferably, the amount of carbon black in the polyester composition is from about 0.5 to about 10 weight percent, to obtain enhanced electrical properties and reduced resin melt viscosity. More preferably, the amount of carbon black in the polyester composition is from about 1.0 to about 7 weight percent based on enhanced electrical properties and reduced resin melt viscosity.

The carbon black can be added as a dry, raw black, as a slurry in a suitable fluid, preferably the above mentioned glycol component, or as a dispersion in a suitable fluid, preferably the above mentioned glycol component. To produce the carbon black dispersions, a slurry of the carbon black, e.g., a preferred glycol-carbon black slurry, can be subjected to intensive mixing and grinding. Suitable types of mechanical dispersing equipment include ball mills, Epenbauch mixers, Kady high shear mill, sandmills (for example, a 3P Redhead sandmill), and attrition grinding apparatuses.

A carbon black dispersion can be produced, for example, in a ball milling process by adding the carbon black to a glycol, such as ethylene glycol, to a ball mill with ceramic or stainless steel balls, and rotating the ball mill for the amount of time necessary to produce the desired dispersion, typically from 0.5 to 50 hours. The dispersion can further be centrifuged to remove any large particles of the carbon black or the grinding media, if desired.

The amount of carbon black dispersed within the glycol depends on the structure and nature of the carbon black to be dispersed. The practical upper limit is the amount that can be dispersed homogeneously in the liquid, e.g., glycol.

A dispersing agent, to enhance the wetting of the carbon particles by the liquid and to help maintain the formation of stable dispersions, can be incorporated into the carbon black, if desired. Examples of suitable dispersing agents include: polyvinylpyrrolidone, epoxidized polybutadiene, sodium salts of sulfonated naphthalene, and fatty acids. The amount of the dispersing agent is typically in the range of about 0.1 to 8 weight percent of the total dispersion, (carbon black, dispersing agent, and liquid, wherein the liquid is preferably glycol).

Preferably, the process includes adding the carbon black during the initial stages of the polyester polymerization process. The carbon black can be added at any stage of the polyester polymerization, preferably prior to the polyester achieving an inherent viscosity of above about 0.20 dL/g. The carbon black component is more preferably added at the monomer stage, such as with the dicarboxylic acid or with the glycol component, or to the initial (trans)esterification product, present as precondensates, ranging from the bis(glycolate) to polyester oligomers with degrees of polymerization (DP) of about 10 or less. Even more preferably, the carbon black is added with the glycol or to the initial (trans)esterification product.

In some embodiments, the polyesters contain pumice fillers in combination with other, heavy metal-free catalysts and other fillers. In some embodiments, the polyester contains pumice fillers that have been used as catalysts in forming the polyesters, in combination with other, heavy metal-free catalysts.

The polyesters, the pumice, the other, heavy metal-free catalysts, the other fillers, and the processes for producing the polyesters are described above. The other, heavy metal-free catalysts do not contain components derived from heavy metals, such antimony. Heavy metals, as used herein, include elements having atomic weights between 63.546 and 200.590. The other, heavy metal-free catalysts that can be used include, for example, salts of Li, Ca, Mg, Mn, and Ti, such as acetate salts and oxides, including glycol adducts, and Ti alkoxides. A specific catalyst or combination or sequence of catalysts used can be selected by a skilled practitioner. The preferred catalyst and preferred conditions depend on, for example, whether the dicarboxylic acid component is polymerized as the free dicarboxylic acid, as a dimethyl ester, or as a bisglycolate, and the chemical composition of the glycol component. Essentially any heavy metal-free catalyst system known can be used.

In some embodiments, the processes, which are described hereinabove, include the addition of the other, heavy metal-free catalysts during the initial stages of the polyester polymerization process. The other, heavy metal-free catalyst component can be added at any stage of the polyester polymerization prior to the polyester achieving an inherent viscosity of above about 0.20 dL/g. The other, heavy metal-free catalyst component is preferably added at the monomer stage, such as with the dicarboxylic acid component or with the glycol component, or to the initial (trans)esterification product (precondensates), ranging from the bis(glycolate) to polyester oligomers with degrees of polymerization, (DP), of about 10 or less. More preferably, the other, heavy metal-free catalyst component is added with the glycol component or to the initial (trans)esterification product. The catalyst used can be modified as the reaction proceeds. The catalyst can be deactivated during the course of the polymerization, for example, by the addition of phosphoric acid.

Preferably, the amount of heavy metal-free catalyst is at least about 0.0001 weight percent based on the total weight of the polyester composition. More preferably, the other, heavy metal-free catalysts are incorporated at from about 0.0001 weight percent to about 1 weight percent based on the total weight of the polyester composition. Most preferably, the amount of heavy metal-free catalysts is from about 0.0001 weight percent to about 0.5 weight percent based on the total weight of the polyester composition.

A further aspect of the present invention includes processes for producing polyester compositions containing pumice fillers in combination with one or more heavy metal-containing catalysts and shaped articles produced therefrom. Optionally, other heavy-metal free catalysts can be included. The polyesters, the pumice, the other, heavy metal-free catalysts, and the processes for producing the polyesters are described above. The heavy metal-containing catalysts contain components derived from heavy metals, such antimony. Heavy metals, as the term is used herein, are elements having atomic weights from 63.546 to 200.590. The heavy metal-containing catalysts that can be used include, for example, salts of Zn, Pb, Sb, Sn, and Ge, such as acetate salts and oxides, including glycol adducts. Such salts are known, and a specific catalyst, or combination or sequence of catalysts, used can be readily selected by a skilled practitioner. The preferred catalyst and preferred conditions depend on, for example, whether the dicarboxylic acid component is polymerized as the free dicarboxylic acid, as a dimethyl ester, or as a bisglycolate, and the chemical composition of the glycol component. Essentially any catalyst system known within the art can be used.

The processes, as described above, can include the addition of the heavy metal-containing catalysts within the polyester polymerization production process. The heavy metal-containing catalyst component can be added during the initial stages of the polyester polymerization process. The heavy metal-containing catalyst can be added at any stage of the polyester polymerization prior to the polyester achieving an inherent viscosity above about 0.20 dL/g. The heavy metal-containing catalyst component is preferably added at the monomer stage, such as with the dicarboxylic acid component or with the glycol component, or to the initial (trans)esterification product, (precondensates), ranging from the bis(glycolate) to polyester oligomers with degrees of polymerization, (DP), of about 10 or less. More preferably, the heavy metal-containing catalyst component is added with the glycol component or to the initial (trans)esterification product. The catalyst used can be modified as the reaction proceeds.

Preferably, the amount of heavy metal-containing catalyst is at least about 0.0001 weight percent based on the total weight of the polyester composition. More preferably, the amount of heavy metal-containing catalysts from about 0.0001 weight percent to about 1 weight percent based on the total weight of the polyester composition. Most preferably, the amount of heavy metal-containing catalysts is from about 0.0001 weight percent to about 0.5 weight percent based on the total weight of the polyester composition.

A further aspect of the present invention includes processes for producing polyester compositions containing pumice fillers in combination with heavy metal-containing catalysts and other fillers, and shaped articles produced therefrom. Optionally, other heavy-metal free catalysts can be included. The polyesters, the pumice, the heavy metal-containing catalysts, the other, heavy metal-free catalysts, the other fillers, and the processes for producing the polyesters and articles are described above.

A further aspect of the present invention includes polyesters containing a perlite filler as a catalyst, processes for producing the polyesters, and shaped articles formed therefrom. The polyesters contain a dicarboxylic acid component, a glycol component, and, optionally, a polyfunctional branching agent component, as described above. In some embodiments, the perlite functions as a catalyst and a filler. In other embodiments, the perlite functions solely as a catalyst. When perlite is used as a polymerization catalyst and not intended to function substantially as a filler, the amount of perlite is preferably from about 0.0001 to about 0.5 weight percent, and more preferably from about 0.0001 to about 0.1 weight percent, based on the total weight of the polyester composition. In addition to perlite as a catalyst and/or filler, other catalysts, which can be heavy metal-free catalysts or heavy metal-containing catalysts, can be used.

Perlite is a generic term for naturally occurring silicious rock formed from the hydration of rhyolitic obsidian, which is produced after the sudden cooling of molten lava. The average chemical composition of perlite can be characterized as 74 weight percent silicone dioxide, 13 weight percent aluminum oxide, 5 weight percent potassium oxide, 3 weight percent sodium oxide, 1 weight percent ferric oxide, and 4 weight percent water. Perlite can be expanded to a low density form of perlite, depending upon the amount of water contained therein. When perlite is heated to above 871 C, the crude perlite pops in a manner similar to popcorn. As used herein, the term “perlite” includes expanded and unexpanded perlite. Preferably, the polyester compositions containing perlite contain at least about 0.0001 weight percent of the perlite filler, based on the total weight of the polyester composition. More preferably, the amount of perlite filler is from about 0.0001 weight percent to about 30 weight percent based on the total weight of the polyester composition, more preferably about 0.0001 weight percent to about 20 weight percent based on the total weight of the polyester composition. Preferably, the nominal particle size of the perlite is about 100 microns or less. More preferably, the nominal particle size of the perlite is about 50 microns or less. The perlite particle can optionally be coated with, for example, silicone, siloxane, or polyester materials. In some embodiments, the polyester also contains additional fillers. In some embodiments, the polyester also contains heavy-metal containing catalysts. In some embodiments, the polyester also contains heavy-metal-free catalysts.

The perlite is added during the initial stages of the polyester polymerization process. The perlite can be added at any stage of the polyester polymerization prior to the polyester achieving an inherent viscosity of above about 0.20 dL/g. The perlite is preferably added at the monomer stage, such as with the dicarboxylic acid component or with the glycol component, or to the initial (trans)esterification product, (precondensates), ranging from the bis(glycolate) to polyester oligomers with degrees of polymerization, (DP), of about 10 or less. More preferably, the perlite is added with the glycol component or to the initial (trans)esterification product. The polyester compositions can be prepared by conventional polycondensation techniques, as described above.

The polyester compositions can contain other known additives. Such additives include thermal stabilizers, for example, phenolic antioxidants, secondary thermal stabilizers, for example, thioethers and phosphites, UV absorbers, for example benzophenone- and benzotriazole-derivatives, and UV stabilizers, for example, hindered amine light stabilizers (HALS). Other additives that can be used include plasticizers, processing aides, flow enhancing additives, lubricants, pigments, flame retardants, impact modifiers, nucleating agents to increase crystallinity, antiblocking agents such as silica, base buffers, such as sodium acetate, potassium acetate, and tetramethyl ammonium hydroxide (for example; as disclosed in U.S. Pat. No. 3,779,993, U.S. Pat. No. 4,340,519, U.S. Pat. No. 5,171,308, U.S. Pat. No. 5,171,309, and U.S. Pat. No. 5,219,646 and references cited therein). Specific examples of plasticizers, which can be added to improve processing, mechanical properties, or to reduce rattle or rustle of the films, coatings and laminates of the present invention, include soybean oil, epoxidized soybean oil, corn oil, caster oil, linseed oil, epoxidized linseed oil, mineral oil, alkyl phosphate esters, Tween® 20 plasticizers, Tween® 40 plasticizers, Tween® 60 plasticizers, Tween® 80 plasticizers, Tween® 85 plasticizers, sorbitan monolaurate, sorbitan monooleate, sorbitan monopalmitate, sorbitan trioleate, sorbitan monostearate, citrate esters, such as trimethyl citrate, triethyl citrate, (Citroflex® 2 plasticizer, produced by Morflex, Inc. Greensboro, N.C.), tributyl citrate, (Citroflex® 4 plasticizer, produced by Morflex, Inc., Greensboro, N.C.), trioctyl citrate, acetyltri-n-butyl citrate, (Citroflex® A-4 plasticizer, produced by Morflex, Inc., Greensboro, N.C.), acetyltriethyl citrate, (Citroflex® A-2 plasticizer, produced by Morflex, Inc., Greensboro, N.C.), acetyltri-n-hexyl citrate, (Citroflex® A-6 plasticizer, produced by Morflex, Inc., Greensboro, N.C.), and butyryltri-n-hexyl citrate, (Citroflex® B-6 plasticizer, produced by Morflex, Inc., Greensboro, N.C.), tartarate esters, such as dimethyl tartarate, diethyl tartarate, dibutyl tartarate, and dioctyl tartarate, poly(ethylene glycol), derivatives of poly(ethylene glycol), paraffin, monoacyl carbohydrates, such as 6-O-sterylglucopyranoside, glyceryl monostearate, Myvaplex® 600 plasticizer, (concentrated glycerol monostearates), Nyvaplex® plasticizer, (concentrated glycerol monostearate which is a 90% minimum distilled monoglyceride produced from hydrogenated soybean oil and which is composed primarily of stearic acid esters), Myvacet® plasticizer, (distilled acetylated monoglycerides of modified fats), Myvacet® 507 plasticizer, (48.5 to 51.5 percent acetylation), Myvacet® 707 plasticizer, (66.5 to 69.5 percent acetylation), Myvacet® 908 plasticizer, (minimum of 96 percent acetylation), Myverol® plasticizer, (concentrated glyceryl monostearates), Acrawax® plasticizer, N,N-ethylene bis-stearamide, N,N-ethylene bis-oleamide, dioctyl adipate, diisobutyl adipate, diethylene glycol dibenzoate, dipropylene glycol dibenzoate, polymeric plasticizers, such as poly(1,6-hexamethylene adipate), poly(ethylene adipate), Rucoflex® plasticizer, and other compatible low molecular weight polymers and mixtures thereof. Essentially any additive known within the art can be used.

The polyester compositions produced by the processes can be blended with other polymeric materials. Examples of blendable polymeric materials include polyethylene, high density polyethylene, low density polyethylene, linear low density polyethylene, ultralow density polyethylene, polyolefins, poly(ethylene-co-glycidylmethacrylate), poly(ethylene-co-methyl(meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth)acrylic acid), metal salts of poly(ethylene-co-(meth)acrylic acid), poly((meth)acrylates), such as poly(methyl methacrylate), poly(ethyl methacrylate), poly(ethylene-co-carbon monoxide), poly(vinyl acetate), poly(ethylene-co-vinyl acetate), poly(vinyl alcohol), poly(ethylene-co-vinyl alcohol), polypropylene, polybutylene, polyesters, poly(ethylene terephthalate), poly(1,3-propylene terephthalate), poly(1,4-butylene terephthalate), PETG, poly(ethylene-co-1,4-cyclohexanedimethanol terephthalate), polyetheresters, poly(vinyl chloride), PVDC, poly(vinylidene chloride), polystyrene, syndiotactic polystyrene, poly(4-hydroxystyrene), novalacs, poly(cresols), polyamides, nylon, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, sulfonated aliphatic-aromatic copolyesters, such as are sold under the Biomax® tradename by the DuPont Company, aliphatic-aromatic copolyesters, such as are sold under the Eastar Bio® tradename by the Eastman Chemical Company, (Eastar Bio® is chemically believed to be essentially poly(1,4-butylene adipate-co-terephthalate, (55:45, molar)), sold under the Ecoflex® tradename by the BASF Corporation, (Ecoflex® is believed to be essentially poly(1,4-butylene terephthalate-co-adipate, (50:50, molar) and can be chain-extended through the addition of hexamethylenediisocyanate), and sold under the EnPol® tradename by the Ire Chemical Company, aliphatic polyesters, such as poly(1,4-butylene succinate), (Bionolle® 1001, from Showa High Polymer Company), poly(ethylene succinate), poly(1,4-butylene adipate-co-succinate), (Bionolle® 3001, from the Showa High Polymer Company), and poly(1,4-butylene adipate) as, for example, sold by the Ire Chemical Company under the tradename of EnPol®, sold by the Showa High Polymer Company under the tradename of Bionolle®, sold by the Mitsui Toatsu Company, sold by the Nippon Shokubai Company, sold by the Cheil Synthetics Company, sold by the Eastman Chemical Company, and sold by the Sunkyon Industries Company, poly(amide esters), for example, as sold under the Bak® tradename by the Bayer Company, (these materials are believed to include the constituents of adipic acid, 1,4-butanediol, and 6-aminocaproic acid), polycarbonates, for example such as poly(ethylene carbonate) sold by the PAC Polymers Company, poly(hydroxyalkanoates), such as poly(hydroxybutyrate)s, poly(hydroxyvalerate)s, poly(hydroxybutyrate-co-hydroxyvalerate)s, for example such as sold by the Monsanto Company under the Biopol® tradename, poly(lactide-co-glycolide-co-caprolactone), for example as sold by the Mitsui Chemicals Company under the grade designations of H100J, S100, and T100, poly(caprolactone), for example as sold under the Tone(R) tradename by the Union Carbide Company and as sold by the Daicel Chemical Company and the Solvay Company, and poly(lactide), for example as sold by the Cargill Dow Company under the tradename of EcoPLA® and the Dianippon Company and copolymers thereof and mixtures thereof.

Examples of blendable natural polymeric materials include starch, starch derivatives, modified starch, thermoplastic starch, cationic starch, anionic starch, starch esters, such as starch acetate, starch hydroxyethyl ether, alkyl starches, dextrins, amine starches, phosphate starches, dialdehyde starches, cellulose, cellulose derivatives, modified cellulose, cellulose esters, such as cellulose acetate, cellulose diacetate, cellulose priopionate, cellulose butyrate, cellulose valerate, cellulose triacetate, cellulose tripropionate, cellulose tributyrate, and cellulose mixed esters, such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethycellulose, and hydroxyethylpropylcellulose, polysaccharides, alginic acid, alginates, phycocolloids, agar, gum arabic, guar gum, acaia gum, carrageenan gum, furcellaran gum, ghatti gum, psyllium gum, quince gum, tamarind gum, locust bean gum, gum karaya, xantahn gum, gum tragacanth, proteins, Zein®, (a prolamine derived from corn), collagen, (extracted from animal connective tissue and bones), and derivatives thereof such as gelatin and glue, casein, (the principle protein in cow milk), sunflower protein, egg protein, soybean protein, vegetable gelatins, gluten, and mixtures thereof. Thermoplastic starch can be produced, for example, as disclosed in U.S. Pat. No. 5,362,777. They disclose the mixing and heating of native or modified starch with high boiling plasticizers, such as glycerin or sorbitol, in such a way that the starch has little or no crystallinity, a low glass transition temperature, and a low water content. This should not be taken as limiting. Essentially any polymeric material known can be blended with the polyester composition.

The additives, plasticizers, and the polymeric materials to be blended with the polyester can be introduced at any stage during the polymerization of the polyester, or after the polymerization is completed. For example, the additives, plasticizers, and/or polymeric materials can be added with the polyester monomers at the start of the polymerization process. Alternatively, the additives, the plasticizers, and/or polymeric materials can be added at an intermediate stage of the polymerization, for example, as the precondensate passes into the polymerization vessel. As yet a further alternative, the additives, the plasticizers, and/or polymeric materials can be added after the polyester exits the polymerizer. For example, the polyester and the additives, the plasticizers, and the polymeric materials can be melt fed to any intensive mixing operation, such as a static mixer or a single- or twin-screw extruder and compounded with the additives, the plasticizers, and the polymeric materials.

As yet a further method to produce the blends of the polyesters and the additives, plasticizers, and/or polymeric materials, the polyester can be combined with the additives, the plasticizers, and the polymeric materials in a subsequent post polymerization process. Typically, such a process includes intensive mixing of the molten polyester with the additives, the plasticizers, and the polymeric materials. The intensive mixing can be provided by, for example, static mixers, Brabender mixers, single screw extruders, and twin screw extruders. In a typical process, the polyester is dried. The additives, the plasticizers, and the polymeric materials can also be dried. The dried polyester can then be mixed with the additives, plasticizers, and/or polymeric materials. Alternatively, the polyester and the additives, plasticizers, and/or polymeric materials can be co-fed into an extruder through two different feeders. In a conventional extrusion process, the polyester and the additives, the plasticizers, and the polymeric materials are typically fed into the back, feed section of the extruder. However, the polyester and the additives, plasticizers, and/or the polymeric materials can be advantageously fed into two different locations of the extruder. For example, the polyester can be added in the back, feed section of the extruder while the additives, the plasticizers, and/or polymeric materials are fed (“side-stuffed”) in the front of the extruder near the die plate. The extruder temperature profile is set up to allow the polyester to melt under the processing conditions. The screw design also provide stresses and, in turn, heat, to the resin as it mixes the molten polyester with the additives, the plasticizers, and/or polymeric materials. Alternatively, the additives, the plasticizers, and/or polymeric materials can be blended with the polyester during the formation of films and coatings in processes described below.

The polyester compositions can be used in making a wide variety of shaped articles. The pumice and/or perlite fillers incorporated within the polyesters provide enhanced strength, abrasion resistance, stiffness, and other benefits to the shaped articles. Shaped articles include, for example, film, sheets, fiber, monofilaments, nonwoven structures, melt blown containers, molded parts, foamed parts, polymeric melt extrusion coatings onto substrates, and polymeric solution coatings onto substrates. The polyesters can be used in any shaped article that can be made from a polyester, by any known process.

In a preferred embodiment, the polyesters are used in making molded parts and articles derived therefrom. Molding of the polyesters into shaped articles can be performed by any known process, such as compression molding or melt forming. Melt forming can be carried out using known methods for forming thermoplastics, such as injection molding, thermoforming, extrusion, blow molding, or any combination thereof.

Compression molding can be carried out using any know process. Examples of compression molding processes include hand molds, semiautomatic molds, and automatic molds. The three common types of mold designs include open flash, fully positive, and semipositive. In conventional compression molding operations, the polyester, in essentially any form, such as powder, pellet, or disc, is preferably dried and heated. The heated polyester is then loaded into a mold, which is typically held at a temperature between 150 to 300° C., depending on the polyester composition. The mold is then partially closed and pressure is exerted. The pressure is generally between 2000 and 5000 psi, but depends on several factors including the compression molding process utilized, the polyester material, the part to be molded. The polyester is melted by the action of the heat and the exerted pressure, and flows into the recesses of the mold to form the shaped molded article.

Injection molding is the most preferred process to mold the shaped articles from the polyesters. Injection molding can be carried out using any known process. The polyester can be in essentially any form, such as powder, pellet or disc. Pellet form is preferable for ease of conveyance. The polyester is preferably dried prior to molding. Generally, the polyester is fed into the back end of an extruder, typically with an automatic feeder, such as a K-Tron® or Accurate® feeder. Other desired additives, plasticizers, and blend materials, as described above, can be pre-compounded with the polyester or cofed to the extruder. The polyester composition is then melted within the extruder and conveyed to the end of the extruder. Typically a hydraulic cylinder then pushes the screw forward to inject the molten polyester composition into the mold. The mold is generally clamped together by pressure. The mold is generally set at such a temperature that allows the polyester to crystallize and set up. Because of the wide variation in possible polyester compositions, the desirable mold temperature can vary over a wide range. Generally it is from about room temperature to about 200° C. The mold can be heated by steam, hot water, gas, electricity, (such as resistance heaters, band heaters, low-voltage heaters, and induction heaters), or hot oil. Typically, the mold temperature is set to provide the shortest mold cycle time possible. For slow crystallizing materials, such as poly(ethylene terephthalate), typically electrical heaters or hot oil is desired. For rapidly crystallizing materials, such as poly(1,4-butylene terephthalate), steam heat can be sufficient. Once the shaped article has solidified, the mold pressure is released, the mold opened and the part is ejected from the mold cavity, typically with the help of knockout pins, ejector pins, knockout plates, stripper rings, compressed air, or combinations thereof.

Molding can produce a wide variety of shaped articles, including, for example; discs, plaques, bushings, automotive parts, such as door handles, window cranks, electrical parts, electronic mechanical parts, electrochemical sensors, positive temperature coefficient devices, temperature sensors, semiconductive shields for conductor shields, electrothermal sensors, electrical shields, high permittivity devices, housing for electronic equipment, containers and pipelines for flammable solids, powders, liquids, and gases. Molded parts made from polyester compositions containing carbon black can be used in laser marking applications, for example for identification purposes. The polyester compositions are particularly useful as “appearance parts”, that is, parts in which the surface appearance is important. Wollastonite reinforcing fillers do not damage the surface properties molded parts as do other commonly used reinforcing agents, such as glass fiber, whether or not the part is coated with paint or another material such as a metal. Examples of such parts include automotive body panels such as fenders, fascia, hoods, tank flaps, rocker panels, spoilers, and other interior and exterior parts; interior automotive panels, automotive trim parts, appliance parts such as handles, control panels, chassises (cases), washing machine tubs and exterior parts, interior or exterior refrigerator panels, and dishwasher front or interior panels; power tool housings such as drills and saws; electronic cabinets and housings such as personal computer housings, printer housings, peripheral housings, server housings; exterior and interior panels for vehicles such as trains, tractors, lawn mower decks, trucks, snowmobiles, aircraft, and ships; decorative interior panels for buildings; furniture such as office and/or home chairs and tables; and telephones and other telephone equipment. The parts can be painted or they can be left unpainted. Automotive body panels are an especially challenging application, in which the polyesters preferably have smooth and reproducible appearance surfaces, are heat resistant so they can pass through without significant distortion automotive E-coat and paint ovens where temperatures may reach as high as about 200° C. for up to 30 minutes for each step, and are tough enough to resist denting or other mechanical damage from minor impacts.

The incorporation of the carbon black into the polyester compositions provides certain electrical properties. For example, the presence of carbon black in the polyester compositions allows molded parts made therefrom to dissipate electrical charges formed on the part as it is being electrostatically painted, providing an even coating of paint over the entire part. Electrostatic painting of parts is desirable because it can reduce paint waste and emissions as compared to non-electrostatic painting processes, and allows for relatively large parts to be consistently painted without color differences over the surface of the part. A significant advantage of the polyester compositions containing the carbon black is that they are electrostatically paintable while maintaining the majority of their desirable physical properties, due to relatively low quantities of carbon black content therein.

Also provided are films containing the polyester compositions and articles made therefrom. Polymeric films have a variety of uses, such as in packaging, especially of foodstuffs, adhesives tapes, insulators, capacitors, photographic development, x-ray development and as laminates, for example. Of particular note, the films produced from the polyester compositions containing carbon black can be used in EMI shielding, as protective film for microwave antennas, as a radome, as a sunshield, packaging for electrically sensitive products, such as electronics, conductive film, charge-transporting components for electrographic imaging equipment. Films made from polyester compositions containing low amounts of carbon black can be used for laser marking for identification purposes. Where heat resistance of the film is an important factor, a higher melting point, glass transition temperature, and crystallinity amount are desirable to provide better heat resistance and more stable electrical characteristics. Further, it is desired that the films have good barrier properties, for example; moisture barrier, oxygen barrier and carbon dioxide barrier, good grease resistance, good tensile strength and a high elongation at break.

For polyesters to be used in making films, the monomer composition is preferably chosen to result in a partially crystalline polymer desirable for the formation of film, wherein the crystallinity provides strength and elasticity. As first produced, the polyester is generally semi-crystalline in structure. The crystallinity increases on reheating and/or stretching of the polymer, as occurs in the production of film.

Films can be made from the polyesters by any process known. For example, thin films can be formed by dipcoating as disclosed in U.S. Pat. No. 4,372,311, by compression molding as disclosed in U.S. Pat. No. 4,427,614, through melt extrusion as disclosed in U.S. Pat. No. 4,880,592, by melt blowing as disclosed in U.S. Pat. No. 5,525,281, or other known processes. The films are preferably made by solution casting or extrusion. Extrusion is particularly preferred for formation of “endless” products, such as films and sheets, which emerge as a continuous length. In extrusion, the polymeric material, whether provided as a molten polymer or as plastic pellets or granules, is fluidized and homogenized. Additives, as described above, such as thermal or UV stabilizers, plasticizers, fillers and/or blendable polymeric materials, can be added, if desired. This mixture is then forced through a suitably shaped die to produce the desired cross-sectional film shape. The extruding force can be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders can be used as known. Different kinds of die are used to produce different products, such as blown film (formed by a blow head for blown extrusions), sheets and strips (slot dies) and hollow and solid sections (circular dies). In this manner, films of different widths and thickness can be produced. After extrusion, the polymeric film is taken up on rollers, cooled and taken off by suitable devices which are designed to prevent any subsequent deformation of the film.

Using extruders, film can be produced by extruding a thin layer of polymer over chilled rolls and then further drawing down the film to size by tension rolls. In the extrusion casting process, the polymer melt is conveyed from the extruder through a slot die, (T-shaped or “coat hanger” die). The die can be as wide as 10 feet and typically have thick wall sections on the lands to minimize deflection of the lips from internal pressure. Die openings can vary within a wide range, but 0.015 inch to 0.030 inch is typical. The nascent cast film can be drawn down, and thinned significantly, depending on the speed of the rolls taking up the film. The film is then solidified by cooling below the crystalline melting point or glass transition temperature. This can be accomplished by passing the film through a water bath or over two or more chrome-plated chill rolls which have been cored for water cooling. The cast film is then conveyed though nip rolls, a slitter to trim the edges, and then wound up. In cast film, conditions can be tailored to allow a relatively high degree of orientation in the machine direction, especially at high draw down conditions and wind up speeds, and a much lower amount of orientation in the transverse direction. Alternatively, the conditions can be tailored to minimize the amount of orientation, thus providing films with essentially equivalent physical properties in both the machine direction and the transverse direction. Preferably, the finished film is 0.25 mm thick or less.

Blown film, which is generally stronger, tougher, and made more rapidly than cast film, is made by extruding a tube. In producing blown film, the melt flow of molten polymer is typically turned upward from the extruder and fed through an annular die. In so doing, the melt flows around a mandrel and emerges through the ring-shaped opening in the form of a tube. As the tube leaves the die, internal pressure is introduced through the die mandrel with air, which expands the tube from about 1.5 to about 2.5 times the die diameter and simultaneously draws the film, causing a reduction in thickness. The air contained in the bubble cannot escape because it is sealed by the die on one end and by nip (or pinch) rolls on the other. Desirably, an even air pressure is maintained to ensure uniform thickness of the film bubble. The tubular film can be cooled internally and/or externally by directing air onto the film. Faster quenching in the blown film method can be accomplished by passing the expanded film about a cooled mandrel which is situated within the bubble. For example, one such method using a cooled mandrel is disclosed by Bunga, et. al., in Canadian Patent 893,216. If the polymer which is being used to prepare blown film is semicrystalline, the bubble can become cloudy as it cools below the softening point of the polymer. Drawdown of the extrudate is not essential, but preferably the drawdown ratio is between 2 and 40. The draw down ratio is defined as the ratio of the die gap to the product of the thickness of the cooled film and the blow-up ratio. Draw down can be induced by tension from pinch rolls. Blow-up ratio is the ratio of the diameter of the cooled film bubble to the diameter of the circular die. The blow up ratio can be as great as 4 to 5, but 2.5 is more typical. The draw down induces molecular orientation with the film in the machine direction, (i.e.; direction of the extrudate flow), and the blow-up ratio induces molecular orientation in the film in the transverse or hoop direction. The quenched bubble moves upward through guiding devices into a set of pinch rolls which flatten it. The resulting sleeve may subsequently be slit along one side, making a larger film width than could be conveniently made via the cast film method. The slit film can be further gusseted and surface-treated in line. In addition, the blown film can be produced by more elaborate techniques, such as the double bubble, tape bubble, or trapped bubble processes. The double-bubble process is a technique in which the polymeric tube is first quenched and then reheated and oriented by inflating the polymeric tube above the Tg but below the crystalline melting temperature, (Tm), of the polyester, (if the polyester is crystalline). The double bubble technique has been described within the common art, for example, by Pahkle in U.S. Pat. No. 3,456,044.

Preferred conditions for producing a blown film are determined by a complex combination of many factors, such as the chemical composition of the polymer, the amount and type of additives, such as plasticizers, and the thermal properties of the polymeric composition. However, the blown film process offers many advantages, such as the relative ease of changing the film width and caliber simply by changing the volume of air in the bubble and the speed of the screw, the elimination of end effects, and the capability of providing biaxial orientation in the as produced film. Typical film thicknesses from a blown film operation can be in the range of about 0.004 to 0.008 inch and the flat film width may range up to 24 feet or larger after slitting.

A sheeting calender, a machine comprising a number of heatable parallel cylindrical rollers which rotate in opposite directions and spread out the polymer and stretch it to the required thickness, can be used for manufacturing large quantities of film. A rough film is fed into the gap of the calender, and the last roller smooths the film produced in the calender. If the film is required to have a textured surface, the last roller is provided with an appropriate embossing pattern. Alternatively, the film can be reheated and then passed through an embossing calender. The calender is followed by one or more cooling drums. Finally, the finished film is reeled up.

Extruded films can also be used as starting materials for other finished products. For example, the film can be cut into small segments for use as feed material for other processing methods, such as injection molding. As a further example, the film can be laminated onto a substrate as described below. As yet a further example, the films can be metallized, using known processes. The film tubes from blown film operations can be converted to bags using, for example, heat sealing processes.

The extrusion process can be combined with a variety of post-extrusion operations for expanded versatility. Such operations include altering round to oval shapes, blowing the film to different dimensions, machining and punching, biaxial stretching, as known to those skilled in the art.

Solution casting produces more consistently uniform gauge film than does melt extrusion. Solution casting comprises dissolving polymeric material in the form of, for example granules or powder, in a suitable solvent with any desired formulants, such as plasticizer or colorant. The solution is filtered to remove dirt or large particles and cast from a slot die onto a moving belt, preferably of stainless steel, and dried, whereupon the film cools. The extrudate thickness is five to ten times that of the finished film. The film can then be finished using methods used for extruded film. One of ordinary skill in the art can determine appropriate process parameters based on the polymeric composition and the process used for film formation. The solution cast film can be subjected to the same post treatments as described for the extrusion cast film.

Multilayer films may also be produced, containing one or more layers made from the polyesters and one more additional layers and having bilayer, trilayer, and other multilayer film structures. One advantage to multilayer films is that specific properties can be tailored into the film to solve critical use needs while allowing the more costly ingredients to be relegated to the outer layers where they provide the greater needs. The multilayer film structures can be formed by coextrusion, blown film, dipcoating, solution coating, blade, puddle, air-knife, printing, Dahlgren, gravure, powder coating, spraying, or other processes. The additional layers can be made of the polyesters disclosed herein, or of other materials useful as blend materials, as described above. Generally, the multilayer films are produced by extrusion casting processes. For example, the resin materials can be heated in a uniform manner, and the resulting molten material conveyed to a coextrusion adapter that combines the molten materials to form a multilayer coextuded structure. The layered polymeric material is transferred through an extrusion die opened to a predetermined gap, commonly in the range of from about 0.05 inch (0.13 cm) and 0.012 inch (0.03 cm). The material is then drawn down to the intended gauge thickness by a primary chill or casting roll maintained at typically in the range of about 15 to 55 C, (60 -130 F). Typical draw down ratios range from about 5:1 to about 40:1. The layers may serve as barrier layers, adhesive layers, antiblocking layers, or for other purposes. Further, for example, the inner layers can be filled and the outer layers can be unfilled, as disclosed in U.S. Pat. No. 4,842,741 and U.S. Pat. No. 6,309,736. Production processes are well known and are disclosed, for example, in U.S. Pat. No. 3,748,962, U.S. Pat. No. 4,522,203, U.S. Pat. No. 4,734,324, U.S. Pat. No. 5,261,899 and U.S. Pat. No. 6,309,736.

Regardless of how the film is formed, it can be subjected to biaxial orientation by stretching in both the machine and transverse direction after formation. The machine direction stretch is initiated in forming the film simply by rolling out and taking up the film. This inherently stretches the film in the direction of takeup, orienting some of the fibers. Although this strengthens the film in the machine direction, it allows the film to tear easily in the direction at right angles because all of the fibers are oriented in one direction. The biaxially oriented film may further be subjected to additional drawing of the film in the machine direction, in a process known as tensilizing.

Biaxial stretching orients the fibers parallel to the plane of the film, but leaves the fibers randomly oriented within the plane of the film. This provides superior tensile strength, flexibility, toughness and shrinkability, for example, in comparison to non-oriented films. It is desirable to stretch the film along two axes at right angles to each other. This increases tensile strength and elastic modulus in the directions of stretch. It is most desirable for the amount of stretch in each direction to be roughly equivalent, thereby providing similar properties or behavior within the film when tested from any direction. However, in applications, such as those desiring an amount of shrinkage or greater strength in one direction over another, as in labels or adhesive and magnetic tapes, uneven, or even uniaxial, orientation may be desirable.

The biaxial orientation can be obtained by any process known. However, tentering is preferred, wherein the material is stretched while heating in the transverse direction simultaneously with, or subsequent to, stretching in the machine direction. The orientation can be performed on available commercial equipment. For example, suitable equipment is available from Bruckner Maschenenbau of West Germany. One form of such equipment operates by clamping on the edges of the sheet to be drawn and, at the appropriate temperature, separating the edges of the sheet at a controlled rate. For example, a film can be fed into a temperature-controlled box, heated above its glass transition temperature and grasped on either side by tenterhooks which simultaneously exert a drawing tension (longitudinal stretching) and a widening tension (lateral stretching). Typically, stretch ratios of 3:1 to 4:1 can be employed. Alternatively, and preferably for commercial purposes, the biaxial drawing process is conducted continuously at high production rates in multistage roll drawing equipment, as available from Bruckner, where the drawing of the extruded film stock takes place in a series of steps between heated rolls rotating at different and increasing rates. When the appropriate combinations of draw temperatures and draw rates are employed, the monoaxial stretching will be preferably from about 4 to about 20, more preferably from about 4 to about 10. Draw ratio is defined as the ratio of a dimension of a stretched film to a non-stretched film.

Uniaxial orientation can be obtained through stretching the film in only one direction in the above described biaxial processes or by directing the film through a machine direction orienter, (“MDO”), such as is commercially available from vendors such as the Marshall and Williams Company of Providence. Rhode Island. The MDO apparatus has a plurality of stretching rollers which progressively stretch and thin the film in the machine direction of the film, which is the direction of travel of the film through the apparatus.

Preferably, the stretching process takes place at a temperature of at least 10° C. above the glass transition temperature of the film material and preferably below the Vicat softening temperature of the film material, especially at least 10° C. below the Vicat softening point, the optimal temperature depending in part on the rate of stretching.

Orientation of blown film can be enhanced by adjusting the blow-up ratio. For example, it is generally preferred to have a BUR of 1 to 5 for the production of bags or wraps. However, the preferred BUR can vary, depending on the balance of properties desired in the machine direction and the transverse direction. For a balanced film, a BUR of about 3:1 is generally appropriate. If it is desired to have a “splitty” film (a film that tears relatively easily in one direction) then a BUR of 1:1 to about 1.5:1 is generally preferred.

Shrinkage can be controlled by holding the film in a stretched position and heating for a few seconds before quenching. This heat stabilizes the oriented film, which then can be forced to shrink only at temperatures above the heat stabilization temperature. Further, the film may also be subjected to rolling, calendering, coating, embossing, printing, or any other typical finishing operations known within the art.

Preferred conditions and parameters for film making by any method can be determined by a skilled artisan, depending on the polymeric composition and desired application.

The properties exhibited by a film are determined by several factors as indicated above, including the polymeric composition, the method of forming the polymer, the method of forming the film, and whether the film was treated for stretch or biaxially oriented. Such factors affect many properties of the film, such as shrinkage, tensile strength, elongation at break, impact strength, electrical properties, tensile modulus, chemical resistance, melting point, heat deflection temperature, and deadfold performance.

The film properties can be further adjusted by adding additives and fillers to the polymeric composition, such as colorants, dyes, UV and thermal stabilizers, antioxidants, plasticizers, lubricants antiblock agents, slip agents, as recited above. Alternatively, the polyester compositions can be blended with one or more other polymeric materials to improve characteristics, as described above.

As disclosed by Moss, in U.S. Pat. No. 4,698,372, Haffner, et. al., in U.S. Pat. No. 6,045,900, and McCormack, in WO 95/16562, the films, especially the filled films, can be formed microporous, if desired. Further disclosures on this subject include those of U.S. Pat. No. 4,626,252, U.S. Pat. No. 5,073,316, and U.S. Pat. No. 6,359,050. As is known to those skilled in the art, the stretching of a filled film may create fine pores, which allows the film to serve as a barrier to liquids and particulate matter, yet allow air and water vapor to pass through.

To enhance the printability (ink receptivity), adhesion or other desirable surface characteristics, the films can be treated by known, conventional post forming operations, such as corona discharge, chemical treatments, and flame treatment.

The films can be further processed to produce additional desirable articles, such as containers. For example, the films can be thermoformed as disclosed, for example, in U.S. Pat. No. 3,303,628, U.S. Pat. No. 3,674,626, and U.S. Pat. No. 5,011,735. The films can further be laminated onto substrates, as described below.

In a further embodiment, coatings of the polyesters can be formed on various substrates, and the coated substrates can be used in making finished articles. Coatings can be produced by coating a substrate with polymer solutions, dispersions, latexes, and emulsions of the polyesters by rolling, spreading, spraying, brushing, or pouring processes, followed by drying, by coextruding the polyesters with other materials, powder coating onto a preformed substrate, or by melt/extrusion coating a preformed substrate with the polyesters. The substrate can be coated on one side or on both sides. The polymeric coated substrates have a variety of uses, such as in packaging, especially static charge dissipative packaging for, for example, sensitive electronic parts, semiconductive cable jacket, EMI shielding, and in disposable products. For some uses, wherein the heat resistance of the coating is an important factor, a higher melting point, glass transition temperature, and crystallinity are desirable. Further, it is frequently desired that the coatings provide good barrier properties for moisture, grease, oxygen, and carbon dioxide, and have good tensile strength and a high elongation at break.

Coatings of the polyesters can be made using any known process. For example, thin coatings can be formed by dipcoating as disclosed in U.S. Pat. No. 4,372,311 and U.S. Pat. No. 4,503,098, extrusion onto substrates, as disclosed, for example, in U.S. Pat. No. 5,294,483, U.S. Pat. No. 5,475,080, U.S. Pat. No. 5,611,859, U.S. Pat. No. 5,795,320, U.S. Pat. No. 6,183,814, and U.S. Pat. No. 6,197,380, blade, puddle, air-knife, printing, Dahlgren, gravure, powder coating, spraying, or other art processes. The coating is preferably formed by solution, dispersion, latex, or emulsion casting, powder coating, or extrusion onto a preformed substrate. The coatings can be of any thickness. Preferably, the polymeric coating is 0.25 mm (10 mils) thick or less, more preferably from about 0.025 mm and 0.15 mm (1 mil and 6 mils). However, thicker coatings can be formed having thicknesses of about 0.50 mm (20 mils) or greater.

Solution casting of a coating onto a substrate generally produces more consistently uniform gauge coating than melt extrusion. Solution casting of a coating can be carried out using processes used for films, as disclosed hereinabove. Alternatively, a solution, emulsion, or dispersion of the polyester can be sprayed, brushed, rolled or poured onto the substrate. For example, Potts, in U.S. Pat. No. 4,372,311 and U.S. Pat. No. 4,503,098, discloses coating water-soluble substrates with solutions of water-insoluble materials. U.S. Pat. No. 3,378,424 discloses processes for coating a fibrous substrate with an aqueous polymeric emulsion.

A coating of the polyester can also be applied to substrates by powder coating processes. In a powder coating process, the polymers of the present invention are coated onto the substrates in the form of a powder with a fine particle size. The substrate to be coated is heated to above the fusion temperature of the polymer and the substrate is dipped into a bed of the powdered polymer fluidized by the passage of air through a porous plate. The fluidized bed is typically not heated. A layer of the polymer adheres to the hot substrate surface and melts to provide the coating. Coating thicknesses can be in the range of about 0.005 inch to 0.080 inch, (0.13 to 2.00 mm). Other powder coating processes include spray coating, wherein the substrate is not heated until after it is coated, and electrostatic coating. For example, paperboard containers can be electrostatically spray-coated with a thermoplastic polymer powder, as disclosed in U.S. Pat. No. 4,117,971, U.S. Pat. No. 4,168,676, U.S. Pat. No. 4,180,844, U.S. Pat. No. 4,211,339, and U.S. Pat. No. 4,283,189. The cups are then heated, causing the polymeric powder to melt to form the laminated polymeric coating.

Metal articles of complex shapes can also be coated with the polyesters using a whirl sintering process. The articles, heated to above the melting point of the polymer, are introduced into a fluidized bed of powdered polymer wherein the polymer particles are held in suspension by a rising stream of air, thus depositing a coating on the metal by sintering.

Coatings of the polyesters can also be applied by spraying the molten, atomized polymer composition onto substrates, such as paperboard. Such processes are disclosed for wax coatings in, for example, U.S. Pat. No. 5,078,313, U.S. Pat. No. 5,281,446, and U.S. Pat. No. 5,456,754.

Coatings of the polyesters are preferably applied by melt or extrusion coating processes. Extrusion is particularly preferred for formation of “endless” products, such as coated paper and paperboard, which emerge as a continuous length. In extrusion, the polymeric material, whether provided as a molten polymer or as plastic pellets or granules, is fluidized and homogenized. Additives, as described above, such as thermal or UV stabilizers, plasticizers, fillers and/or blendable polymeric materials, can be added during this extrusion process. This mixture is then forced through a suitably shaped die to produce the desired cross-sectional film shape. The extruding force can be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders can be used as known. Different kinds of die are used to produce different products. Typically slot dies, such as T-shaped or “coat hanger” dies, are used for extrusion coatings. In this manner, films of different widths and thickness can be produced and can be extruded directly onto the object to be coated. The thin molten nascent film exiting the die is pulled down onto the substrate and into a nip between a chill roll and a pressure roll situated directly below the die. Typically the nip rolls are a pair of cooperating, axially parallel rolls, one being a pressure roll having a rubber surface and the other being a water-cooled, chromium-plated chill roll. Typically the uncoated side of the substrate contacts the pressure roll while the polymer-coated side of the substrate contacts the chill roll. The pressure between the two rolls forces the film onto the substrate. At the same time, the substrate is moving at a speed faster than the extruded film and is drawing the film down to the required thickness. In extrusion coating, the substrate (e.g., paper, foil, fabric, polymeric film) is compressed together with the extruded polymeric melt by the pressure rolls so that the polymer impregnates the substrate for maximum adhesion. The molten polymer is then cooled by the chill rolls. The coated substrate can be passed through a slitter to trim the edges and taken off by suitable devices designed to prevent any subsequent deformation of the coated substrate. As a further example of extrusion coating, wires and cable can be sheathed directly with polymeric films extruded from oblique heads.

Extrusion coating of polyesters onto paperboard is disclosed, for example, in U.S. Pat. No. 3,924,013, U.S. Pat. No. 4,147,836, U.S. Pat. No. 4,391,833, U.S. Pat. No. 4,595,611, U.S. Pat. No. 4,957,578, and U.S. Pat. No. 5,942,295. Kane, in U.S. Pat. No. 3,924,013, discloses the formation of ovenable trays mechanically formed from paperboard previously laminated polyester. Chaffey et. al., in U.S. Pat. No. 4,836,400, disclose the production of cups formed from paper stock which has been coated with a polymer on both sides. Beavers, et. al., in U.S. Pat. No. 5,294,483, disclose the extrusion coating of polyesters onto paper substrates.

Calendering processes can also be used to produce polymeric laminates onto substrates. Calenders generally consist of two, three, four, or five hollow rolls arranged for steam heating or water cooling. Typically, the polymer to be calendered is softened, for example in ribbon blenders, such as a Banbury mixer. Other components can be mixed in, such as plasticizers. The softened polymeric composition is then fed to the roller arrangement and is squeezed into the form of films. If desired, thicker sections can be formed by applying one layer of polymer onto a previous layer (double plying). The substrate, such as textile or nonwoven fabric or paper, is fed through the last two rolls of the calender so that the polymer is pressed into the substrate. The thickness of the laminate is determined by the gap between the last two rolls of the calender. The surface can be made glossy, matt, or embossed. The laminate is then cooled and wound up on rolls.

Multiple polymer layers, such as bilayer, trilayer, and other multilayer structures, can be coated onto a substrate. Processes and properties of multiple layer coatings are disclosed hereinabove with respect to multilayer films.

In addition to a layer comprising the polyesters, additional layers can be made of the polyesters or of materials described above as blend materials.

Generally, the coating is applied to a thickness of from about 0.2 to 15 mils, more generally in the range of between 0.5 to 2 mils. The substrates may vary widely in thickness, but the range of between 0.5 to more than 24 mils thickness is common. Suitable substrates for coating with the polyesters include articles made of paper, paperboard, cardboard, fiberboard, cellulose, such as Cellophane®, starch, plastic, polystyrene foam, glass, metal such aluminum or tin in the form of cans, metal foils, polymeric foams, organic foams, inorganic foams, organic-inorganic foams, and polymeric films. Essentially any substrate known can be used.

To enhance the coating process, the substrates can be treated by known, conventional post forming operations, such as corona discharge, and chemical treatments, such as primers, flame treatments, and adhesives. The substrate can be primed with, for example, an aqueous solution of polyethyleneimine, (Adcote® 313), or a styrene-acrylic latex, or can be flame treated, as disclosed in U.S. Pat. No. 4,957,578 and U.S. Pat. No. 5,868,309.

Coating of the substrate with an adhesive can be done using conventional coating processes such as melt processes, solution, emulsion, or dispersion coating processes, or extrusion. Specific examples of adhesives that can be used include: glue, gelatin, caesin, starch, cellulose esters, aliphatic polyesters, poly(alkanoates), aliphatic-aromatic polyesters, sulfonated aliphatic-aromatic polyesters, polyamide esters, rosin/polycaprolactone triblock copolymers, rosin/poly(ethylene adipate) triblock copolymers, rosin/poly(ethylene succinate) triblock copolymers, poly(vinyl acetates), poly(ethylene-co-vinyl acetate), poly(ethylene-co-ethyl acrylate), poly(ethylene-co-methyl acrylate), poly(ethylene-co-propylene), poly(ethylene-co-I-butene), poly(ethylene-co-1-pentene), poly(styrene), acrylics, Rhoplex® N-1031, (an acrylic latex from the Rohm & Haas Company), polyurethanes, AS 390, (an aqueous polyurethane adhesive base for Adhesion Systems, Inc.) with AS 316, (an adhesion catalyst from Adhesion Systems, Inc.), Airflex® 421, (a water-based vinyl acetate adhesive formulated with a crosslinking agent), sulfonated polyester urethane dispersions, (such as sold as Dispercoll® U-54, Dispercoll® U-53, and Dispercoll® KA-8756 by the Bayer Corporation), nonsulfonated urethane dispersions, (such as Aquathane® 97949 and Aquathane® 97959 by the Reichold Company; Flexthane® 620 and Flexthane® 630 by the Air Products Company; Luphen® D DS 3418 and Luphen® D 200A by the BASF Corporation; Neorez® 9617 and Neorez® 9437 by the Zeneca Resins Company; Quilastic® DEP 170 and Quilastic® 172 by the Merquinsa Company; Sancure®D 1601 and Sancure® 815 by the B.F. Goodrich Company), urethane-styrene polymer dispersions, (such as Flexthane® 790 and Flexthane® 791 of the Air Products & Chemicals Company), Non-ionic polyester urethane dispersions, (such as Neorez® 9249 of the Zeneca Resins Company), acrylic dispersions, (such as Jagotex® KEA-5050 and Jagotex® KEA 5040 by the Jager Company; Hycar® 26084, Hycar® 26091, Hycar® 26315, Hycar® 26447, Hycar® 26450, and Hycar® 26373 by the B.F. Goodrich Company; Rhoplex® AC-264, Rhoplex® HA-16, Rhoplex® B-60A, Rhoplex® AC-234, Rhoplex) E-358, and Rhoplex® N-619 by the Rohm & Haas Company), silanated anionic acrylate-styrene polymer dispersions, (such as Acronal® S-710 by the BASF Corporation and Texigel® 13-057 by Scott Bader Inc.), anionic acrylate-styrene dispersions, (such as Acronal® 296D, Acrona® NX 4786, Acronal® S-305D, Acronal® S-400, Acronal® S-610, Acronal® S-702, Acronal® S-714, Acronal® S-728, and Acronal® S-760 by the BASF Corporation; Carboset® CR-760 by the B.F. Goodrich Company; Rhoplex® P-376, Rhoplex® P-308, and Rhoplex® NW-1715K by the Rohm & Haas Company; Synthemul® 40402 and Synthemul® 40403 by the Reichold Chemicals Company; Texigel® 13-57 Texigel® 13-034, and Texigel® 13-031 by Scott Bader Inc.; and Vancryl® 954, Vancrylo 937 and Vancryl® 989 by the Air Products & Chemicals Company), anionic acrylate-styrene-acrylonitrile dispersions, (such as Acronal® S 886S, Acronal® S 504, and Acronal® DS 2285 X by the BASF Corporation), acrylate-acrylonitrile dispersions, (such as Acronal® 35D, Acronal® 81D, Acronal® B 37D, Acronal® DS 3390, and Acronal® V275 by the BASF Corporation), vinyl chloride-ethylene emulsions, (such as Vancryl® 600, Vancryl® 605, Vancryl® 610, and Vancryl® 635 by Air Products and Chemicals Inc.), vinylpyrrolidone/styrene copolymer emulsions, (such as Polectron® 430 by ISP Chemicals), carboxylated and noncarboxylated vinyl acetate ethylene dispersions, (such as Airflex® 420, Airflex® 421, Airflex® 426, Airflex® 7200, and Airflex® A-7216 by Air Products and Chemicals Inc. and Dur-o-set® E150 and Dur-o-set® E-230 by ICI), vinyl acetate homopolymer dispersions, (such as Resyn® 68-5799 and Resyn® 25-2828 by ICI), polyvinyl chloride emulsions, (such as Vycar® 460×24, Vycar® 460×6 and Vycar® 460×58 by the B.F. Goodrich Company), polyvinylidene fluoride dispersions, (such as Kynar® 32 by Elf Atochem), ethylene acrylic acid dispersions, (such as Adcote® 50T4990 and Adcote® 50T4983 by Morton International), polyamide dispersions, (such as Micromid® 121RC, Micromid® 141L, Micromid® 142LTL, Micromid® 143LTL, Micromid® 144LTL, Micromid® 321RC, and Micromid® 632HPL by the Union Camp Corporation), anionic carboxylated or noncarboxylated acrylonitrile-butadiene-styrene emulsions and acrylonitrile emulsions, (such as Hycar® 1552, Hycar® 1562×107, Hycar® 1562×117 and Hycar® 1572×64 by B.F. Goodrich), resin dispersions derived from styrene, (such as Tacolyn® 5001 and Piccotex® LC-55WK by Hercules), resin dispersions derived from aliphatic and/or aromatic hydrocarbons, (such as Escorez® 9191, Escorez® 9241, and Escorez® 9271 by Exxon), styrene-maleic anhydrides, (such as SMAO 1440 H and SMA® 1000 by AtoChem), and mixtures thereof.

Coated substrates are known and are disclosed, for example, in U.S. Pat. No. 4,343,858, which discloses a coated paperboard formed by the coextrusion of a polyester top film and an intermediate layer of an ester of acrylic acid, methacrylic acid, or ethacrylic acid, on top of a paperboard. U.S. Pat. No. 4,455,184, disclose a process to coextrude a polyester layer and a polymeric adhesive layer onto a paperboard substrate in U.S. Pat. No. 4,543,280, disclose the use of adhesives in the extrusion coating of polyester onto ovenable paperboard. U.S. Pat. No. 4,957,578, disclose the extrusion of a polyester layer on top of a polyethylene coated paperboard, and the direct formation of the structure through coextrusion of the polyethylene layer on top of the paperboard with the polyester on top of the polyethylene with a coextruded adhesive tie layer of Bynel® between the polyethylene layer and the polyester layer.

One of ordinary skill in the art will be able to identify appropriate process parameters based on the polymeric composition and process used for the coating formation, and the desired application.

The properties exhibited by a coating are determined by several factors, including the polymeric composition, the method of forming the polymer, the method of forming the coating, and whether the coating was oriented during manufacture. Such factors affect properties of the coating such as shrinkage, tensile strength, elongation at break, impact strength, electrical properties, tensile modulus, chemical resistance, melting point, and heat deflection temperature.

The coating properties can be further adjusted by adding additives and fillers to the polymeric composition, such as colorants, dyes, UV and thermal stabilizers, antioxidants, plasticizers, lubricants antiblock agents, slip agents, as recited above. Alternatively, the polyesters can be blended with one or more other polymeric materials to improve characteristics, as described above.

The substrates can be formed into articles prior to coating or after they are coated. For example, containers can be produced from flat, coated paperboard by pressforming them, by vacuum forming, or by folding and adhering them into the desired shape. Coated, flat paperboard stock can be formed into trays by the application of heat and pressure, as disclosed in, for example, U.S. Pat. No. 4,900,594. They can be vacuum formed into containers as disclosed in U.S. Pat. No. 5,294,483. Articles into which the substrates can be formed include, for example, mailing tubes, light fixtures, containers, cartons, boxes, cups, two-piece cups, one-piece pleated cups, cone cups, lids, cup tops, packaging, support boxes, plates, bowls, vending plates, trays, baking trays, microwavable dinner trays, disposable single use liners for use with containers such as cups, substantially spherical objects, bottles, jars, crates, dishes, interior packaging, such as partitions, liners, anchor pads, corner braces, corner protectors, clearance pads, hinged sheets, trays, funnels, cushioning materials, and other objects used in packaging, storing, shipping, portioning, serving, or dispensing an object within a container.

In a further embodiment, laminates are formed of the polyesters on substrates. Films comprising the polyesters, prepared as described above, can be laminated onto a wide variety of substrates using known processes, such as thermoforming, vacuum thermoforming, vacuum lamination, pressure lamination, mechanical lamination, skin packaging, and adhesion lamination. A laminate is differentiated from a coating in that in lamination, a preformed film is attached to a substrate. The substrate can be shaped into the end-use shape, such as in the form of a plate, cup, bowl, or tray, or can be in an intermediate shape still to be formed, such as a sheet or film, when a laminate is applied. The film can be attached to the substrate through the applications of heat and/or pressure, as with, for example heated bonding rolls. Generally speaking, the laminate bond strength or peel strength can be enhanced through the use of higher temperatures and/or pressures. When adhesives are used, the adhesives can be hot melt adhesives or solvent based adhesives. To enhance the lamination process, the films and/or the substrates can be treated by known, conventional post forming operations, such as corona discharge, chemical treatments, such as primers, flame treatments, as previously described. For example, U.S. Pat. No. 4,147,836 discloses subjecting a paperboard to a corona discharge to enhance the lamination process with a poly(ethylene terephthalate) film. Quick, et. al., in U.S. Pat. No. 4,900,594, disclose the corona treatment of a polyester film to aid in the lamination to paperstock with adhesives. Schirmer, in U.S. Pat. No. 5,011,735, discloses the use of corona treatments to aid the adhesion between blown films. U.S. Pat. No. 5,679,201 and U.S. Pat. No. 6,071,577, disclose the use of flame treatments to aid in the adhesion within polymeric lamination processes. Sandstrom, et. al., in U.S. Pat. No. 5,868,309, disclose the use of paperboard substrate primer consisting of styrene-acrylic materials to improve the adhesion with polymeric laminates.

Processes for producing polymeric coated or laminated paper and paperboard substrates for use as containers and cartons are known and are disclosed, for example, in U.S. Pat. No. 3,863,832, U.S. Pat. No. 3,866,816, U.S. Pat. No. 4,337,116, U.S. Pat. No. 4,456,164, U.S. Pat. No. 4,698,246, U.S. Pat. No. 4,701,360, U.S. Pat. No. 4,789,575, U.S. Pat. No. 4,806,399, U.S. Pat. No. 4,888,222, and U.S. Pat. No. 5,002,833. Kane, in U.S. Pat. No. 3,924,013, discloses the formation of ovenable trays mechanically formed from paperboard previously laminated with polyester. U.S. Pat. No. 4,130,234, discloses the polymeric film lamination of paper cups. The lamination of films onto nonwoven fabrics is disclosed in U.S. Pat. No. 6,045,900 and U.S. Pat. No. 6,309,736. Depending on the intended use of the polyester laminated substrate, the substrate can be laminated on one side or on both sides.

The films can be passed through heating and pressure/nip rolls to be laminated onto flat substrates. More commonly, the films are laminated onto substrates utilizing processes derived from thermoforming. In such processes, films can be laminated onto substrates by, for example, vacuum lamination, pressure lamination, blow lamination, or mechanical lamination. When the films are heated, they soften and can be stretched onto a substrate of any given shape. Processes to adhere a polymeric film to a preformed substrate are known, for example, as disclosed in U.S. Pat. No. 2,590,221.

In vacuum lamination, the film can be clamped or simply held against the substrate and then heated until it becomes soft. A vacuum is then applied, typically through porous substrates or designed-in holes, causing the softened film to mold into the contours of the substrate and laminate onto the substrates. The as formed laminate is then cooled. The vacuum can be maintained or not during the cooling process. For substrate shapes that require a deep draw, such as cups, deep bowls, boxes, and cartons, a plug assist can be used. In such substrate shapes, the softened film tends to thin out significantly before it reaches the bottom of the substrate, leaving only a thin and weak laminate on the bottom of the substrate. The plug assist is any type of mechanical helper that carries more film stock toward an area of the substrate shape where the lamination would otherwise be too thin. Plug assist techniques can be adapted to vacuum and pressure lamination processes.

Vacuum lamination processes for applying films to substrates are known and are disclose, for example, in U.S. Pat. No. 4,611,456 and U.S. Pat. No. 4,862,671. U.S. Pat. No. 3,932,105, discloses processes for the vacuum lamination of a film onto a folded paperboard carton. U.S. Pat. No. 3,957,558, discloses the vacuum lamination of thermoplastic films onto a molded pulp product, such as a plate. U.S. Pat. No. 4,337,116, discloses the lamination of poly(ethylene terephthalate) films onto preformed molded pulp containers by preheating the pulp container and the film, pressing the film into contact with the substrate and applying vacuum through the molded pulp container substrate. Plug assisted, vacuum lamination processes are disclosed, for example, by Wommelsdorf, et. al., in U.S. Pat. No. 4,124,434, for deep drawn laminates, such as coated cups. Faller, in U.S. Pat. No. 4,200,481 and U.S. Pat. No. 4,257,530, discloses the production processes of lined trays by such processes.

Pressure lamination can be contrasted with vacuum lamination in that pressure lamination uses positive pressure. The film can be clamped, heated until it softens, and then forced into the contours of the substrate to be laminated by the application of air pressure to the side of the film opposite to the substrate. Exhaust holes can be present to allow the trapped air to escape, or in the more common situation, the substrate is porous to air and the air simply escapes through the substrate. The air pressure can be released once the laminated substrate cools and the film solidifies. Pressure lamination tends to allow a faster production cycle, improved part definition and greater dimensional control over vacuum lamination. Pressure lamination of films onto preformed substrates is disclosed, for example, in U.S. Pat. No. 3,657,044 and U.S. Pat. No. 4,862,671. Wommelsdorf, in U.S. Pat. No. 4,092,201, discloses a process for lining an air-permeable container, such as a paper cup, with a thermoplastic foil using a warm pressurized stream of gas.

Mechanical lamination includes any lamination method that does not use vacuum or air pressure. The film is heated and then mechanically applied to the substrate. Examples include molds or pressure rolls.

Suitable substrates for lamination with the polyesters include articles made of paper, paperboard, cardboard, fiberboard, cellulose, such as Cellophane® cellulose, starch, plastic, polystyrene foam, glass, metal, for example; aluminum or tin cans, metal foils, polymeric foams, organic foams, inorganic foams, organic-inorganic foams, and polymeric films.

The substrates can be formed into the desired shape prior to lamination. Any conventional process to form the substrates can be used. For example, for molded pulp substrates, a “precision molding”, “die-drying”, and “close-drying” process can be used. The processes include molding fibrous pulp from an aqueous slurry against a screen-covered open-face suction mold to the substantially finished contoured shape, followed by drying the damp pre-form under a strong pressure applied by a mated pair of heated dies. Such processes are disclosed, for example, in U.S. Pat. No. 2,183,869, U.S. Pat. No. 4,337,116, and U.S. Pat. No. 4,456,164. Precision molded pulp articles can be dense, hard and boardy, with an extremely smooth, hot-ironed surface finish. Disposable paper plates produced by such processes have been sold under the “Chinet” tradename by the Huhtamaki Company.

Molded pulp substrates can also be produced using known “free-dried” or “open-dried” processes. The free-dried process includes molding fibrous pulp from an aqueous slurry against a screen-covered, open-face suction mold to essentially the molded shape and then drying the damp pre-from in a free space, such as placing it on a conveyor, and moving it slowly through a heated drying oven. The molded pulp articles tend to be characterized by a non-compacted consistency, resilient softness, and an irregular fibrous feel and appearance. Molded pulp substrates may also be produced by being “after pressed” after forming through a free-dried process, for example, as disclosed in U.S. Pat. No. 2,704,493. They may also be produced by other conventional art process, such as disclosed, for example, in U.S. Pat. No. 3,185,370.

The laminated substrates can be converted to a desired shape using well known processes, such a press forming or folding. Such processes are disclosed, for example in U.S. Pat. No. 3,924,013, 4,026,458, and U.S. Pat. No. 4,456,164. For example, Quick, et al., in U.S. Pat. No. 4,900,594, disclose the production of trays from flat, polyester laminated paperstock through the use of pressure and heat.

As suggested above, adhesives can be applied to the film, to the substrate or to the film and the substrate to enhance the bond strength of the laminate. Adhesive lamination of films onto preformed substrates is known within the art, for example, as disclosed in U.S. Pat. No. 2,434,106, U.S. Pat. No. 2,510,908, U.S. Pat. No. 2,628,180, U.S. Pat. No. 2,917,217, U.S. Pat. No. 2,975,093, U.S. Pat. No. 3,112,235, U.S. Pat. No. 3,135,648, U.S. Pat. No. 3,616,197, U.S. Pat. No. 3,697,369, U.S. Pat. No. 4,257,530, U.S. Pat. No. 4,016,327, U.S. Pat. No. 4,352,925, U.S. Pat. No. 5,037,700, U.S. Pat. No. 5,132,391, and U.S. Pat. No. 5,942,295. Schmidt, in U.S. Pat. No. 4,130,234, discloses the use of hot melt adhesives in the lamination of polymeric films to paper cups. Dropsy, in U.S. Pat. No. 4,722,474, discloses the use of adhesives for plastic laminated cardboard packaging articles. Quick, et al., in U.S. Pat. No. 4,900,594, disclose the formation of paperboard trays by pressure and heat forming of a flat polyester laminated paperboard stock adhered with a crosslinkable adhesives system. Martini, et. al., in U.S. Pat. No. 5,110,390, disclose the lamination of coextruded bilayer films onto watersoluble substrates using adhesives. Gardiner, in U.S. Pat. No. 5,679,201 and U.S. Pat. No. 6,071,577, discloses the use of adhesives to provide improved bond strengths between polyester coated paperboard onto polyethylene coated paperboard to produce, for example, juice containers.

The film can be coated with an adhesive using conventional coating technologies or coextrusion, or the substrate can be coated with adhesives, or both the film and the substrate can be coated with adhesives. Specific examples of adhesives which can be used are provided above.

The polyester compositions can be formed into sheets. The difference between a film and a sheet is the thickness, but there is no set industry standard as to when a film becomes a sheet. As used herein, a sheet is greater than about 0.25 mm (10 mils) thick, preferably from about 0.25 mm and 25 mm, more preferably from about 2 mm to about 15 mm, and even more preferably from about 3 mm to about 10 mm. In a preferred embodiment, the sheets of the present invention have a thickness sufficient to cause the sheet to be rigid, which generally occurs at about 0.50 mm and greater, However, sheets greater than 25 mm, and thinner than 0.25 mm can be formed. Also, as used herein, a film is 0.25 mm (10 mils) thick or less, preferably from about 0.025 mm to 0.15 mm (1 mil and 6 mils). However, thicker films can be formed up to a thickness of about 0.50 mm (20 mils). Polymeric sheets have a variety of uses, such as in signage, glazings, thermoforming articles, displays and display substrates, for example. For many of these uses, the heat resistance of the sheet is an important factor. Therefore, a higher melting point and glass transition temperature are desirable to provide better heat resistance and greater stability. Further, it is desired that these sheets have ultraviolet (UV) and scratch resistance, good tensile strength, and good impact strength, particularly at low temperatures.

A significant advantage of the polyester compositions containing carbon black is that they are electrostatically paintable while maintaining the majority of their desirable physical properties, due to the carbon black incorporated therein. Relatively large sheets can be consistently painted without color differences over the surface of the part. It is believed that the carbon black allows the dissipation of electrical charges formed on the polyester as it is being electrostatically painted, providing an even coating of paint over the entire sheet. For the polyester compositions produced by the processes containing low amounts of carbon black, sheets produced therefrom can be used for laser marking for identification purposes.

Various polymeric compositions have been used in an attempt to meet all of the above criteria. In particular, poly(ethylene terephthalate) (PET) has been used to form low-cost sheets for many years. However, PET sheets have poor low temperature impact strength, a low glass transition temperature (Tg) and a high rate of crystallization. Thus, PET sheets are not desirable for use at extreme low temperatures because of the danger of breakage or at extreme high temperatures because the polymer crystallizes, thereby diminishing optical clarity. Polycarbonate sheets can be used in applications where a low temperature impact strength is needed, or a high service temperature is required. While polycarbonate sheets have high impact strengths at low temperatures as well as a high Tg which allows them to be used in high temperature applications, polycarbonate has poor solvent resistance, thereby limiting its use in applications, and it is prone to stress induced cracking. Polycarbonate sheets also provide an impact strength than can be excessive for applications, making them costly and inefficient for use.

The polyesters can be formed into sheets directly from the polymerization melt. In the alternative, the polyester can be formed into an easily handled shape (such as pellets) from the melt, which can then be used to form a sheet. The sheets can be used for forming signs, glazings (such as in bus stop shelters, sky lights or recreational vehicles), displays, automobile lights and in thermoforming articles, for example.

Sheets can be formed by any process known, such as extrusion, solution casting or injection molding. The parameters for each of these processes can be easily determined by one of ordinary skill in the art depending upon viscosity characteristics of the polyester and the desired thickness of the sheet.

Sheets are preferably formed from the polyesters by solution casting or extrusion. Extrusion is particularly preferred for formation of “endless” products, such as films and sheets, which emerge as a continuous length. For example, PCT applications WO 96/38282 and WO 97/00284 disclose the formation of crystallizable sheets by melt extrusion.

In extrusion, the polymeric material, whether provided as a molten polymer or as plastic pellets or granules, is fluidized and homogenized. This mixture is then forced through a suitably shaped die to produce the desired cross-sectional sheet shape. The extruding force can be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders can be used as known. Different kinds of die are used to produce different products, such as sheets and strips (slot dies) and hollow and solid sections (circular dies). In this manner, sheets of different widths and thickness can be produced. A sheet can be produced by extruding a thin layer of polymer over chilled rolls and then further drawing down the sheet to size (>0.25 mm) by tension rolls. After extrusion, the polymeric sheet is taken up on rollers, cooled and taken off by suitable devices designed to prevent any subsequent deformation of the sheet.

For manufacturing large quantities of sheets, a sheeting calender is employed. The methods of using a sheeting calendar for making film, as described hereinabove, can also be used to make sheets. Extrusion can be combined with a variety of post-extruding operations for expanded versatility. Such post-forming operations include altering round to oval shapes, stretching the sheet to different dimensions, machining and punching, and biaxial stretching, as known to those skilled in the art.

The polyester sheet can be combined with other polymeric materials during extrusion and/or finishing to form laminates or multilayer sheets with improved characteristics, such as water vapor resistance. In particular, the polyester sheet can be combined with one or more of the following: poly(ethylene terephthalate) (PET), aramid, polyethylene sulfide (PES), polyphenylene sulfide (PPS), polyimide (PI), polyethylene imine (PEI), poly(ethylene naphthalate) (PEN), polysulfone (PS), polyether ether ketone (PEEK), olefins, polyethylene, poly(cyclic olefins), cellulose, and cyclohexylene dimethylene terephthalate, for example. Other polymers, as described above as blending polymeric materials, can also be used with the polyesters in making sheets. A multilayer or laminate sheet can be made by any method known, and can have as many as five or more separate layers joined together by heat, adhesive and/or a tie layer, as known.

A sheet may also be made by solution casting, as in forming films, which produces more consistently uniform gauge sheet than that made by melt extrusion. Further, sheets and sheet-like articles, such as discs, can be formed by injection molding using known methods. One of ordinary skill in the art can determine appropriate process parameters based on the polymeric composition and process used for sheet formation.

Regardless of how the sheet is formed, it can be subjected to orientation, particularly biaxial orientation, using processes described hereinabove for orienting films.

The properties of a sheet are determined by various factors, including the polymeric composition, the method of forming the polymer, the method of forming the sheet, and whether the sheet was treated for stretch or biaxially oriented. Properties affected by such factors include shrinkage, tensile strength, elongation at break, impact strength, dielectric strength and constant, tensile modulus, chemical resistance, melting point, and heat deflection temperature.

The sheet properties can be further adjusted by adding additives and fillers to the polymeric composition, such as colorants, dyes, UV and thermal stabilizers, antioxidants, plasticizers, lubricants antiblock agents, slip agents, as recited above. Alternatively, the polyesters can be blended with one or more other polymers, such as starch, to improve characteristics, as recited above. Other polymers can be added to change such characteristics as air permeability, optical clarity, strength and/or elasticity, for example.

The sheets can be thermoformed by any known method into any desirable shape, such as covers, skylights, shaped greenhouse glazings, displays, and food trays. The thermoforming is accomplished by heating the sheet to a sufficient temperature and for sufficient time to soften the polyester so that the sheet can be easily molded into the desired shape. One skilled in the art can determine the optimal thermoforming parameters depending upon the viscosity and crystallization characteristics of the polyester sheet.

The polyesters can be used in making plastic containers. Plastic containers are widely used for foods and beverages, and also for non-food materials. Poly(ethylene terephthalate) (PET) is used to make many of these containers because of its appearance (optical clarity), ease of blow molding, chemical and thermal stability, and its price. PET is generally fabricated into bottles by blow molding processes, and generally by stretch blow molding.

Containers produced from the polyesters containing carbon black can be laser marked for identification purposes. In addition, relatively small amounts of incorporated carbon black, in the 5-25 ppm range, can function as reheat catalysts in the stretch blow molding processes as the preform is heated to form a container such as a bottle. Containers can be made from the polyesters by any method known, such as extrusion, injection molding, injection blow molding, rotational molding, thermoforming of a sheet, and stretch-blow molding. Preferably, containers are made from the polyesters by stretch-blow molding, which generally used in the production of poly(ethylene terephthalate) (PET) containers, such as bottles. In this case, use can be made of any of the cold parison methods, in which a preformed parison (generally made by injection molding) is taken out of the mold and then subjected to stretch blow molding in a separate step. The hot parison method as known may also be used, wherein the hot parison is immediately subjected to stretch blow molding in the same equipment without complete cooling after injection molding to make the parison. The parison temperature will vary based on the composition of the polymer to be used. Generally, parison temperatures in the range from about 90 to about 160° C. are found useful. The stretch blow molding temperature will also vary dependent on the material composition used, but a mold temperature of about 80° C. to about 150° C. is generally found to be useful. Reviews are widely available, as for example, “Blow Molding” by C. Irwin in Encyclopedia of Polymer Science and Engineering, Second Edition, Vol. 2, John Wiley and Sons, New York, 1985, pp. 447-478.

Containers made from the polyesters can have any shape desirable, and particularly include narrow-mouth bottles and wide-mouth bottles having threaded tops and a volume of about 400 mL to about 3 liters, although smaller and larger containers can be formed. The containers can be used in standard cold fill applications. Some of the compositions can be used in hot fill applications.

The containers are suitable for foods and beverages, and other solids and liquids. The containers can be modified to have color, if desired, by adding colorants or dyes, or by causing crystallization of the polymer, which results in opaqueness.

The polyesters can be formed into fibers. The term “fibers” as used herein includes continuous monofilaments, non-twisted or entangled multifilament yarns, staple yarns, spun yarns, melt blown fibers, non-woven materials, and melt blown non-woven materials. Such fibers can be used to form uneven fabrics, knitted fabrics, fabric webs, or any other fiber-containing structures, such as tire cords. Synthetic fibers, such as nylon, acrylic, polyesters, and others, are made by spinning and drawing the polymer into a filament, which is then formed into a yarn by winding many filaments together. Fibers are often treated mechanically and/or chemically to impart desirable characteristics such as strength, elasticity, heat resistance, hand (feel of fabric), as known based on the desired end product to be fashioned from fibers. Polyester fibers are produced in large quantities for use in a variety of applications. In particular, polyester fibers are desirable for use in textiles, particularly in combination with natural fibers such as cotton and wool. Clothing, rugs, and other items can be fashioned from these fibers. Further, polyester fibers are desirable for use in industrial applications due to their elasticity and strength. In particular, they are used to make articles such as tire cords and ropes.

The polyester compositions containing carbon black provide fibers having a wide range of electrical conductivity, including antistatic, static dissipating or moderately conductive, and conductive. For example, the fibers can be antistatic and antisoiling. The fibers can be in a variety of forms, including homogeneous and bicomponent. For example, the polyester compositions can serve as a conductive core covered by a dielectric sheath material. A significant advantage of the polyesters is that they maintain the majority of their physical properties, while also exhibiting antistatic properties, due to the relatively small amount of carbon black needed for the desired electrical properties. Antistatic fibers produced from the polyester compositions are capable of providing antistatic protection in all types of textile end uses, including, for example, knitted, tufted, woven, and nonwoven textiles. Antistatic monofilaments can be used, for example, in hairbrushes. Antistatic monofilaments may be desirable in low humidity environments and can be woven into fabrics and used as belting materials for, for example, paper production clothing, poultry belts, and package conveyance belts.

Fibers made from the polyesters can be used in making carpets, and the presence of carbon black can provide antistatic properties to the carpets. As is well known, static electricity is generated and transferred as one walks across a conventional carpet made from hydrophobic fiber materials, such as nylon fibers, acrylic fibers, polypropylene fibers, and polyester fibers. When the person walking across the carpet becomes grounded, such as through touching a door knob or a metal cabinet, an electrical shock exceeding 3500 volts occurs. This shock is quite annoying and may provide significant discomfort to the person. The addition of the fiber produced from the polyester compositions which include carbon black will provide antistatic protection to such carpet structures. The accumulation of static electricity in textiles is not only an annoyance, as in items of apparel clinging to the body and being attracted to other garments, especially in hospital gowns and garments, fine particles of lint and dust being attracted to and gathering on upholstery fabrics, and increasing the frequency of required cleaning, but can also constitute a real danger, such as the discharge of static electricity resulting in sparks capable of igniting flammable mixtures commonly found in hospitals. The reduction of such dangers is desirable, and can be aided by the use of antistatic fibers in making textiles.

For making fibers, the polyester composition is desirably chosen to result in a partially crystalline polymer. The crystallinity is desirable for the formation of fibers, providing strength and elasticity. As first produced, the polyester is mostly amorphous in structure. In preferred embodiments, the polyester polymer readily crystallizes on reheating and/or extension of the polymer.

Fibers can be made from the polyesters by any process known. Generally, however, melt spinning is preferred. Melt spinning, which is most commonly used for polyesters such as poly(ethylene terephthalate), comprises heating the polymer to form a molten liquid, or melting the polymer against a heated surface. The molten polymer is forced through a spinneret with a plurality of fine holes. Upon contact with air or a non-reactive gas stream after passing through the spinneret, the polymer solution from each spinneret solidifies into filaments. The filaments are gathered together downstream from the spinneret by a convergence guide, and can be taken up by a roller or a plurality of rollers. This process allows filaments of various sizes and cross sections to be formed, including filaments having a round, elliptical, square, rectangular, lobed or dog-boned cross section, for example.

Following the extrusion and uptake of the fiber, the fiber is usually drawn, thereby increasing the crystallization and maximizing desirable properties such as orientation along the longitudinal axis, which increases elasticity, and strength. The drawing can be done in combination with takeup by using a series of rollers, some of which are generally heated, as known, or can be done as a separate stage in the process of fiber formation.

The polymer can be spun at speeds of from about 600 to 6000 meters per minute or higher, depending on the desired fiber size. For textile applications, a fiber with a denier per filament of from about 0.1 to about 100 is desired. Preferably, the denier is about 0.5 to 20, more preferably 0.7 to 10. However, for industrial applications the fiber is preferably from about 0.5 to 100 denier per filament, more preferably about 1.0 to 10.0, most preferably 3.0 to 5.0 denier per filament. The required size and strength of a fiber can be determined by one skilled in the art for any given application.

The resulting filamentary material can be further processed, or it can be used directly in applications requiring a continuous filament textile yarn. The filamentary material can be converted from a flat yarn to a textured yarn by known false twist texturing conditions or other processes. In particular, it is desirable to increase the surface area of the fiber to provide a softer feel and to enhance the ability of the fibers to breathe, thereby providing better insulation and water retention. The fibers can be crimped or twisted by the false twist method, air jet, edge crimp, gear crimp, or stuffer box, for example. Alternatively, the fibers can be cut into shorter lengths, called staple, which can be processed into yarn. A skilled artisan can determine the best method of crimping or twisting based on the desired application and the composition of the fiber.

After formation, the fibers are finished by any method appropriate to the desired use. For textiles, finishing can include dyeing, sizing, or addition of chemical agents such as antistatic agents, flame retardants, UV light stabilizers, antioxidants, pigments, dyes, stain resistants, or antimicrobial agents, which are appropriate to adjust the look and hand of the fibers. For industrial applications, the fibers can be treated to impart additional desired characteristics such as strength, elasticity or shrinkage, for example. A continuous filament fiber can be used either as produced or texturized for use in applications such as textile fabrics for apparel and home furnishings, for example. High tenacity fiber can be used in industrial applications such as high strength fabrics, tarpaulins, sail cloth, sewing threads and rubber reinforcement for tires and V-belts, for example.

Staple fiber can be blended with natural fibers, especially cotton and wool. The polyester has chemical resistance and is generally resistant to mold, mildew, and other problems inherent to natural fibers. The polyester fiber further provides strength and abrasion resistance and can provide lower cost in comparison to other fibers. Therefore, it is ideal for use in textiles and other commercial applications, such as for use in fabrics for apparel, home furnishings and carpets.

The polyester fiber can be used with another synthetic or natural polymer to form heterogeneous fiber, thereby providing a fiber with improved properties. The heterogeneous fiber can be formed in any suitable manner, such as side-by-side, sheath-core, and matrix designs, as is known within the art. For some end uses, such as monofilaments, the polyesters can be stabilized with an effective amount of hydrolysis stabilization additive. While it is not intended that any of the polyester compositions of the present invention be limited by any particular theory or mechanism it is believed that the hydrolysis stabilization additive acts by reducing the carboxyl concentration of the polyester. The amount of hydrolysis stabilization additive required stabilize the polyester during its conversion to monofilaments is dependent on the carboxyl content of the polyester prior to extrusion into monofilaments. In general, the amount of hydrolysis stabilization additive used is from 0.1 to 10.0 weight percent based on the polyester. Preferably the amount of the hydrolysis stabilization additive used is in the range of 0.2 to 4.0 weight percent.

The hydrolysis stabilization additive can be any known material that enhances the stability of the polyester monofilament to hydrolytic degradation. Examples of hydrolysis stabilization additives include: diazomethane, carbodiimides, epoxides, cyclic carbonates, oxazolines, aziridines, keteneimines, isocyanates, alkoxy end-capped polyalkylene glycols. However, any material that increases the hydrolytic stability of monofilaments formed from the polyesters can be used. Carbodiimides are preferred. Specific examples of carbodiimides include N,N′-di-o-tolylcarbodiimide, N,N′-diphenylcarbodiimide, N,N′dioctyldecylcarbodiimide, N,N′-di-2,6-dimethylphenylcarbodiimide, N-tolyl-N′cyclohexylcarbodiimide, N,N′-di-2,6-diisopropylphenylcarbodiimide, N,N′di-2,6-di-tert.-butylphenylcarbodiimide, N-tolyl-N′-phenylcarbodiimide, N,N′-di-p-nitrophenylcarbodiimide, N,N′di-p-aminophenylcarbodiimide, N,N′-di-p-hydroxyphenylcarbodiimide, N,N′-di-cyclohexylcarbodiimide, N,N′-di-p-tolylcarbodiimide, p-phenylene-bis-di-o-tolylcarbodiimide, p-phenylene-bisdicyclohexylcarbodiimide, hexamethylene-bisdicyclohexylcarbodiimide, ethylene-bisdiphenylcarbodiimide, benzene-2,4-diisocyanato-1,3,5-tris(1-methylethyl)homopolymer, a copolymer of 2,4-diisocyanato-1,3,5-tris(10methylethyl) with 2,6-diisoproyl diisocyanate, Such materials are commercially sold under the tradenames: STABAXOL 1, STABAXOL P, STABAXOL P-100, STABAXOL KE7646, (Rhein-Chemie, of Rheinau GmbH, Germany and Bayer). Carbodiimides are disclosed as polyester hydrolysis stabilization additives in U.S. Pat. No. 3,193,522, U.S. Pat. No. 3,193,523, U.S. Pat. No. 3,975,329, U.S. Pat. No. 5,169,499, U.S. Pat. No. 5,169,711, U.S. Pat. No. 5,246,992, U.S. Pat. No. 5,378,537, U.S. Pat. No. 5,464,890, U.S. Pat. No. 5,686,552, U.S. Pat. No. 5,763,538, U.S. Pat. No. 5,885,709 and U.S. Pat. No. 5,886,088.

Specific examples of epoxides include iso-nonyl-glycidyl ether, stearyl glycidyl ether, tricyclo-decylmethylene glycidyl ether, phenyl glycidyl ether, p-tert.-butylphenyl glycidyl ether, o-decylphenyl glycidyl ether, allyl glycidyl ether, butyl glycidyl ether, lauryl glycidyl ether, benzyl glycidyl ether, cyclohexyl glycidyl ether, alpha-cresyl glycidyl ether, decyl glycidyl ether, dodecyl glycidyl ether, N-(epoxyethyl)succinimide, and N-(2,3-epoxypropyl)phthalimide. Catalysts can be included to increase the rate of reaction, for example; alkali metal salts. Epoxides are disclosed as polyester hydrolysis stabilization additives in U.S. Pat. No. 3,627,867, U.S. Pat. No. 3,657,191, U.S. Pat. No. 3,869,427, U.S. Pat. No. 4,016,142, U.S. Pat. No. 4,071,504, U.S. Pat. No. 4,139,521, U.S. Pat. No. 4,144,285, U.S. Pat. No. 4,374,960, U.S. Pat. No. 4,520,174, U.S. Pat. No. 4,520,175, U.S. Pat. No. 5,763,538, and U.S. Pat. No. 5,886,088.

Specific examples of cyclic carbonates include ethylene carbonate, methyl ethylene carbonate, 1,1,2,2-tetramethyl ethylene carbonate, and 1,2-diphenyl ethylene carbonate. Cyclic carbonates, such as ethylene carbonate, are disclosed as hydrolysis stabilization additives in U.S. Pat. No. 3,657,191, U.S. Pat. No. 4,374,960, and U.S. Pat. No. 4,374,961.

The hydrolysis stabilization additive can be incorporated into the polyesters in a separate melt compounding process, using any known intensive mixing process, such as extrusion through a single screw or twin screw extruder; by intimate mixing with the solid granular material, such as mixing, stirring or pellet blending operations; or by cofeeding within the monofilament process. Preferably, the hydrolysis stabilization additive is incorporated by cofeeding within the monofilament process.

The polyesters can be formed into monofilaments by any known method, for example as disclosed in U.S. Pat. No. 3,051,212, U.S. Pat. No. 3,999,910, U.S. Pat. No. 4,024,698, U.S. Pat. No. 4,030,651, U.S. Pat. No. 4,072,457, and U.S. Pat. No. 4,072,663. As one skilled in the art would appreciate, the process can be tailored to take into account the material to be formed into monofilaments and the physical and chemical properties desired in the monofilament. Optimal spinning parameters for achieving a desired combination of monofilament properties can be determined by one skilled in the art for a particular polyester composition.

The polyesters are preferably dried prior to being formed into monofilaments. In general, the polyesters are melted at a temperature in the range of about 100 to about 300° C. Preferably, the polyesters are melted at a temperature within the range of about 150 to about 290° C. The spinning can generally be carried out by a spinning grid or an extruder. The extruder melts the dried granular polyester and conveys the melt to a spinning aggregate by a screw. It is well known that polyesters can thermally degrade due to time and temperature in the melt. It is preferred that the time that the polyester is in the melt is minimized, which can be done by the use of the shortest practical length of pipes between the point at which melting of the polyester occurs and the spinneret. The molten polyester can be filtered through, for example, screen filters, to remove any particulate foreign matter. The molten polyester can then be conveyed, optionally through a metering pump, through a die to form the monofilament. After exiting the die, the monofilaments can be quenched in an air or a water bath to form solid filaments. The monofilament can be spin finished. The filaments can be drawn at elevated temperatures up to 100° C. between a set of draw rolls to a draw ratio of from 3.0:1 to 4.5:1, and optionally be further drawn at a higher temperature of up to 250° C. to a maximum draw ratio of 6.5:1 and allowed to relax up to about 30 percent maximum while heated in a relaxing stage. The finished cooled monofilaments may then be wound up onto spools. The polyesters can be formed into monofilaments by any known process. The monofilaments can further be woven using known processes into textile fabrics.

In order to provide the desired tenacity, the filaments prepared from the polyesters can be drawn at least about 2:1. Preferably the filaments of the present invention can be drawn at least about 4:1. The overall draw ratio can be varied to allow for the production of a range of denier of the monofilaments.

Typical ranges of sizes of monofilaments used in press fabrics and dryer fabrics are 0.20 mm to 1.27 mm in diameter or the equivalent mass in cross-section in other cross-section shapes, such as square or oval. For forming fabrics, finer monofilaments are used, for example, as small as 0.05 mm to about 0.9 mm in diameter. Most often, the monofilaments used in forming fabrics have a diameter from about 0.12 mm to about 0.4 mm. On the other hand, for special industrial applications, monofilaments of 3.8 mm in diameter or greater may be desired.

The monofilaments can have any cross-sectional shape, such as, for example, circle, flattened figure, square, triangle, pentagon, other polygon, multifoil, dumbbell, or cocoon. When the monofilament is intended as a warp in a papermaking drier canvas, a cross-sectional shape of a flattened figure is preferred, to improve the amount of proof against staining and ensure a desirable degree of flatness of the drier canvas. The term “flattened figure” as used herein refers to an ellipse or a rectangle. The term not only embraces a geometrically defined ellipse and rectangle but also shapes similar to an ellipse and a rectangle and includes a shape obtained by rounding the four corners of a rectangle.

The polyesters can be formed into shaped foamed articles, and can provide improved properties over other polymeric materials in some applications. Thermoplastic polymeric materials are foamed to provide low density articles, such as films, cups, food trays, decorative ribbons, and furniture parts. For example, polystyrene beads containing low boiling hydrocarbons, such as pentane, are formed into light weight foamed cups for hot drinks such as coffee, tea, hot chocolate. Polypropylene can be extruded in the presence of blowing agents such as nitrogen or carbon dioxide gas to provide decorative films and ribbons for package wrappings. Also, polypropylene can be injection molded in the presence of blowing agents to form lightweight furniture parts such as table legs and to form lightweight chairs. Polyesters, such as poly(ethylene terephthalate), typically have a much higher density, (e.g.; 1.3 g/cc), than other polymers. It would, therefore, be desirable to be able to foam polyester materials to decrease the weight of molded parts, films, sheets, food trays, and thermoformed parts. Such foamed articles also provide better insulating properties than unfoamed articles. The foamable polyester compositions can include a wide variety of additives and/or fillers, and can be blended with other materials.

It is generally preferred that a polyester to be foamed has a relatively high melt viscosity, in order to have sufficient melt viscosity to hold the as-formed foamed shape sufficiently long for the polyester to solidify to form the foamed article. This can be achieved by raising the as produced polyester inherent viscosity by post-polymerization processes, such as the solid state polymerization method, as described above. Alternatively, a branching agent can be incorporated into the polyester, such as described in U.S. Pat. No. 4,132,707, U.S. Pat. No. 4,145,466, U.S. Pat. No. 4,999,388, U.S. Pat. No. 5,000,991, U.S. Pat. No. 5,110,844, U.S. Pat. No. 5,128,383, and U.S. Pat. No. 5,134,028. Such branched polyesters can additionally be subjected to solid state polymerization, as described hereinabove, to further increase the melt viscosity. It has also been found that the incorporation of sulfonate substituents onto the polyetherester backbone can raise the apparent melt viscosity of the polyester, providing an adequate foamable polyester.

The polyesters can be foamed by a wide variety of methods, including the injection of an inert gas such as nitrogen or carbon dioxide into the melt during extrusion or molding operations. Alternatively, inert hydrocarbon gases such as methane, ethane, propane, butane, and pentane, or chlorofluorocarbons, hydrochlorofluorocarbons, or hydrofluorocarbons, can be used. Another method involves the dry blending of chemical blowing agents with the polyester and then extruding or molding the polyester to provide foamed articles. During the extrusion or molding operation, an inert gas such as nitrogen is released from the blowing agents and provides the foaming action. Typical blowing agents include azodicaronamide, hydrazocarbonamide, dinitrosopentamethylenetetramine, p-toluenesulfonyl hydrazodicarboxylate, 5-phenyl-3,6-dihydro-1,3,4-oxa-diazin-2-one, sodium borohydride, sodium bicarbonate, 5-phenyltetrazole, p,p′-oxybis(benzenesulfonylhydrazide). Still another method involves the blending of sodium carbonate or sodium bicarbonate with one portion of polyester pellets, blending of an organic acid, such as citric acid, with another portion of polyester pellets and then blending of the two portions of pellets together by extrusion or molding at elevated temperatures. Carbon dioxide gas is released from the interaction of the sodium carbonate or bicarbonate with citric acid to provide the desired foaming action in the polymeric melt.

It is desirable that the foamable polyester compositions incorporate nucleation agents to create sites for bubble initiation, influence the cell size of the foamed sheet or object and to hasten the solidification of the as foamed article. Examples of the nucleation agents may include sodium acetate, talc, titanium dioxide, polyolefin materials such as polyethylene, polypropylene.

Polymeric foaming equipment and processes are well known and are disclosed, for example, in U.S. Pat. No. 5,116,881, U.S. Pat. No. 5,134,028, U.S. Pat. No. 4,626,183, U.S. Pat. No. 5,128,383, U.S. Pat. No. 4,746,478, U.S. Pat. No. 5,110,844, U.S. Pat. No. 5,000.844, and U.S. Pat. No. 4,761,256. Reviews of foaming technology can be found in Kirk-Othmer Encyclopedia of Chemical Technology, Third Edition, Volume 11, pp. 82-145 (1980), John Wiley and Sons, Inc., New York, N.Y. and the Encyclopedia of Polymer Science and Engineering, Second Edition, Volume 2, pp. 434-446 (1985), John Wiley and Sons, Inc., New York, N.Y.

### EXAMPLES

Test Methods

DSC is performed on a TA Instruments Model Number 2920 machine. Samples are heated under a nitrogen atmosphere at a rate of 20° C./minute to 300° C., programmed cooled back to room temperature at a rate of 20° C./minute and then reheated to 300° C. at a rate of 20° C./minute. The observed sample glass transition temperature (T_{g}) and crystalline melting temperature (Tₘ) noted below were from the second heat.

Inherent Viscosity, (IV), is defined in Preparative Methods of Polymer Chemistry, W. R. Sorenson and T. W. Campbell, 1961, p. 35. It is determined at a concentration of 0.5 g/100 mL of a 50:50 weight percent trifluoroacetic acid:dichloromethane acid solvent system at room temperature by a Goodyear R-103B method.

Laboratory Relative Viscosity (LRV) is the ratio of the viscosity of a solution of 0.6 gram of the polyester sample dissolved in 10 mL of hexafluoroisopropanol, (HFIP) containing 80 ppm sulfuric acid to the viscosity of the sulfuric acid-containing hexafluoroisopropanol itself, both measured at 25° C. in a capillary viscometer. The LRV can be numerically related to IV. Where this relationship is utilized, the term “calculated” is noted.

Surface resistivity was measured on melt pressed films of the compositions noted with a T Rek Model Number 152 CE Resistance Meter, (T Rek, Inc.), at a 10 volt test voltage. This meter can test samples only down to 10³ Ohms per square. Any measurements measured at 10³ Ohms per square may have surface resistivities less than 10³ Ohms per square.

### Example 1

To a 250 milliliter glass flask was added bis(2-hydroxyethyl)terephthalate, (132.43 grams) and pumice, (0.0053 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.5 hours while under a slow nitrogen purge. The reaction mixture was heated to 295° C. over 0.5 hours with stirring under a slow nitrogen purge. The resulting reaction mixture was stirred at 295° C. under a slight nitrogen purge for 0.8 hours. 13.0 grams of a colorless distillate were collected over the heating cycle. The reaction mixture was then staged to full vacuum with stirring at 295° C. The resulting reaction mixture was stirred for 3.9 hours under full vacuum (pressure less than 100 mtorr). The vacuum was then released with nitrogen and the reaction mass allowed to cool to room temperature. An additional 12.7 grams of distillate were recovered and 62.7 grams of a solid product were recovered.

A sample was measured for LRV as described above and was found to have an LRV of 25.66. This sample was calculated to have an inherent viscosity of 0.71 dL/g.

The sample underwent DSC analysis. A recrystallization temperature was found on the programmed cool after the first heat cycle with an onset temperature of 192.2° C. and a peak at 181.5° C., (37.4 J/g). A Tg was found with an onset temperature of 70.6° C., a midpoint temperature of 75.6° C., and an endpoint temperature of 81.1° C. A Tm was observed at 248.4° C., (34.2 J/g).

### Example 2

To a 250 milliliter glass flask was added bis(2-hydroxyethyl)terephthalate, (132.46 grams) and pumice, (0.013 grams, 2.5 micron median particle diameter, Hess Superior Grade Pumice, Grade 2.5 micron.) The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.1 hours while under a slow nitrogen purge. After achieving 225° C., the resulting reaction mixture was stirred at 225° C. for 0.7 hours while under a slow nitrogen purge. The reaction mixture was heated to 295° C. over 0.7 hours with stirring under a slow nitrogen purge. The resulting reaction mixture was stirred at 295° C. under a slight nitrogen purge for 0.6 hours. 19.3 grams of a colorless distillate were collected over this heating cycle. The reaction mixture was then staged to full vacuum with stirring at 295° C. The resulting reaction mixture was stirred for 1.1 hours under full vacuum, (pressure less than 100 mtorr). The vacuum was then released with nitrogen and the reaction mass allowed to cool to room temperature. An additional 9.3 grams of distillate were recovered and 73.8 grams of a solid product were recovered.

A sample was measured for LRV as described above and was found to have an LRV of 21.74. This sample was calculated to have an inherent viscosity of 0.64 dL/g.

The sample underwent DSC analysis. A recrystallization temperature was found on the programmed cool after the first heat cycle with an onset temperature of 184.9° C. and a peak at 169.5° C., (35.4 J/g). A Tg was found with an onset temperature of 75.4° C., a midpoint temperature of 77.4° C., and an endpoint temperature of 79.4° C. A Tm was observed at 249.3° C., (32.3 J/g).

### Example 3

To a 250 milliliter glass flask was added dimethyl terephthalate, (94.00 grams), 1,3-propanediol, (48.04 grams), manganese(II) acetate tetrahydrate, (0.444 grams), and pumice, (0.010 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225°C. for 0.8 hours while under a slow nitrogen purge. The reaction mixture was heated to 255° C. over 0.3 hours with stirring under a slow nitrogen purge. The resulting reaction mixture was stirred at 255° C. under a slight nitrogen purge for 0.9 hours. 22.8 grams of a colorless distillate were collected over this heating cycle. The reaction mixture was then staged to full vacuum with stirring at 255° C. The resulting reaction mixture was stirred for 3.2 hours under full vacuum, (pressure less than 100 mtorr). The vacuum was then released with nitrogen and the reaction mass allowed to cool to room temperature. An additional 3.4 grams of distillate were recovered and 72.0 grams of a solid product were recovered.

A sample was measured for LRV as described above and was found to have an LRV of 21.72. This sample was calculated to have an inherent viscosity of 0.64 dL/g.

The sample underwent DSC analysis. A recrystallization temperature was found on the programmed cool after the first heat cycle with an onset at 179.8° C. and a peak at 168.9° C., (53.8 J/g). A Tm was observed at 229.8° C., (54.0 J/g).

### Example 4

To a 250 milliliter glass flask was added dimethyl terephthalate, (25.00 grams), 1,4-butanediol, (13.31 grams), poly(tetramethylene ether)glycol, (75.00 grams, average molecular weight of 2000), pumice, (0.0118 grams, 2.5 micron median particle diameter, Hess Superior Grade Pumice, Grade 2.5 micron) and manganese(II) acetate tetrahydrate, (0.0450 grams). The reaction mixture was stirred and heated to 180° C. under a slow nitrogen purge. After achieving 180°0 C., the resulting reaction mixture was stirred at 180° C. for 0.4 hours while under a slow nitrogen purge. The reaction mixture was stirred and heated to 190° C. over 0.2 hours under a slow nitrogen purge. After achieving 190° C., the resulting reaction mixture was stirred at 190° C. for 0.6 hours while under a slow nitrogen purge. The reaction mixture was stirred and heated to 200° C. over 0.2 hours under a slow nitrogen purge. After achieving 200° C., the resulting reaction mixture was stirred at 200° C. for 0.5 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.5 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.8 hours. 1.0 gram of a colorless distillate was collected over this heating cycle. The reaction mixture was then staged to full vacuum with stirring at 255° C. The resulting reaction mixture was stirred for 3.1 hours under full vacuum, (pressure less than 100 mtorr). The vacuum was then released with nitrogen and the reaction mass allowed to cool to room temperature. An additional 11.0 grams of distillate were recovered and 81.7 grams of a solid product were recovered.

A sample was measured for LRV as described above and was found to have an LRV of 6.89. This sample was calculated to have an inherent viscosity of 0.37 dL/g.

The sample underwent DSC analysis. A recrystallization temperature was found on the programmed cool after the first heat cycle with an onset at 149.1° C. and a peak at 128.3° C., (4.1 J/g). A Tm was observed at 155.7° C., (3.3 J/g).

### Example 5

To a 250 milliliter glass flask was added bis(2-hydroxyethyl)terephthalate, (132.42 grams) and pumice, (0.05 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.7 hours while under a slow nitrogen purge. The reaction mixture was heated to 295120 C. over 0.7 hours with stirring under a slow nitrogen purge. The resulting reaction mixture was stirred at 295° C. under a slight nitrogen purge for 0.7 hours. 13.1 grams of a colorless distillate were collected over this heating cycle. The reaction mixture was then staged to full vacuum with stirring at 295° C. The resulting reaction mixture was stirred for 3.4 hours under full vacuum, (pressure less than 100 mtorr). The vacuum was then released with nitrogen and the reaction mass allowed to cool to room temperature. An additional 12.5 grams of distillate were recovered and 79.4 grams of a solid product were recovered.

A sample was measured for LRV as described above and was found to have an LRV of 19.20. This sample was calculated to have an inherent viscosity of 0.59 dL/g.

The sample underwent DSC analysis. A recrystallization temperature was found on the programmed cool after the first heat cycle with an onset temperature of 191.2° C. and a peak at 181.4° C., (38.8 J/g). A Tg was found with an onset temperature of 67.6° C., a midpoint temperature of 74.3° C., and an endpoint temperature of 80.7° C. A Tm was observed at 245.0° C., (35.0 J/g).

### Example 6

To a 250 milliliter glass flask was added bis(2-hydroxyethyl)terephthalate, (132.42 grams), sodium acetate, (0.1793 grams) and pumice, (0.0507 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.5 hours while under a slow nitrogen purge. The reaction mixture was heated to 295° C. over 0.3 hours with stirring under a slow nitrogen purge. The resulting reaction mixture was stirred at 295° C. under a slight nitrogen purge for 0.6 hours. 20.5 grams of a colorless distillate were collected over this heating cycle. The reaction mixture was then staged to full vacuum with stirring at 295° C. The resulting reaction mixture was stirred for 3.1 hours under full vacuum, (pressure less than 100 mtorr). The vacuum was then released with nitrogen and the reaction mass allowed to cool to room temperature. An additional 10.5 grams of distillate were recovered and 82.9 grams of a solid product were recovered.

A sample was measured for LRV as described above and was found to have an LRV of 10.59. This sample was calculated to have an inherent viscosity of 0.47 dL/g.

The sample underwent DSC analysis. A recrystallization temperature was found on the programmed cool after the first heat cycle with an onset temperature of 222.5° C. and a peak at 219.3° C., (47.0 J/g). A Tg was found with an onset temperature of 72.1° C., a midpoint temperature of 77.5° C., and an endpoint temperature of 83.1° C. A Tm was observed at 255.4-C, (45.9 J/g).

### Example 7

To a 250 milliliter glass flask was added dimethyl terephthalate, (61.00 grams), dimethyl isophthalate, (40.45 grams), ethylene glycol, (64.80 grams), pumice, (0.0510 grams, 2.5 micron median particle diameter, Hess Superior Grade Pumice, Grade 2.5 micron, a product of Hess Pumice Products, Inc.), and manganese(II) acetate tetrahydrate, (0.0442 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was stirred and heated to 190° C. over 0.2 hours under a slow nitrogen purge. After achieving 190° C., the resulting reaction mixture was stirred at 190° C. for 0.4 hours while under a slow nitrogen purge. The reaction mixture was stirred and heated to 200° C. over 0.2 hours under a slow nitrogen purge. After achieving 200° C., the resulting reaction mixture was stirred at 200° C. for 0.6 hours while under a slow nitrogen purge. The reaction mixture was then stirred and heated to 225° C. over 0.1 hours while under a slow nitrogen purge. After achieving 225° C., the resulting reaction mixture was stirred at 225° C. for 0.5 hours while under a slow nitrogen purge. The reaction mixture was heated to 295° C. over 0.5 hours with stirring under a slow nitrogen purge. The resulting reaction mixture was stirred at 295° C. under a slight nitrogen purge for 0.7 hours. 41.3 grams of a colorless distillate were collected over this heating cycle. The reaction mixture was then staged to full vacuum with stirring at 295° C. The resulting reaction mixture was stirred for 3.3 hours under full vacuum, (pressure less than 100 mtorr). The vacuum was then released with nitrogen and the reaction mass allowed to cool to room temperature. An additional 11.8 grams of distillate were recovered and 95.7 grams of a solid product were recovered.

A sample was measured for LRV as described above and was found to have an LRV of 18.26. This sample was calculated to have an inherent viscosity of 0.54 dL/g.

The sample underwent DSC analysis. A Tg was found with an onset temperature of 62.0C, and an endpoint temperature of 72.1° C. A Tm was not observed.

### Example 8

To a 250 milliliter glass flask was added bis(2-hydroxyethyl)terephthalate, (132.73 grams) and pumice, (0.10 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.5 hours while under a slow nitrogen purge. The reaction mixture was heated to 295° C. over 0.5 hours with stirring under a slow nitrogen purge. The resulting reaction mixture was stirred at 295° C. under a slight nitrogen purge for 1.4 hours. 17.1 grams of a colorless distillate were collected over this heating cycle. The reaction mixture was then staged to full vacuum with stirring at 295° C. The resulting reaction mixture was stirred for 2.0 hours under full vacuum, (pressure less than 100 mtorr). The vacuum was then released with nitrogen and the reaction mass allowed to cool to room temperature. An additional 13.1 grams of distillate were recovered and 63.1 grams of a solid product were recovered.

A sample was measured for LRV as described above and was found to have an LRV of 24.14. This sample was calculated to have an inherent viscosity of 0.68 dL/g.

The sample underwent DSC analysis. A recrystallization temperature was found on the programmed cool after the first heat cycle with an onset temperature of 188.4° C. and a peak at 177.9° C., (34.4 J/g). A Tg was found with an onset temperature of 73.8° C., a midpoint temperature of 77.1° C., and an endpoint temperature of 80.3° C. A Tm was observed at 247.8° C., (32.2 J/g).

### Example 9

To a 250 milliliter glass flask was added bis(2-hydroxyethyl)terephthalate, (132.28 grams), sodium acetate, (0.1784 grams) and pumice, (0.10 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.9 hours while under a slow nitrogen purge. The reaction mixture was heated to 295° C. over 1.5 hours with stirring under a slow nitrogen purge. The resulting reaction mixture was stirred at 295° C. under a slight nitrogen purge for 0.3 hours. 18.9 grams of a colorless distillate were collected over this heating cycle. The reaction mixture was then staged to full vacuum with stirring at 295° C. The resulting reaction mixture was stirred for 2.3 hours under full vacuum, (pressure less than 100 mtorr). The vacuum was then released with nitrogen and the reaction mass allowed to cool to room temperature. An additional 12.4 grams of distillate were recovered and 65.7 grams of a solid product were recovered.

A sample was measured for LRV as described above and was found to have an LRV of 23.68. This sample was calculated to have an inherent viscosity of 0.67 dL/g.

The sample underwent DSC analysis. A recrystallization temperature was found on the programmed cool after the first heat cycle with an onset temperature of 210.8° C. and a peak at 208.9° C., (38.6 J/g). A Tg was found with an onset temperature of 74.2° C., a midpoint temperature of 78.7° C., and an endpoint temperature of 83.5° C. A Tm was observed at 249.9° C., (34.2 J/g).

### Example 10

To a 250 milliliter glass flask was added bis(2-hydroxyethyl)terephthalate, (112.55 grams), poly(ethylene glycol), (15.00 grams, average molecular weight Of 1500), and pumice, (0.10 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.8 hours while under a slow nitrogen purge. The reaction mixture was heated to 295° C. over 1.0 hour with stirring under a slow nitrogen purge. The resulting reaction mixture was stirred at 295° C. under a slight nitrogen purge for 1.3 hours. 16.4 grams of a colorless distillate were collected over this heating cycle. The reaction mixture was then staged to full vacuum with stirring at 295° C. The resulting reaction mixture was stirred for 2.9 hours under full vacuum, (pressure less than 100 mtorr). The vacuum was then released with nitrogen and the reaction mass allowed to cool to room temperature. An additional 10.8 grams of distillate were recovered and 80.4 grams of a solid product were recovered.

A sample was measured for LRV as described above and was found to have an LRV of 10.44. This sample was calculated to have an inherent viscosity of 0.43 dL/g.

The sample underwent DSC analysis. A recrystallization temperature was found on the programmed cool after the first heat cycle with an onset temperature of 196.6° C. and a peak at 187.3° C., (39.6 J/g). A Tm was observed at 249.1 ° C., (34.9 J/g).

### Example 11

To a 250 milliliter glass flask was added dimethyl terephthalate, (91.38 grams), 1,4-cyclohexanedimethanol, (21.80 grams), ethylene glycol, (39.79 grams), pumice, (0.1007 grams, 2.5 micron median particle diameter, Hess Superior Grade Pumice, Grade 2.5 micron) and manganese(II) acetate tetrahydrate (0.0444 grams). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was stirred and heated to 190° C. over 0.1 hours under a slow nitrogen purge. After achieving 190° C., the resulting reaction mixture was stirred at 190° C. for 0.4 hours while under a slow nitrogen purge. The reaction mixture was then stirred and heated to 225° C. over 0.4 hours while under a slow nitrogen purge. After achieving 225° C., the resulting reaction mixture was stirred at 225° C. for 1.0 hour while under a slow nitrogen purge. The reaction mixture was heated to 295° C. over 0.7 hours with stirring under a slow nitrogen purge. The resulting reaction mixture was stirred at 295° C. under a slight nitrogen purge for 0.7 hours. 30.0 grams of a colorless distillate were collected over this heating cycle. The reaction mixture was then staged to full vacuum with stirring at 295° C. The resulting reaction mixture was stirred for 1.2 hours under full vacuum, (pressure less than 100 mtorr). The vacuum was then released with nitrogen and the reaction mass allowed to cool to room temperature. An additional 12.9 grams of distillate were recovered and 68.9 grams of a solid product were recovered.

A sample was measured for LRV as described above and was found to have an LRV of 21.12. This sample was calculated to have an inherent viscosity of 0.63 dL/g.

The sample underwent DSC analysis. A Tg was found with an onset temperature of 81.8° C., and an endpoint temperature of 84.9° C. A Tm was not observed.

### Example 12

To a 250 milliliter glass flask was added dimethyl terephthalate, (94.32 grams), 1,3-propanediol, (48.00 grams), manganese(II) acetate tetrahydrate, (0.451 grams), and pumice, (0.010 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 200° C. over 0.3 hours while under a slow nitrogen purge. After achieving 190° C., the resulting reaction mixture was stirred at 200° C. for 0.7 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.9 hours while under a slow nitrogen purge. The reaction mixture was heated to 255° C. over 0.3 hours with stirring under a slow nitrogen purge. The resulting reaction mixture was stirred at 255° C. under a slight nitrogen purge for 0.6 hours. 21.9 grams of a colorless distillate were collected over this heating cycle. The reaction mixture was then staged to full vacuum with stirring at 255° C. The resulting reaction mixture was stirred for 3.4 hours under full vacuum, (pressure less than 100 mtorr). The vacuum was then released with nitrogen and the reaction mass allowed to cool to room temperature. An additional 3.3 grams of distillate were recovered and 71.2 grams of a solid product were recovered.

A sample was measured for LRV as described above and was found to have an LRV of 23.36. This sample was calculated to have an inherent viscosity of 0.67 dL/g.

The sample underwent DSC analysis. A recrystallization temperature was found on the programmed cool after the first heat cycle with an onset at 186.1° C. and a peak at 176.2° C., (53.2 J/g). A Tm was observed at 231.2° C., (51.1 J/g).

### Example 13

To a 250 milliliter glass flask was added bis(2-hydroxyethyl)terephthalate, (125.80 grams) and pumice, (5.00 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.7 hours while under a slow nitrogen purge. The reaction mixture was heated to 295° C. over 0.5 hours with stirring under a slow nitrogen purge. The resulting reaction mixture was stirred at 295° C. under a slight nitrogen purge for 0.8 hours. 18.0 grams of a colorless distillate were collected over this heating cycle. The reaction mixture was then staged to full vacuum with stirring at 295° C. The resulting reaction mixture was stirred for 0.6 hours under full vacuum, (pressure less than 100 mtorr). The vacuum was then released with nitrogen and the reaction mass allowed to cool to room temperature. An additional 11.5 grams of distillate were recovered and 79.9 grams of a solid product were recovered.

A sample was measured for LRV as described above and was found to have an LRV of 15.38. This sample was calculated to have an inherent viscosity of 0.53 dL/g.

The sample underwent DSC analysis. A recrystallization temperature was found on the programmed cool after the first heat cycle with an onset temperature of 200.9° C. and a peak at 194.7° C., (39.3 J/g). A Tg was found with an onset temperature of 72.5° C., a midpoint temperature of 76.5° C., and an endpoint temperature of 80.4° C. A Tm was observed at 250.9° C., (35.1 J/g).

### Example 14

To a 250 milliliter glass flask was added dimethyl terephthalate, (91.03 grams), ethylene glycol, (58.31 grams), and pumice, (10.00 grams, 2.5 micron median particle diameter, Hess Superior Grade Pumice, Grade 2.5 micron). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.7 hours while under a slow nitrogen purge. The reaction mixture was heated to 295° C. over 0.7 hours with stirring under a slow nitrogen purge. The resulting reaction mixture was stirred at 295° C. under a slight nitrogen purge for 0.6 hours. 37.6 grams of a colorless distillate were collected over this heating cycle. The reaction mixture was then staged to full vacuum with stirring at 295° C. The resulting reaction mixture was stirred for 2.7 hours under full vacuum, (pressure less than 100 mtorr). The vacuum was then released with nitrogen and the reaction mass allowed to cool to room temperature. An additional 10.1 grams of distillate were recovered and 84.7 grams of a solid product were recovered.

A sample was measured for LRV as described above and was found to have an LRV of 24.21. This sample was calculated to have an inherent viscosity of 0.68 dL/g.

The sample underwent DSC analysis. A recrystallization temperature was found on the programmed cool after the first heat cycle with an onset temperature of 197.1° C. and a peak at 191.4° C., (34.8 J/g). A Tg was found with an onset temperature of 70.6° C., a midpoint temperature of 75.6° C., and an endpoint temperature of 80.6° C. A Tm was observed at 248.5° C., (30.8 J/g).

### Example 15

To a 250 milliliter glass flask was added bis(2-hydroxyethyl)terephthalate, (83.52 grams), poly(ethylene glycol)-block-poly(propylene glycol)-block-poly(ethylene glycol), (27.00 grams, average molecular weight of 2000, 10 weight percent ethylene glycol), and pumice, (10.00 grams, 5.0 micron median particle diameter, Hess Superior Grade Pumice, Grade 5 micron). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.6 hours while under a slow nitrogen purge. The reaction mixture was heated to 295° C. over 0.7 hours with stirring under a slow nitrogen purge. The resulting reaction mixture was stirred at 295° C. under a slight nitrogen purge for 1.0 hour. 12.8 grams of a colorless distillate were collected over this heating cycle. The reaction mixture was then staged to full vacuum with stirring at 295° C. The resulting reaction mixture was stirred for 3.7 hours under full vacuum, (pressure less than 100 mtorr). The vacuum was then released with nitrogen and the reaction mass allowed to cool to room temperature. An additional 8.8 grams of distillate were recovered and 77.9 grams of a solid product were recovered.

A sample was measured for LRV as described above and was found to have an LRV of 8.12. This sample was calculated to have an inherent viscosity of 0.39 dL/g.

The sample underwent DSC analysis. A recrystallization temperature was found on the programmed cool after the first heat cycle with an onset at 186.9° C. and a peak at 181.0° C., (28.1 J/g). A Tm was observed at 218.9° C., (22.1 J/g).

### Example 16

To a 250 milliliter glass flask was added bis(2-hydroxyethyl)terephthalate, (126.00 grams), pumice, (5.01 grams, 2.5 micron median particle diameter, Hess Superior Grade Pumice, Grade 2.5 micron), manganese(II) acetate tetrahydrate (0.0444 grams), and antimony(III) trioxide (0.0359 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.6 hours while under a slow nitrogen purge. The reaction mixture was heated to 295° C. over 0.4 hours with stirring under a slow nitrogen purge. The resulting reaction mixture was stirred at 295° C. under a slight nitrogen purge for 1.1 hours. 19.6 grams of a colorless distillate were collected over this heating cycle. The reaction mixture was then staged to full vacuum with stirring at 295° C. The resulting reaction mixture was stirred for 0.3 hours under full vacuum, (pressure less than 100 mtorr). The vacuum was then released with nitrogen and the reaction mass allowed to cool to room temperature. An additional 10.1 grams of distillate were recovered and 93.1 grams of a solid product were recovered.

A sample was measured for LRV as described above and was found to have an LRV of 16.66. This sample was calculated to have an inherent viscosity of 0.55 dL/g.

The sample underwent DSC analysis. A recrystallization temperature was found on the programmed cool after the first heat cycle with an onset temperature of 203.6° C. and a peak at 195.3° C., (38.1 J/g). A Tg was found with an onset temperature of 71.4° C., a midpoint temperature of 76.3° C., and an endpoint temperature of 81.1° C. A Tm was observed at 250.1° C., (34.6 J/g).

### Example 17

To a 250 milliliter glass flask was added bis(2-hydroxyethyl)terephthalate, (125.80 grams), pumice, (5.00 grams, 5 micron median particle diameter, Hess Superior Grade Pumice, Grade 5 micron), manganese(II) acetate tetrahydrate (0.0446 grams), and antimony(III) trioxide (0.0359 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.7 hours while under a slow nitrogen purge. After achieving 225° C., the resulting reaction mixture was stirred at 225° C. for 0.7 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.7 hours. 19.3 grams of a colorless distillate were collected over this heating cycle. The reaction mixture was then staged to full vacuum with stirring at 295° C. The resulting reaction mixture was stirred for 2.2 hours under full vacuum, (pressure less than 100 mtorr). The vacuum was then released with nitrogen and the reaction mass allowed to cool to room temperature. An additional 11.6 grams of distillate were recovered and 92.5 grams of a solid product were recovered.

A sample was measured for LRV as described above and was found to have an LRV of 23.05. This sample was calculated to have an inherent viscosity of 0.66 dL/g.

The sample underwent DSC analysis. A recrystallization temperature was found on the programmed cool after the first heat cycle with an onset temperature of 193.0° C. and a peak at 183.7° C., (39.4 J/g). A Tg was found with an onset temperature of 70.3° C., a midpoint temperature of 73.9° C., and an endpoint temperature of 77.4° C. A Tm was observed at 244.7° C., (32.8 J/g).

### Example 18

To a 250 milliliter glass flask was added bis(2-hydroxyethyl)terephthalate, (120.50 grams), a ball milled dispersion of 8.00 weight percent Ketjinblack® EC300J carbon black and 0.7 weight percent polyvinylpyrrolidone in ethylene glycol, (50.00 grams, Aquablak® 6071 provided by Solutions Dispersions, Inc.), pumice, (5.00 grams, 2.5 micron median particle diameter, Hess Superior Grade Pumice, Grade 2.5 micron), manganese(II) acetate tetrahydrate (0.0446 grams), and antimony(III) trioxide (0.0359 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.6 hours. 65.3 grams of a colorless distillate were collected over this heating cycle. The reaction mixture was then staged to full vacuum with stirring at 295° C. The resulting reaction mixture was stirred for 2.1 hours under full vacuum, (pressure less than 100 mtorr). The vacuum was then released with nitrogen and the reaction mass allowed to cool to room temperature. An additional 7.3 grams of distillate were recovered and 90.1 grams of a solid product were recovered.

A sample was measured for LRV as described above and was found to have an LRV of 16.03. This sample was calculated to have an inherent viscosity of 0.54 dL/g.

The sample underwent DSC analysis. A recrystallization temperature was found on the programmed cool after the first heat cycle with an onset temperature of 209.7° C. and a peak at 205.0° C., (40.0 J/g). A Tg was found with an onset temperature of 68.8° C., a midpoint temperature of 72.7° C., and an endpoint temperature of 76.8° C. A Tm was observed at 245.5° C., (40.0 J/g).

### Example 19

To a 250 milliliter glass flask was added bis(2-hydroxyethyl)terephthalate, (120.50 grams), a ball milled dispersion of 8.00 weight percent Ketjinblack® EC300J carbon black and 0.7 weight percent polyvinylpyrrolidone in ethylene glycol, (50.00 grams, Aquablak® 6071 provided by Solutions Dispersions, Inc.), pumice, (5.00 grams, 5 micron median particle diameter, Hess Superior Grade Pumice, Grade 2.5 micron), manganese(II) acetate tetrahydrate (0.0446 grams), and antimony(III) trioxide (0.0359 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.7 hours while under a slow nitrogen purge. After achieving 225° C., the resulting reaction mixture was stirred at 225° C. for 0.5 hours while under a slow nitrogen purge. The reaction mixture was heated to 295° C. over 1.0 hour with stirring under a slow nitrogen purge. The resulting reaction mixture was stirred at 295° C. under a slight nitrogen purge for 0.6 hours. 65.3 grams of a colorless distillate were collected over this heating cycle. The reaction mixture was then staged to full vacuum with stirring at 295° C. The resulting reaction mixture was stirred for 1.5 hours under full vacuum, (pressure less than 100 mtorr). The vacuum was then released with nitrogen and the reaction mass allowed to cool to room temperature. An additional 7.3 grams of distillate were recovered and 92.1 grams of a solid product were recovered.

A sample was measured for LRV as described above and was found to have an LRV of 16.59. This sample was calculated to have an inherent viscosity of 0.55 dL/g.

The sample underwent DSC analysis. A recrystallization temperature was found on the programmed cool after the first heat cycle with an onset temperature of 208.4° C. and a peak at 203.6° C., (38.8 J/g). A Tg was found with an onset temperature of 70.6° C., a midpoint temperature of 72.8° C., and an endpoint temperature of 73.6° C. A Tm was observed at 244.3° C., (38.4 J/g).

### Example 20

To a 250 milliliter glass flask was added bis(2-hydroxyethyl)terephthalate, (132.55 grams) and Dicaperl® HP-2000 perlite (0.11 grams, an unmodified expanded grade of perlite produced by Grefco Minerals, Inc.). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.8 hours while under a slow nitrogen purge. The reaction mixture was heated to 295° C. over 1.2 hours with stirring under a slow nitrogen purge. The resulting reaction mixture was stirred at 295° C. under a slight nitrogen purge for 0.8 hours. 14.4 grams of a colorless distillate were collected over this heating cycle. The reaction mixture was then staged to full vacuum with stirring at 295° C. The resulting reaction mixture was stirred for 2.8 hours under full vacuum, (pressure less than 100 mtorr). The polymerization did not build any melt viscosity. The vacuum was then released with nitrogen and the reaction mass allowed to cool to room temperature. An additional 7.8 grams of distillate were recovered and 58.2 grams of a solid product were recovered.

A sample was measured for LRV as described above and was found to have an LRV of 12.44. This sample was calculated to have an inherent viscosity of 0.47 dL/g.

The sample underwent DSC analysis. A recrystallization temperature was found on the programmed cool after the first heat cycle with an onset temperature of 199.9° C. and a peak at 195.9° C., (46.0 J/g). A Tg was found with an onset temperature of C, a midpoint temperature of C, and an endpoint temperature of C. A Tm was observed at 250.0° C., (41.2 J/g).

### Example 21

To a 250 milliliter glass flask was added bis(2-hydroxyethyl)terephthalate, (119.18 grams) and Dicaperle HP-2000 perlite, (10.00 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.8 hours. 19.7 grams of a colorless distillate were collected over this heating cycle. The reaction mixture was then staged to full vacuum with stirring at 295° C. The resulting reaction mixture was stirred for 1.1 hours under full vacuum, (pressure less than 100 mtorr). The vacuum was then released with nitrogen and the reaction mass allowed to cool to room temperature. An additional 6.1 grams of distillate were recovered and 92.0 grams of a solid product were recovered.

A sample was measured for LRV as described above and was found to have an LRV of 16.48. This sample was calculated to have an inherent viscosity of 0.54 dL/g.

The sample underwent DSC analysis. A recrystallization temperature was found on the programmed cool after the first heat cycle with an onset temperature of 206.8° C. and a peak at 193.8° C., (42.0 J/g). A Tg was found with an onset temperature of 75.8° C., a midpoint temperature of 79.4° C., and an endpoint temperature of 81.8° C. A Tm was observed at 255.9° C., (36.2 J/g).

### Example 22

To a 250 milliliter glass flask was added bis(2-hydroxyethyl)terephthalate, (131.09 grams), Dicaperl® HP-2000 perlite (1.00 gram), manganese(II) acetate tetrahydrate, (0.0440 grams), and antimony(II) trioxide, (0.0350 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.9 hours while under a slow nitrogen purge. The reaction mixture was heated to 295° C. over 0.7 hours with stirring under a slow nitrogen purge. The resulting reaction mixture was stirred at 295° C. under a slight nitrogen purge for 0.7 hours. 21.5 grams of a colorless distillate were collected over this heating cycle. The reaction mixture was then staged to full vacuum with stirring at 295° C. The resulting reaction mixture was stirred for 0.4 hours under full vacuum, (pressure less than 100 mtorr). The vacuum was then released with nitrogen and the reaction mass allowed to cool to room temperature. An additional 11.3 grams of distillate were recovered and 103.7 grams of a solid product were recovered.

A sample was measured for LRV as described above and was found to have an LRV of 20.60. This sample was calculated to have an inherent viscosity of 0.62 dL/g.

The sample underwent DSC analysis. A recrystallization temperature was found on the programmed cool after the first heat cycle with an onset temperature of 214.1° C. and a peak at 206.8° C., (44.7 J/g). A Tg was found with an onset temperature of 75.3° C., a midpoint temperature of 77.8° C., and an endpoint temperature of 79.1° C. A Tm was observed at 254.3° C., (38.5 J/g).

### Example 23

To a 250 milliliter glass flask was added bis(2-hydroxyethyl)terephthalate, (129.11 grams), Dicaperl® HP-2000 perlite, (2.50 grams), manganese(II) acetate tetrahydrate, (0.0446 grams), and antimony(III) trioxide, (0.0359 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.7 hours. 22.3 grams of a colorless distillate were collected over this heating cycle. The reaction mixture was then staged to full vacuum with stirring at 295° C. The resulting reaction mixture was stirred for 1.9 hours under full vacuum, (pressure less than 100 mtorr). The vacuum was then released with nitrogen and the reaction mass allowed to cool to room temperature. An additional 7.0 grams of distillate were recovered and 94.7 grams of a solid product were recovered.

A sample was measured for LRV as described above and was found to have an LRV of 22.84. This sample was calculated to have an inherent viscosity of 0.66 dL/g.

The sample underwent DSC analysis. A recrystallization temperature was found on the programmed cool after the first heat cycle with an onset temperature of 211.7° C. and a peak at 204.5° C., (46.2 J/g). A Tg was found with an onset temperature of 76.5° C., a midpoint temperature of 79.9° C., and an endpoint temperature of 82.8° C. A Tm was observed at 253.4° C., (45.4 J/g).

### Example 24

To a 250 milliliter glass flask was added bis(2-hydroxyethyl)terephthalate, (126.00 grams), Dicaperl® HP-2000 perlite, (5.00 grams), manganese(II) acetate tetrahydrate, (0.0462 grams), and antimony(III) trioxide, (0.0373 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.5 hours while under a slow nitrogen purge. The reaction mixture was heated to 295° C. over 0.5 hours with stirring under a slow nitrogen purge. The resulting reaction mixture was stirred at 295° C. under a slight nitrogen purge for 1.2 hours. 20.6 grams of a colorless distillate were collected over this heating cycle. The reaction mixture was then staged to full vacuum with stirring at 295° C. The resulting reaction mixture was stirred for 0.7 hours under full vacuum, (pressure less than 100 mtorr). The vacuum was then released with nitrogen and the reaction mass allowed to cool to room temperature. An additional 11.2 grams of distillate were recovered and 103.7 grams of a solid product were recovered.

A sample was measured for LRV as described above and was found to have an LRV of 20.19. This sample was calculated to have an inherent viscosity of 0.61 dL/g.

The sample underwent DSC analysis. A recrystallization temperature was found on the programmed cool after the first heat cycle with an onset temperature of 214.9° C. and a peak at 206.5° C., (39.3 J/g). A Tg was found with an onset temperature of 75.5° C., a midpoint temperature of 81.3° C., and an endpoint temperature of 86.9° C. A Tm was observed at 254.8° C., (37.3 J/g).

### Example 25

To a 250 milliliter glass flask was added bis(2-hydroxyethyl)terephthalate, (126.00 grams), Dicaper® HP-2010 perlite, (5.00 grams, a surface modified expanded grade of perlite produced by Grefco Minerals, Inc.), manganese(II) acetate tetrahydrate, (0.0440 grams), and antimony(III) trioxide, (0.0356 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.7 hours while under a slow nitrogen purge. The reaction mixture was heated to 295° C. over 0.5 hours with stirring under a slow nitrogen purge. The resulting reaction mixture was stirred at 295° C. under a slight nitrogen purge for 0.9 hours. 19.8 grams of a colorless distillate were collected over this heating cycle. The reaction mixture was then staged to full vacuum with stirring at 295° C. The resulting reaction mixture was stirred for 1.2 hours under full vacuum, (pressure less than 100 mtorr). The vacuum was then released with nitrogen and the reaction mass allowed to cool to room temperature. An additional 10.7 grams of distillate were recovered and 97.8 grams of a solid product were recovered.

A sample was measured for LRV as described above and was found to have an LRV of 18.03. This sample was calculated to have an inherent viscosity of 0.57 dL/g.

The sample underwent DSC analysis. A recrystallization temperature was found on the programmed cool after the first heat cycle with an onset temperature of 212.3° C. and a peak at 204.9° C., (40.4 J/g). A Tg was found with an onset temperature of 76.0° C., a midpoint temperature of 80.8° C., and an endpoint temperature of 85.4° C. A Tm was observed at 254.8° C., (36.5 J/g).

### Example 26

To a 250 milliliter glass flask was added bis(2-hydroxyethyl)terephthalate, (125.81 grams), Dicaperl® HP-2020 perlite, (5.00 grams, a surface modified expanded grade of perlite produced by Grefco Minerals, Inc.), manganese(II) acetate tetrahydrate, (0.0452 grams), and antimony(III) trioxide, (0.0350 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.5 hours while under a slow nitrogen purge. The reaction mixture was heated to 295° C. over 0.5 hours with stirring under a slow nitrogen purge. The resulting reaction mixture was stirred at 295° C. under a slight nitrogen purge for 0.8 hours. 19.8 grams of a colorless distillate were collected over this heating cycle. The reaction mixture was then staged to full vacuum with stirring at 295° C. The resulting reaction mixture was stirred for 1.0 hour under full vacuum, (pressure less than 100 mtorr). The vacuum was then released with nitrogen and the reaction mass allowed to cool to room temperature. An additional 11.2 grams of distillate were recovered and 103.7 grams of a solid product were recovered.

A sample was measured for LRV as described above and was found to have an LRV of 21.02. This sample was calculated to have an inherent viscosity of 0.63 dL/g.

The sample underwent DSC analysis. A recrystallization temperature was found on the programmed cool after the first heat cycle with an onset temperature of 215.6° C. and a peak at 209.0° C., (43.2 J/g). A Tg was found with an onset temperature of 76.5° C., a midpoint temperature of 81.9° C., and an endpoint temperature of 86.6° C. A Tm was observed at 254.9° C., (40.1 J/g).

### Example 27

To a 250 milliliter glass flask was added bis(2-hydroxyethyl)terephthalate, (120.50 grams), a ball milled dispersion of 8.00 weight percent Ketjinblack® EC300J carbon black and 0.7 weight percent polyvinylpyrrolidone in ethylene glycol (50.00 grams, Aquablak® 6071 provided by Solutions Dispersions, Inc.), Dicaperl® HP-2000 perlite (5.00 grams), manganese(II) acetate tetrahydrate, (0.0446 grams), and antimony(III) trioxide, (0.0359 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.5 hours while under a slow nitrogen purge. The reaction mixture was heated to 295° C. over 1.0 hour with stirring under a slow nitrogen purge. The resulting reaction mixture was stirred at 295° C. under a slight nitrogen purge for 0.7 hours. 66.3 grams of a colorless distillate were collected over this heating cycle. The reaction mixture was then staged to full vacuum with stirring at 295° C. The resulting reaction mixture was stirred for 1.5 hours under full vacuum, (pressure less than 100 mtorr). The vacuum was then released with nitrogen and the reaction mass allowed to cool to room temperature. An additional 7.5 grams of distillate were recovered and 92.1 grams of a solid product were recovered.

A sample was measured for LRV as described above and was found to have an LRV of 19.49. This sample was calculated to have an inherent viscosity of 0.60 dL/g.

The sample underwent DSC analysis. A recrystallization temperature was found on the programmed cool after the first heat cycle with an onset temperature of 214.5° C. and a peak at 209.9° C., (45.6 J/g). A Tg was found with an onset temperature of 72.1° C., a midpoint temperature of 76.0° C., and an endpoint temperature of 78.5° C. A Tm was observed at 249.7° C., (44.8 J/g).

Surface resistivity was measured and found to have a surface resistivity of 2.45×10⁴ Ohms per square.

### Example 28

To a 250 milliliter glass flask was added bis(2-hydroxyethyl)terephthalate, (106.93 grams), poly(ethylene glycol), (14.25 grams, average molecular weight of 1500), Dicaperl® HP-2000 perlite, (5.00 grams), manganese(II) acetate tetrahydrate (0.0446 grams), and antimony(III) trioxide (0.0359 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.5 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.6 hours. 17.5 grams of a colorless distillate were collected over this heating cycle. The reaction mixture was then staged to full vacuum with stirring at 295° C. The resulting reaction mixture was stirred for 1.5 hours under full vacuum, (pressure less than 100 mtorr). The vacuum was then released with nitrogen and the reaction mass allowed to cool to room temperature. An additional 8.3 grams of distillate were recovered and 91.6 grams of a solid product were recovered.

A sample was measured for LRV as described above and was found to have an LRV of 26.45. This sample was calculated to have an inherent viscosity of 0.72 dL/g.

The sample underwent DSC analysis. A recrystallization temperature was found on the programmed cool after the first heat cycle with an onset at 202.3° C. and a peak at 194.0° C., (41.5 J/g). A Tm was observed at 248.9° C., (39.0 J/g).

### Example 29

To a 250 milliliter glass flask was added dimethyl terephthalate, (56.00 grams), dimethyl isophthalate, (38.00 grams), ethylene glycol, (61.00 grams), Dicaperl® HP-2000 perlite (7.00 grams), manganese(II) acetate tetrahydrate (0.0442 grams), and antimony(III) trioxide (0.0363 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was stirred and heated to 200° C. over 0.2 hours under a slow nitrogen purge. After achieving 200° C., the resulting reaction mixture was stirred at 200° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.7 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.7 hours. 41.0 grams of a colorless distillate were collected over this heating cycle. The reaction mixture was then staged to full vacuum with stirring at 295° C. The resulting reaction mixture was stirred for 0.4 hours under full vacuum, (pressure less than 100 mtorr). The vacuum was then released with nitrogen and the reaction mass allowed to cool to room temperature. An additional 10.6 grams of distillate were recovered and 100.4 grams of a solid product were recovered.

A sample was measured for LRV as described above and was found to have an LRV of 19.20. This sample was calculated to have an inherent viscosity of 0.59 dL/g.

The sample underwent DSC analysis. A Tg was found with an onset temperature of 65.2° C., and an endpoint temperature of 69.6° C. A Tm was not observed.

### Example 30

To a 250 milliliter glass flask was added dimethyl terephthalate, (81.65 grams), 1,4-butanediol, (49.26 grams), Dicaperl® HP-2000 perlite, (7.50 grams), and titanium(IV) isopropoxide (0.1188 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was stirred and heated to 190° C. over 0.3 hours under a slow nitrogen purge. After achieving 190° C., the resulting reaction mixture was stirred at 190° C. for 0.7 hours while under a slow nitrogen purge. The reaction mixture was stirred and heated to 200° C. over 0.3 hours under a slow nitrogen purge. After achieving 200° C., the resulting reaction mixture was stirred at 200° C. for 0.6 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.5 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.5 hours. 21.6 grams of a colorless distillate were collected over this heating cycle. The reaction mixture was then staged to full vacuum with stirring at 255° C. The resulting reaction mixture was stirred for 2.7 hours under full vacuum, (pressure less than 100 mtorr). The vacuum was then released with nitrogen and the reaction mass allowed to cool to room temperature. An additional 5.6 grams of distillate were recovered and 94.9 grams of a solid product were recovered.

A sample was measured for LRV as described above and was found to have an LRV of 31.47. This sample was calculated to have an inherent viscosity of 0.82 dL/g.

The sample underwent DSC analysis. A recrystallization temperature was found on the programmed cool after the first heat cycle with an onset at 194.0° C. and a peak at 188.6° C., (55.0 J/g). A Tm was observed at 224.6° C., (38.0 J/g).

### Example 31

To a 250 milliliter glass flask was added bis(2-hydroxyethyl)terephthalate, (119.18 grams), Dicaperl® HP-2000 perlite, (10.00 grams, an unmodified expanded grade of perlite produced by Grefco Minerals, Inc.), manganese(II) acetate tetrahydrate, (0.0443 grams), and antimony(III) trioxide, (0.0358 grams). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 225° C. over 0.6 hours while under a slow nitrogen purge. After achieving 225° C., the resulting reaction mixture was stirred at 225° C. for 1.2 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.7 hours. 18.7 grams of a colorless distillate were collected over this heating cycle. The reaction mixture was then staged to full vacuum with stirring at 295° C. The resulting reaction mixture was stirred for 0.4 hours under full vacuum, (pressure less than 100 mtorr). The vacuum was then released with nitrogen and the reaction mass allowed to cool to room temperature. An additional 10.8 grams of distillate were recovered and 97.0 grams of a solid product were recovered.

A sample was measured for LRV as described above and was found to have an LRV of 16.70. This sample was calculated to have an inherent viscosity of 0.55 dL/g.

The sample underwent DSC analysis. A recrystallization temperature was found on the programmed cool after the first heat cycle with an onset temperature of 216.6° C. and a peak at 211.2° C., (43.3 J/g). A Tg was found with an onset temperature of 71.6° C., a midpoint temperature of 78.5° C., and an endpoint temperature of 84.1° C. A Tm was observed at 253.9° C., (38.6 J/g).

### Example 32

To a 250 milliliter glass flask was added bis(2-hydroxyethyl)terephthalate, (119.00 grams), manganese(II) acetate tetrahydrate (0.0440 grams), and antimony(III) trioxide (0.0359 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.7 hours while under a slow nitrogen purge. A small intermediate resin sample was obtained and tested for LRV, as described below. Dicaperl® HP-2000 perlite, (10.00 grams, an unmodified expanded grade of perlite produced by Grefco Minerals, Inc.), was added to the reaction mixture. The reaction mixture was heated to 295° C. over 0.6 hours with stirring under a slow nitrogen purge. The resulting reaction mixture was stirred at 295° C. under a slight nitrogen purge for 0.9 hours. 15.6 grams of a colorless distillate were collected over this heating cycle. The reaction mixture was then staged to full vacuum with stirring at 295° C. The resulting reaction mixture was stirred for 0.8 hours under full vacuum, (pressure less than 100 mtorr). The vacuum was then released with nitrogen and the reaction mass allowed to cool to room temperature. An additional 13.3 grams of distillate were recovered and 98.3 grams of a solid product were recovered.

The intermediate resin sample obtained after the 225° C. hold was measured for LRV as described above and was found to have an LRV of 1.75. This sample was calculated to have an inherent viscosity of 0.28 dL/g.

The product sample was measured for LRV as described above and was found to have an LRV of 17.94. This sample was calculated to have an inherent viscosity of 0.57 dL/g.

The sample underwent DSC analysis. A recrystallization temperature was found on the programmed cool after the first heat cycle with an onset temperature of 213.3° C. and a peak at 207.1° C., (36.1 J/g). A Tm was observed at 253.5° C., (32.4 J/g).

### Example 33

To a 250 milliliter glass flask was added bis(2-hydroxyethyl)terephthalate, (119.18 grams), manganese(II) acetate tetrahydrate, (0.0450 grams), and antimony(III) trioxide, (0.0357 grams). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.5 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.8 hours. A small intermediate resin sample was obtained and tested for LRV, as described below. Dicaperl® HP-2000 perlite, (10.00 grams, an unmodified expanded grade of perlite produced by Grefco Minerals, Inc.), was added to the reaction mixture. 12.9 grams of a colorless distillate were collected over this heating cycle. The reaction mixture was then staged to full vacuum with stirring at 295° C. The resulting reaction mixture was stirred for 1.0 hour under full vacuum, (pressure less than 100 mtorr). The vacuum was then released with nitrogen and the reaction mass allowed to cool to room temperature. An additional 16.4 grams of distillate were recovered and 90.9 grams of a solid product were recovered.

The intermediate resin sample obtained after the 295° C. hold was measured for LRV as described above and was found to have an LRV of 1.97. This sample was calculated to have an inherent viscosity of 0.28 dL/g.

A sample was measured for LRV as described above and was found to have an LRV of 20.87. This sample was calculated to have an inherent viscosity of 0.62 dL/g.

The sample underwent DSC analysis. A recrystallization temperature was found on the programmed cool after the first heat cycle with an onset temperature of 208.4° C. and a peak at 201.6° C., (36.5 J/g). A Tg was found with an onset temperature of 67.1° C., a midpoint temperature of 73.3° C., and an endpoint temperature of 79.6° C. A Tm was observed at 251.3° C., (33.6 J/g).

### Example 34

To a 250 milliliter glass flask was added bis(2-hydroxyethyl)terephthalate, (119.18 grams), Dicaperl® HP-2010 perlite, (10.00 grams), manganese(II) acetate tetrahydrate (0.0456 grams), and antimony(III) trioxide (0.0352 grams). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.7 hours while under a slow nitrogen purge. The reaction mixture was heated to 295° C. over 0.6 hours with stirring under a slow nitrogen purge. The resulting reaction mixture was stirred at 295° C. under a slight nitrogen purge for 0.7 hours. 18.2 grams of a colorless distillate were collected over this heating cycle. The reaction mixture was then staged to full vacuum with stirring at 295° C. The resulting reaction mixture was stirred for 0.5 hours under full vacuum, (pressure less than 100 mtorr). The vacuum was then released with nitrogen and the reaction mass allowed to cool to room temperature. An additional 12.1 grams of distillate were recovered and 111.7 grams of a solid product were recovered.

A sample was measured for LRV as described above and was found to have an LRV of 15.81. This sample was calculated to have an inherent viscosity of 0.53 dL/g.

The sample underwent DSC analysis. A recrystallization temperature was found on the programmed cool after the first heat cycle with an onset temperature of 220.3° C. and a peak at 215.7° C., (42.1 J/g). A Tg was found with an onset temperature of 78.4° C., a midpoint temperature of 82.3° C., and an endpoint temperature of 86.2° C. A Tm was observed at 255.1° C., (35.7 J/g).

### Example 35

To a 250 milliliter glass flask was added bis(2-hydroxyethyl)terephthalate, (113.89 grams), a ball milled dispersion of 8.00 weight percent Ketjinblack® EC300J carbon black and 0.7 weight percent polyvinylpyrrolidone in ethylene glycol, (50.00 grams, Aquablak® 6071 provided by Solutions Dispersions, Inc.), Dicaperl® HP-2000 perlite, (10.00 grams), manganese(II) acetate tetrahydrate (0.0446 grams), and antimony(III) trioxide (0.0359 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.7 hours while under a slow nitrogen purge. The reaction mixture was heated to 295° C. over 1.2 hours with stirring under a slow nitrogen purge. The resulting reaction mixture was stirred at 295° C. under a slight nitrogen purge for 0.8 hours. 65.3 grams of a colorless distillate were collected over this heating cycle. The reaction mixture was then staged to full vacuum with stirring at 295° C. The resulting reaction mixture was stirred for 0.3 hours under full vacuum, (pressure less than 100 mtorr). The vacuum was then released with nitrogen and the reaction mass allowed to cool to room temperature. An additional 8.2 grams of distillate were recovered and 92.9 grams of a solid product were recovered.

A sample was measured for LRV as described above and was found to have an LRV of 12.96. This sample was calculated to have an inherent viscosity of 0.48 dL/g.

The sample underwent DSC analysis. A recrystallization temperature was found on the programmed cool after the first heat cycle with an onset temperature of 212.7° C. and a peak at 207.7° C., (41.5 J/g). A Tg was found with an onset temperature of 68.1° C., a midpoint temperature of 70.3° C., and an endpoint temperature of 71.2° C. A Tm was observed at 246.2° C., (40.0 J/g).

Surface resistivity was measured and found to have a surface resistivity of 1.40×10⁴ Ohms per square.

### Example 36

To a 250 milliliter glass flask was added bis(2-hydroxyethyl)terephthalate, (83.43 grams), poly(ethylene glycol)-block-poly(propylene glycol)-block-poly(ethylene glycol), (27.00 grams, average molecular weight of 2000, 10 weight percent ethylene glycol), Dicaperl® HP-2000 perlite, (10.00 grams), manganese(II) acetate tetrahydrate (0.0446 grams), and antimony(III) trioxide (0.0359 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.6 hours. 14.8 grams of a colorless distillate were collected over this heating cycle. The reaction mixture was then staged to full vacuum with stirring at 295° C. The resulting reaction mixture was stirred for 2.8 hours under full vacuum, (pressure less than 100 mtorr). The vacuum was then released with nitrogen and the reaction mass allowed to cool to room temperature. An additional 9.2 grams of distillate were recovered and 89.3 grams of a solid product were recovered.

A sample was measured for LRV as described above and was found to have an LRV of 8.95. This sample was calculated to have an inherent viscosity of 0.41 dL/g.

The sample underwent DSC analysis. A recrystallization temperature was found on the programmed cool after the first heat cycle with an onset at 193.7° C. and a peak at 183.2° C., (34.5 J/g). A Tm was observed at 231.7° C., (26.6 J/g).

### Example 37

To a 250 milliliter glass flask was added dimethyl terephthalate, (84.84 grams), 1,3-propanediol, (43.22 grams), Dicaperl® HP-2000 perlite, (10.00 grams), and titanium(IV) isopropoxide (0.1177 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.4 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.8 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.5 hours. 21.0 grams of a colorless distillate were collected over this heating cycle. The reaction mixture was then staged to full vacuum with stirring at 255° C. The resulting reaction mixture was stirred for 1.1 hours under full vacuum, (pressure less than 100 mtorr). The vacuum was then released with nitrogen and the reaction mass allowed to cool to room temperature. An additional 6.1 grams of distillate were recovered and 93.1 grams of a solid product were recovered.

A sample was measured for LRV as described above and was found to have an LRV of 21.80. This sample was calculated to have an inherent viscosity of 0.64 dL/g.

The sample underwent DSC analysis. A recrystallization temperature was found on the programmed cool after the first heat cycle with an onset at 195.7° C. and a peak at 191.2° C., (46.4 J/g). A Tg was found with an onset temperature of 57.5° C., a midpoint temperature of 60.0° C., and an endpoint temperature of 62.5° C. A Tm was observed at 231.0° C., (40.4 J/g).

### Example 38

To a 250 milliliter glass flask was added dimethyl terephthalate, (78.00 grams), ethylene glycol, (34.00 grams), 1,4-cyclohexanedimethanol, (19.00 grams), Dicaperl® HP-2000 perlite, (13.00 grams), manganese(II) acetate tetrahydrate (0.0454 grams), and antimony(III) trioxide (0.0366 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.4 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.7 hours while under a slow nitrogen purge. The reaction mixture was heated to 295° C. over 0.8 hours with stirring under a slow nitrogen purge. The resulting reaction mixture was stirred at 295° C. under a slight nitrogen purge for 1.2 hours. 22.3 grams of a colorless distillate were collected over this heating cycle. The reaction mixture was then staged to full vacuum with stirring at 295° C. The resulting reaction mixture was stirred for 2.7 hours under full vacuum, (pressure less than 100 mtorr). The vacuum was then released with nitrogen and the reaction mass allowed to cool to room temperature. An additional 7.9 grams of distillate were recovered and 103.1 grams of a solid product were recovered.

A sample was measured for LRV as described above and was found to have an LRV of 17.67. This sample was calculated to have an inherent viscosity of 0.57 dL/g.

The sample underwent DSC analysis. A Tg was found with an onset temperature of 73.0° C. and an endpoint temperature of 77.4° C.

### Example 39

To a 250 milliliter glass flask was added bis(2-hydroxyethyl)terephthalate, (112.55 grams), Dicaperle HP-2000 perlite, (15.00 grams), manganese(II) acetate tetrahydrate (0.0446 grams), and antimony(III) trioxide (0.0359 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.5 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.6 hours. 18.6 grams of a colorless distillate were collected over this heating cycle. The reaction mixture was then staged to full vacuum with stirring at 295° C. The resulting reaction mixture was stirred for 2.0 hours under full vacuum, (pressure less than 100 mtorr). The vacuum was then released with nitrogen and the reaction mass allowed to cool to room temperature. An additional 7.5 grams of distillate were recovered and 94.7 grams of a solid product were recovered.

A sample was measured for LRV as described above and was found to have an LRV of 27.47. This sample was calculated to have an inherent viscosity of 0.74 dL/g.

The sample underwent DSC analysis. A recrystallization temperature was found on the programmed cool after the first heat cycle with an onset temperature of 214.1° C. and a peak at 208.4° C., (42.6 J/g). A Tg was found with an onset temperature of 67.6° C., a midpoint temperature of 74.7° C., and an endpoint temperature of 81.6° C. A Tm was observed at 252.9° C., (40.3 J/g).

### Example 40

To a 250 milliliter glass flask was added dimethyl terephthalate, (25.00 grams), 1,4-butanediol, (11.35 grams), poly(tetramethylene ether)glycol, (64.06 grams, average molecular weight of 2000), Dicaperl® HP-2000 perlite, (15.00 grams), and titanium(IV) isopropoxide (0.1280 grams). The reaction mixture was stirred and heated to 180° C. under a slow nitrogen purge. After achieving 180 C, the resulting reaction mixture was stirred at 180° C. for 0.5 hours while under a slow nitrogen purge. The reaction mixture was stirred and heated to 190° C. over 0.1 hours under a slow nitrogen purge. After achieving 190° C., the resulting reaction mixture was stirred at 190° C. for 0.5 hours while under a slow nitrogen purge. The reaction mixture was stirred and heated to 200° C. over 0.1 hours under a slow nitrogen purge. After achieving 200° C., the resulting reaction mixture was stirred at 200° C. for 0.6 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.6 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.8 hours. 1.9 grams of a colorless distillate were collected over this heating cycle. The reaction mixture was then staged to full vacuum with stirring at 255° C. The resulting reaction mixture was stirred for 3.0 hours under full vacuum, (pressure less than 100 mtorr). The vacuum was then released with nitrogen and the reaction mass allowed to cool to room temperature. An additional 0.8 grams of distillate were recovered and 99.1 grams of a solid product were recovered.

A sample was measured for LRV as described above and was found to have an LRV of 23.30. This sample was calculated to have an inherent viscosity of 0.67 dL/g.

The sample underwent DSC analysis. A recrystallization temperature was found on the programmed cool after the first heat cycle with an onset at 150.6° C. and a peak at 127.6° C., (8.5 J/g). A Tm was observed at 170.6° C., (3.2 J/g).

### Example 41

To a 250 milliliter glass flask was added bis(2-hydroxyethyl)terephthalate, (105.93 grams), Dicaperl® HP-2000 perlite, (20.00 grams), manganese(II) acetate tetrahydrate (0.0455 grams), and antimony(III) trioxide (0.0358 grams). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 225° C. over 0.4 hours while under a slow nitrogen purge. After achieving 225° C., the resulting reaction mixture was stirred at 225° C. for 1.0 hour while under a slow nitrogen purge. The reaction mixture was heated to 295° C. over 0.7 hours with stirring under a slow nitrogen purge. The resulting reaction mixture was stirred at 295° C. under a slight nitrogen purge for 0.6 hours. 16.1 grams of a colorless distillate were collected over this heating cycle. The reaction mixture was then staged to full vacuum with stirring at 295° C. The resulting reaction mixture was stirred for 2.4 hours under full vacuum, (pressure less than 100 mtorr). The vacuum was then released with nitrogen and the reaction mass allowed to cool to room temperature. An additional 14.1 grams of distillate were recovered and 106.5 grams of a solid product were recovered.

A sample was measured for LRV as described above and was found to have an LRV of 27.97. This sample was calculated to have an inherent viscosity of 0.75 dL/g.

The sample underwent DSC analysis. A recrystallization temperature was found on the programmed cool after the first heat cycle with an onset temperature of 215.4° C. and a peak at 209.2° C., (34.0 J/g). A Tg was found with an onset temperature of 68.8° C., a midpoint temperature of 78.8° C., and an endpoint temperature of 88.9° C. A Tm was observed at 254.8° C., (31.0 J/g).

What is claimed is:

1. A polyester composition comprising a polyester and at least about 0.0001 weight percent of one or more pumice fillers, based on total weight of the polyester composition.

2. The polyester composition of claim 1, comprising from about 0.0001 to about 30 weight percent of the pumice filler.

3. The polyester composition of claim 1, comprising from about 0.0001 to about 20 weight percent of the pumice filler.

4. The polyester composition of claim 1, comprising from about 0.001 to about 0.5 weight percent of the pumice filler.

5. The polyester composition of claim 1, comprising from about 0.001 to about 0.1 weight percent of the pumice filler.

6. The polyester composition of claim 1, further comprising a catalyst different from the pumice filler.

7. The polyester composition of claim 1, further comprising a heavy metal-free catalyst different from the pumice filler.

8. The polyester composition of claim 1 wherein the nominal particle size of the pumice is about 100 microns or less.

9. The polyester composition of claim 1 wherein the nominal particle size of the pumice is about 50 microns or less.

10. The polyester composition of claim 1 wherein the nominal particle size of the pumice is about 10 microns or less.

11. The polyester composition of claim 1, further comprising a heavy metal-containing catalyst.

12. The polyester composition of claim 1, wherein the pumice functions as a polymerization catalyst and is the sole polymerization catalyst.

13. The polyester composition of claim 7, wherein the pumice functions as a polymerization catalyst and is the sole polymerization catalyst.

14. The polyester composition of claim 1, further comprising at least one other filler different from the pumice filler.

15. The polyester composition of claim 14, comprising at least about 0.01 weight percent of said other filler, based on the total weight of the polyester composition.

16. The composition of claim 15, wherein the total amount of other fillers is from about 0.1 weight percent to about 20 weight percent, based on the total weight of the polyester composition.

17. The composition of claim 15, wherein the total amount of other fillers is from about 1 weight percent to about 15 weight percent, based on the total weight of the polyester composition.

18. The composition of claim 14, wherein the other filler is selected from the group consisting of carbon black, clay, glass beads, hollow glass beads, glass fibers, and mixtures thereof.

19. The polyester composition of claim 18 wherein the other filler comprises carbon black.

20. The polyester composition of claim 19 wherein the carbon black has a DBP value of at least about 150 cc/100 grams.

21. The polyester composition of claim 20 wherein the DBP value is at least about 220 cc/100 grams.

22. The polyester composition of claim 19 wherein the amount of carbon black is about 15 weight percent or less, based on the total weight of the polyester composition.

23. The polyester composition of claim 8 wherein the composition is antistatic, static dissipating, moderately conductive, or conductive.

24. A shaped article comprising the polyester composition of claim 1.

25. A shaped article made from the polyester composition of claim 19, wherein the article is electrostatically paintable.

26. A shaped article of claim 24, selected from films, sheets, filaments, sheets, fibers, melt blown containers, molded parts, foamed parts and thermoformed products.

27. A fiber comprising the polyester composition of claim 1.

28. A monofilament comprising the polyester composition of claim 1.

29. An article comprising a substrate and a coating on the substrate, the coating comprising the polyester composition of claim 1.

30. The article of claim 29 wherein the substrate wherein the substrate is selected from paper, paperboard, cardboard, fiberboard, cellulose, starch, plastic, polystyrene foam, glass, metal such aluminum or tin in the form of cans, metal foils, polymeric foams, organic foams, inorganic foams, organic-inorganic foams, and polymeric films.

31. An oriented film comprising the polyester composition of claim 1.

32. The film of claim 31 wherein the film is biaxially oriented.

33. The film of claim 31 wherein the film is uniaxially oriented.

34. A multilayer film comprising a layer comprising a polyester composition of claim 1.

35. A sheet comprising a polyester composition of claim 1.

36. A process for producing a polyester composition comprising: providing a dicarboxylic acid component, a glycol component, and, optionally, a polyfunctional branching agent component to form a reaction mixture contacting the reaction mixture with a pumice filler, and allowing the dicarboxylic acid component, the glycol component, and the optional polyfunctional branching agent to polymerize in the presence of the pumice filler to form a polyester.

37. The process of claim 36, further comprising adding to the reaction mixture a heavy metal catalyst.

38. The process of claim 37, wherein the heavy metal catalyst is selected from salts of Zn, Pb, Sb, Sn, and Ge.

39. The process of claim 38, wherein the salts are selected from acetate salts, oxides, and glycol adducts.

40. The process of claim 37, wherein the amount of the heavy metal catalyst is at least about 0.0001 weight percent based on the total weight of the polyester composition.

41. The process of claim 37, wherein the amount of heavy metal-containing catalyst is from about 0.0001 weight percent to about 1 weight percent based on the total weight of the polyester composition.

42. The process of claim 37, wherein the amount of heavy metal-containing catalysts is from about 0.0001 weight percent to about 0.5 weight percent based on the total weight of the polyester composition.

43. The process of claim 36, further comprising adding to the reaction mixture a heavy metal-free catalyst.

44. The process of claim 43 wherein the heavy metal-free catalyst is selected from salts of Li, Ca, Mg, Mn, and Ti.

45. The process of claim 44 wherein the salts are selected from acetate salts, oxides, glycol adducts, and alkoxides.

46. The process of claim 43, wherein the amount of the heavy metal-free catalyst is at least about 0.0001 weight percent based on the total weight of the polyester composition.

47. The process of claim 43, wherein the amount of heavy metal-free catalyst is from about 0.0001 weight percent to about 1 weight percent based on the total weight of the polyester composition.

48. The process of claim 43, wherein the amount of heavy metal-free catalysts is from about 0.0001 weight percent to about 0.5 weight percent based on the total weight of the polyester composition.

49. The process of claim 36, further comprising adding to the reaction mixture another filler.

50. The process of claim 49, wherein the other filler is selected from the group consisting of carbon black, clay, glass beads, hollow glass beads, glass fibers, and mixtures thereof.

51. The process of claim 36, further comprising solid state polymerizing the polyester by heating the solid polyester particles to a temperature below the melting point of said polyester and for a time sufficient to increase the molecular weight of said polyester.

52. A blend comprising the polyester composition of claim 1 and one or more other polymers.

53. The blend of claim 52 wherein the other polymer is biodegradable.

54. The blend of claim 53 wherein the biodegradable polymer is selected from the group consisting of poly(hydroxy alkanoates), polycarbonates, poly(caprolactone), aliphatic polyesters, aliphatic-aromatic copolyesters, aliphatic-aromatic copolyetheresters, aliphatic-aromatic copolyamideesters, sulfonated aliphatic-aromatic copolyesters, sulfonated aliphatic-aromatic copolyetheresters, sulfonated aliphatic-aromatic copolyamideesters, and mixtures derived therefrom.

55. The blend of claim 52 wherein the other polymer is nonbiodegradable.

56. The blend of claim 55 wherein the nonbiodegradable polymer is selected from a group consisting of polyamides, polyesters, polyolefins, ethylene copolymers, polycarbonates, polyphenylene ethers, and mixtures thereof.

57. The blend of claim 52 wherein the other polymer is a natural polymer.

58. The blend of claim 57 wherein the natural polymer is a starch.

59. A polyester composition comprising a polyester and at least about 0.0001 weight percent of one or more perlite fillers, based on total weight of the polyester composition.

60. The polyester composition of claim 58, comprising from about 0.0001 to about 30 weight percent of the perlite filler.

61. The polyester composition of claim 58, comprising from about 0.0001 to about 20 weight percent of the perlite filler.

62. The polyester composition of claim 58, comprising from about 0.001 to about 0.5 weight percent of the perlite filler.

63. The polyester composition of claim 58, comprising from about 0.001 to about 0.1 weight percent of the perlite filler.

64. The polyester composition of claim 58, further comprising a catalyst different from the perlite filler.

65. The polyester composition of claim 58, further comprising a heavy metal-free catalyst different from the perlite filler.

66. The polyester composition of claim 58 wherein the nominal particle size of the perlite is about 100 microns or less.

67. The polyester composition of claim 58 wherein the nominal particle size of the perlite is about 50 microns or less.

68. The polyester composition of claim 58 wherein the nominal particle size of the perlite is about 10 microns or less.

69. The polyester composition of claim 58, further comprising a heavy metal-containing catalyst.

70. The polyester composition of claim 58, wherein the perlite functions as a polymerization catalyst and is the sole polymerization catalyst.

71. The polyester composition of claim 70, wherein the perlite functions as a polymerization catalyst and is the sole polymerization catalyst.

72. The polyester composition of claim 58, further comprising at least one other filler different from the perlite filler.

73. The polyester composition of claim 72, comprising at least about 0.01 weight percent of said other filler, based on the total weight of the polyester composition.

74. The composition of claim 72, wherein the total amount of other fillers is from about 0.1 weight percent to about 20 weight percent, based on the total weight of the polyester composition.

75. The composition of claim 72, wherein the total amount of other fillers is from about 1 weight percent to about 15 weight percent, based on the total weight of the polyester composition.

76. The composition of claim 72, wherein the other filler is selected from the group consisting of carbon black, clay, glass beads, hollow glass beads, glass fibers, and mixtures thereof.

77. The polyester composition of claim 76 wherein the other filler comprises carbon black.

78. The polyester composition of claim 77 wherein the carbon black has a DBP value of at least about 150 cc/100 grams.

79. The polyester composition of claim 78 wherein the DBP value is at least about 220 cc/100 grams.

80. The polyester composition of claim 77 wherein the amount of carbon black is about 15 weight percent or less, based on the total weight of the polyester composition.

81. The polyester composition of claim 77 wherein the composition is antistatic, static dissipating, moderately conductive, or conductive.

82. A shaped article comprising the polyester composition of claim 58.

83. A shaped article made from the polyester composition of claim 77, wherein the article is electrostatically paintable.

84. A shaped article of claim 82, selected from films, sheets, filaments, sheets, fibers, melt blown containers, molded parts, foamed parts and thermoformed products.

85. A fiber comprising the polyester composition of claim 58.

86. A monofilament comprising the polyester composition of claim 58.

87. An article comprising a substrate and a coating on the substrate, the coating comprising the polyester composition of claim 58.

88. The article of claim 87 wherein the substrate wherein the substrate is selected from paper, paperboard, cardboard, fiberboard, cellulose, starch, plastic, polystyrene foam, glass, metal such aluminum or tin in the form of cans, metal foils, polymeric foams, organic foams, inorganic foams, organic-inorganic foams, and polymeric films.

89. An oriented film comprising the polyester composition of claim 58.

90. The film of claim 89 wherein the film is biaxially oriented.

91. The film of claim 89 wherein the film is uniaxially oriented.

92. A multilayer film comprising a layer comprising a polyester composition of claim 58.

93. A sheet comprising a polyester composition of claim 58.

94. A process for producing a polyester composition comprising: providing a dicarboxylic acid component, a glycol component, and, optionally, a polyfunctional branching agent component to form a reaction mixture contacting the reaction mixture with a perlite filler, and allowing the dicarboxylic acid component, the glycol component, and the optional polyfunctional branching agent to polymerize in the presence of the perlite filler to form a polyester.

95. The process of claim 94, further comprising adding to the reaction mixture a heavy metal catalyst.

96. The process of claim 95, wherein the heavy metal catalyst is selected from salts of Zn, Pb, Sb, Sn, and Ge.

97. The process of claim 96, wherein the salts are selected from acetate salts, oxides, and glycol adducts.

98. The process of claim 96, wherein the amount of the heavy metal catalyst is at least about 0.0001 weight percent based on the total weight of the polyester composition.

99. The process of claim 96, wherein the amount of heavy metal-containing catalyst is from about 0.0001 weight percent to about 1 weight percent based on the total weight of the polyester composition.

100. The process of claim 96, wherein the amount of heavy metal-containing catalysts is from about 0.0001 weight percent to about 0.5 weight percent based on the total weight of the polyester composition.

101. The process of claim 94, further comprising adding to the reaction mixture a heavy metal-free catalyst.

102. The process of claim 101 wherein the heavy metal-free catalyst is selected from salts of Li, Ca, Mg, Mn, and Ti.

103. The process of claim 102 wherein the salts are selected from acetate salts, oxides, glycol adducts, and alkoxides.

104. The process of claim 101, wherein the amount of the heavy metal-free catalyst is at least about 0.0001 weight percent based on the total weight of the polyester composition.

105. The process of claim 101, wherein the amount of heavy metal-free catalyst is from about 0.0001 weight percent to about 1 weight percent based on the total weight of the polyester composition.

106. The process of claim 101, wherein the amount of heavy metal-free catalysts is from about 0.0001 weight percent to about 0.5 weight percent based on the total weight of the polyester composition.

107. The process of claim 94, further comprising adding to the reaction mixture another filler.

108. The process of claim 107, wherein the other filler is selected from the group consisting of carbon black, clay, glass beads, hollow glass beads, glass fibers, and mixtures thereof.

109. The process of claim 94, further comprising solid state polymerizing the polyester by heating the solid polyester particles to a temperature below the melting point of said polyester and for a time sufficient to increase the molecular weight of said polyester.

110. A blend comprising the polyester composition of claim 58 and one or more other polymers.

111. The blend of claim 110 wherein the other polymer is biodegradable.

112. The blend of claim 111 wherein the biodegradable polymer is selected from the group consisting of poly(hydroxy alkanoates), polycarbonates, poly(caprolactone), aliphatic polyesters, aliphatic-aromatic copolyesters, aliphatic-aromatic copolyetheresters, aliphatic-aromatic copolyamideesters, sulfonated aliphatic-aromatic copolyesters, sulfonated aliphatic-aromatic copolyetheresters, sulfonated aliphatic-aromatic copolyamideesters, and mixtures derived therefrom.

113. The blend of claim 110 wherein the other polymer is nonbiodegradable.

114. The blend of claim 113 wherein the nonbiodegradable polymer is selected from a group consisting of polyamides, polyesters, polyolefins, ethylene copolymers, polycarbonates, polyphenylene ethers, and mixtures thereof.

115. The blend of claim 110 wherein the other polymer is a natural polymer.

116. The blend of claim 115 wherein the natural polymer is a starch.
